(19) United States
(12) Patent Application Publication
(10) Pub. No.: US 2004/0229199 A1
(43) Pub. Date: Nov. 18, 2004

(54) Computer-based standardized test administration, scoring and analysis system

(75) Inventors: Edmund P. Ashley, Portland, ME (US); R. Craig Enslin, Barrington, NH (US); Neal M. Kingston, Greenland, NH (US); Chloe Y. Torres, Dover, NH (US); David G. Wozmak, Bennington, NH (US); Michael G. Willett, Eliot, ME (US)

Correspondence Address: MAINE & ASMUS, 100 MAIN STREET, P O BOX 3445, NASHUA, NH, 03061-3445, US

(73) Assignee: MEASURED PROGRESS, INC., Dover, NH

(21) Appl. No.: 10/824,914

(22) Filed: Apr. 15, 2004

Related U.S. Application Data
(60) Provisional application No. 60/463,244, filed on Apr. 16, 2003.

(51) Int. Cl. G09B 7/00; G09B 3/00

(52) U.S. Cl. 434/323

(57) ABSTRACT

A computer-based testing system is disclosed comprising: a data administration system including centrally hosted data administration servers; a network and an operational testing system the data administration system including a browser-capable workstation connectible via the network to the centrally hosted data administration servers. The operational testing system may include three subsystems connected to the network: a test delivery server running on a test delivery workstation and managing all aspects of a test session by acting as a data repository and hub for communication between the other subsystems, a proctor software running on a proctor test workstation providing a user interface for managing a test session by communicating with the test delivery server, and a student test software running on a student test workstation providing a user interface for displaying test items and recording responses.

### RELATED APPLICATIONS

This application claims the benefit of U.S. Provisional Applications No. 60/463,244, filed Apr. 16, 2003. This application is herein incorporated in its entirety by reference.

### STATEMENT OF GOVERNMENT INTEREST

### COPYRIGHT NOTICE

A portion of the disclosure of this patent document contains material that is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### FIELD OF THE INVENTION

The invention relates to standardized test administration, and more particularly, to a computer-based distributed system for the administration, scoring and analysis of standardized tests.

### BACKGROUND OF THE INVENTION

Two movements have been developed in education in recent years. The great expense associated with public education has driven political initiatives for accountability and measurement of student progress, increasing the need for large scale, often state wide, standardized testing.

In combination with this growth in wide scale testing, computers have gained wide spread acceptance in education. With this acceptance, traditionally paper driven tasks, like testing, are becoming increasingly automated. Scoring of multiple-choice standardized tests has long been automated with the use of the widely known scanned forms.

Previous attempts to implement statewide electronic testing have demonstrated significant and often profound performance issues, relating to the load characteristics of such a system, where many student test sessions hit the main servers all at once. In such instances data transfer may slow to unacceptably low levels. Such system performance problems may bias tests, eroding limited test time, increasing student and administrator stress and frustration levels, and undermining the primary benefit of such test administration: ease of use.

Likewise, various commercial off the shelf equipment used by various schools, districts, and state departments of education. A system for electronic administration of standardized tests must compensate for such equipment variation.

What is needed, therefore, are effective, user friendly, techniques for electronic administration of standardized tests.

### BRIEF SUMMARY OF THE INVENTION

One embodiment of the present invention provides A computer-based testing system comprising: a data administration system including centrally hosted data administration servers; a network and an operational testing system the data administration system including a browser-capable workstation connectible via the network to the centrally hosted data administration servers. The operational testing system may include three subsystems connected to the network: a test delivery server running on a test delivery workstation and managing all aspects of a test session by acting as a data repository and hub for communication between the other subsystems, a proctor software running on a proctor test workstation providing a user interface for managing a test session by communicating with the test delivery server, and a student test software running on a student test workstation providing a user interface for displaying test items and recording responses.

Another embodiment of the present invention provides a distributed system whereby all aspects of a testing administration program are facilitated, from test item administration to scoring.

A further embodiment of the present invention provides such a system further comprising a scalable test display system, such that the appearance of a test item is common to all student test workstations within the system.

Still another embodiment of the present invention provides such a system wherein users are categorized according to classes.

A still further embodiment of the present invention provides such a system wherein access to the system by a user is limited according to which class the user belongs.

Even another embodiment of the present invention provides such a system further comprising an egress control system whereby access to non-test material by a student using a student test workstation is monitored and controlled during the administration of the test.

An even further embodiment of the present invention provides such a system wherein the egress control system permits limited use of a world wide computer network.

Yet another embodiment of the present invention provides such a system wherein the proctor software facilitates the monitoring of at least one student using the student test workstation.

A yet further embodiment of the present invention provides such a system wherein the proctor software facilitates the assignment and reassignment of a student to the student test workstations.

Still yet another embodiment of the present invention provides such a system wherein the proctor software facilitates requests for assistance by a student to a proctor monitoring the proctor test workstation.

A still yet further embodiment of the present invention provides a statewide computer-based assessment administration system comprising: a data administration system including centrally hosted data administration servers; a network; and an operational testing system; the data administration system including a browser-capable workstation connectible via the network to the centrally-hosted data administration servers; the operational testing system including three subsystems connected to the network: a test delivery server running on a test delivery workstation and managing all aspects of a test session by acting as a data repository and hub for communication between the other subsystems, a proctor software running on a proctor test workstation providing a user interface for managing a test session by communicating with the test delivery server, and a student test software running on a student test workstation providing a user interface for displaying test items and recording responses.

One embodiment of the present invention provides a system for the administration of jurisdiction wide standardized examinations, the system comprising: an item bank management subsystem whereby items comprising the examinations may be accessed and edited by authorized test editors; an assessment bank management subsystem whereby assessment materials may be accessed and edited by the authorized test editors; a user management subsystem whereby a testee accesses the system and the examination is administered to the testee, the user management subsystem, comprising testee, teacher, and administrator import and export interfaces for batch updates and modifications; a test publication subsystem comprising an online assessment system that takes an item set and applies pre-established styles to compile the examination for a distribution method, the method being chosen from the group consisting of online distribution and paper distribution; a scoring subsystem whereby a user may manually score open response items, thereby obtaining testee results; an analysis subsystem comprising algorithms for the analysis of testee results; an reporting subsystem comprising algorithms for the analysis of testee results; a security subsystem whereby a technical administrator can control access to the system; and the system being rule based and configured to prompt users with specific steps and enforce the completion of the specific steps before proceeding to a next the specific step.

A further embodiment of the present invention provides a method for administering a test over a distributed computer network comprising transmitting test content to at least one data station from a central database, transmitting test content to at least one testing station, administering the test, transferring test results from the test station to the data station, storing the test results on the data station, uploading test results to the central database for analysis.

The features and advantages described herein are not all-inclusive and, in particular, many additional features and advantages will be apparent to one of ordinary skill in the art in view of the drawings, specification, and claims. Moreover, it should be noted that the language used in the specification has been principally selected for readability and instructional purposes, and not to limit the scope of the inventive subject matter.

### BRIEF DESCRIPTION OF THE DRAWINGS

FIG. 1 is a flow diagram illustrating a distributed computer testing system configured in accordance with one embodiment of the present invention.

FIG. 2 is a diagram illustrating a distributed computer testing system configured in accordance with one embodiment of the present invention.

FIG. 3 is a network connectivity diagram illustrating a distributed computer testing system configured in accordance with one embodiment of the present invention.

FIG. 4 is a diagram illustrating the server hardware data administration system of a distributed computer testing system configured in accordance with one embodiment of the present invention.

FIG. 5 is a diagram illustrating the pre-test administration configuration of a distributed computer testing system configured in accordance with one embodiment of the present invention.

FIG. 6 is a diagram illustrating the self-test administration configuration of a distributed computer testing system configured in accordance with one embodiment of the present invention.

FIG. 7 is a diagram illustrating the teacher sponsored administration configuration of a distributed computer testing system configured in accordance with one embodiment of the present invention.

FIG. 8 is a diagram illustrating the secure administration configuration of a distributed computer testing system configured in accordance with one embodiment of the present invention.

FIG. 9 is a diagram illustrating the post-administration dataflow of a distributed computer testing system configured in accordance with one embodiment of the present invention.

### DETAILED DESCRIPTION OF THE INVENTION

According to one embodiment of the present invention, a distributed computer system comprising a central data administration server communicating with data administration work stations, local test delivery servers, proctor test workstations, and student work stations located at schools or test centers is used to deliver a standardized test to test takers. The distributed system allows for decreased load on the central server at times of high demand, thereby avoiding data bottlenecks and the resulting decreases in work station performance and lags in test delivery.

One embodiment of such a test administration system provides three subsystems through which users may access the system to perform required tasks: a data administration system, a student testing system, and a proctoring system.

According to one such embodiment, the data administration system provides test administrators of the state, school district and test center levels to set permissions, manage users and school district information, organize, test sessions, administer assessments, and review results.

The student testing system, according to one embodiment, provides an interactive testing environment, designed to be comparable between various existing COTS displays already in the possession of the test centers. This facilitates uniform presentation of materials to all students minimizing environmental differences between students that may adversely effect test result accuracy.

The proctoring system, of one embodiment, provides exam proctors information monitoring student progress through the exam and providing controlling access to the examination materials. The proctor system interacts with the student testing system to allow for non-disruptive student requests for assistance from the proctor.

The computer testing system of one embodiment provides test security features. Software prevents test takers from engaging in a variety of activities which may compromise test integrity: copying test items, materials, or answers, book-marking material, sending or receiving messages, or visiting web sites. High levels of encryption are in tended to protect test data from corruption or interception by hackers, protecting both the exam and confidential student data. In one embodiment of the present invention a 128-bit encryption scheme is used.

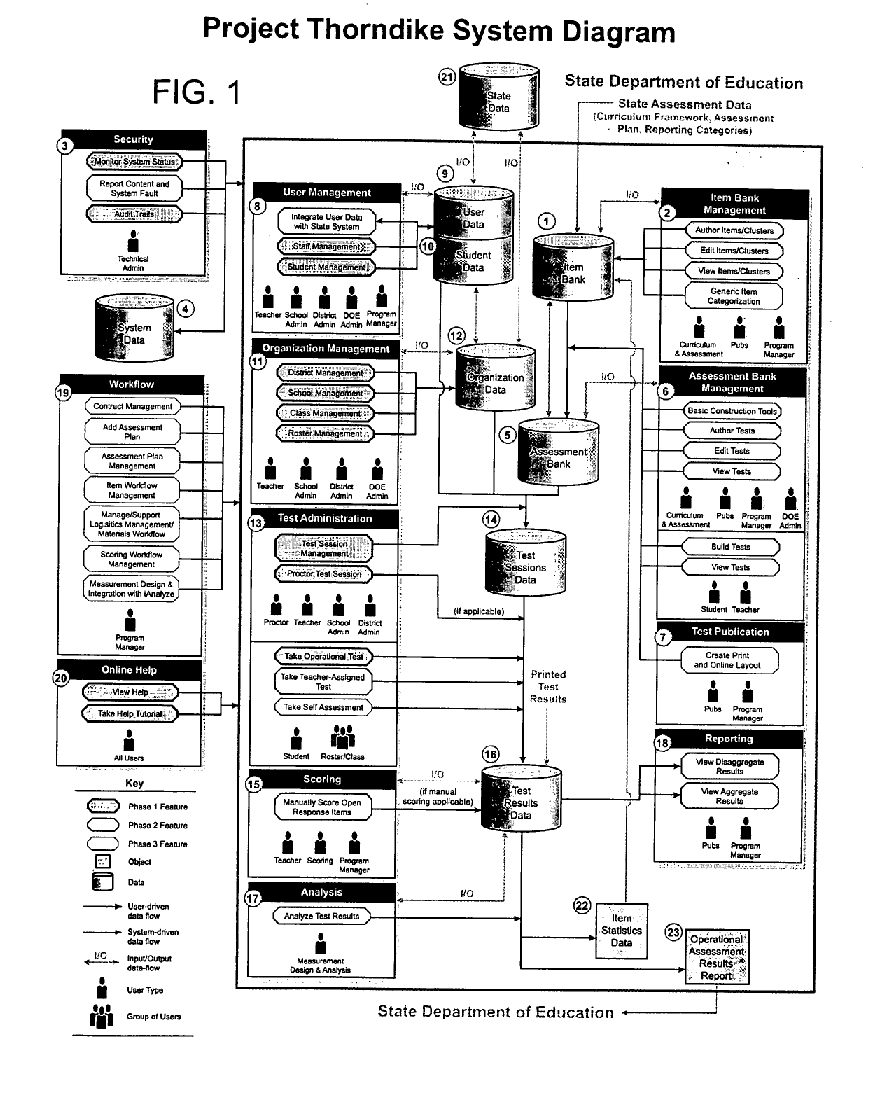

FIG. 1 is a system diagram illustrating one embodiment of a computerized testing system, which may be utilized as a state or jurisdiction-wide testing assessment system. The testing system is configured to be a comprehensive and integrated set of databases and interfaces that allow users to develop test items, construct tests, and administer tests either via direct connections through the Internet, or through a distributed architecture. The reference numbers below correspond to the reference numbers identifying elements on FIG. 1.

An item bank 10 contains information about the individual items such as the item stimulus (materials that provide context for the item), item stem (e.g., An example of a fruit is a . . . ), and possible responses if it is a multiple-choice question (e.g., A. banana, B. carrot, C. peanut, D. pickle), and other characteristics of the item. Item statistics (e.g., difficulty index, bi-serial correlation, item response theory a, b, and c statistics, model fit statistics, and differential item function statistics) are stored for each pilot, field, or operational administration of the item.

The item bank management user interface 12, is provided whereby users interact with the item bank 10. The item bank management user interface allows users to author items or clusters of related items, to edit items or clusters of related items, or to simply view items or item clusters.

The security interface 14 allows the users to access the System database in order to monitor the system status, and to audit the permissions associated with the system and the actions that have been performed on items and tests.

In the item authoring and editing process, a System Database 16 identifies the various actions that require permissions, and groups permissions into different default categories that may be assigned to particular users. For example, a Proctor might be allowed to administer tests, but not view test results. This same security system controls interactions through any of the other user interfaces in the system.

5. Assessments bank database. Tests consist of collections of test items, and the specifics of which items constitute a test are captured in the assessments bank database. Characteristics of tests such as the font, page styles etc., are all maintained in the assessment bank. Items themselves reside only in the item bank and thus, if an item is changed at any step in the editing process, that change propagates through the assessment bank.

6. Assessment bank management user interface. The assessment bank management user interface allows users to construct tests by putting sets of items together, to edit those tests, or to view those tests. The assessment bank management user interface may also allow users, such as classroom teachers, to build classroom unit tests or view those tests.

7. A test publication user interface. A test publication user interface allows users to create print or online layouts of the test for publication.

8. A user management interface. A user management interface accesses a user database (9) and a student database (10) to allow the users to assign rights to staff and students regarding the tests with which they may interact.

9. User database. Contains data on system users. These data include but are not limited to names, identification numbers, e-mail address and telephone number.

10. Student database. Contains data on students who will take tests using the system. These data include student names and identification numbers.

11. An organization management user interface. An organization management user interface allows users to manage districts, schools, classes, or rosters of students, the data of which is maintained in an organization database (12).

12. Organization database. Contains data regarding districts, schools, classes, or rosters of students.

13. A test administration user interface. A test administration user interface allows for the management of test sessions, by defining what tests are to be administered when and where and also allows proctors to assign students to particular testing stations and testing times. The test administration module also allows students to take operational tests, teacher assigned classroom tests, or practice tests by applying the information in the test session database.

14. Test session database. The test session database contains information related to the tests being administered to students. A test session might include the name of the session, the test to be administered during that session, and the time span in which the test may be administered.

15. A scoring user interface allows the user to input scores for items that require human grading, or to apply scoring keys to selected response questions that may be scored electronically, and places the results in a test results data base (16).

16. Test results database. The test results database contains data from the administration of tests using the system. Test results might include student level information such as raw scores (number of questions answered correctly); item response theory based scores (thetas), scaled scores, and percentile ranks, as well as aggregated information (e.g., average scores for classrooms, schools, and districts).

17. An analysis user interface. An analysis user interface allows psychometricians to analyze and perform quality controls of test data prior to the releasing of score results.

18. A reporting user interface. A reporting user interface allows test results to be reported in either aggregated or disaggregated fashion.

19. A workflow user interface. A workflow user interface will allow high level users to enforce required test development work activities such as item development, item editing, committee reviews, and client reviews. This will be done both in regard to what quality control procedures must be applied and the order in which they must be applied.

20. An online help user interface. An online help user interface will provide context sensitive or searchable help for all the other user interfaces in the system.

21. A state or client database. A state or client database will provide high-level information about the requirements of any particular contract. This may apply to what logo is used where, what subjects and grade levels are tested as part of the program, and other similar details.

One of ordinary skill in the art would readily appreciate that the use of this system for test administration is merely one embodiment, and that the system is susceptible to a variety of other uses, such as the administration of surveys, questionnaires, or other such data gathering, analysis, and reporting tasks. One skilled in the art would appreciate that this invention would be useful in education, medical/psychological research, market research, career counseling, and polling, as well as many other industries.

### Overview

The assessment administration system must perform in multiple environmental conditions: In which there is full connectivity between the main servers and the schools, and also when the schools are disconnected from the main servers.

NOTE: For phase I, disconnected service is a lower priority ‘nice to have’, but not required functionality. Because disconnected service is an architecturally significant aspect of the system design, it must be considered and provisioned for in Phase I, although not implemented in Phase I.

1.1 Synopsis

Past attempts to implement statewide electronic testing, both by Measured Progress and by other companies, have demonstrated significant and often profound performance issues, relating to the load characteristics of such a system, where many student test sessions hit the main servers all at once.

Both of these factors point to an architecture that moves significant functionality of the system toward the client side, distributing the test session tasks away from the main servers and down to the local systems.

The local client architecture that would accomplish this is a custom standalone client/server application, written in Java, C++, or other cross-platform language that would perform two distinct roles: server-level data and session management; and user facing functionality.

1.2 Advantages to design approach:

Ability to lock down the desktop during test sessions.

Ability to run disconnected from the main servers. (not available in Phase I)

Ability to off-load connectivity-intensive tasks such as image serving and test building.

1.3 Issues with design approach:

Increased security required.

Need to manage data redundancy and recoverability becomes more elaborate, because we no longer physically control all exposure points.

Cannot assure the timing of results availability because of lack of connectivity. (not an issue for Phase I connected sessions)

Availability of an absolute timestamp is problematic. (not an issue for Phase I connected sessions)

### Design Approach

1.4 Client Architecture

The proposed client architecture is to deploy a custom application on the test stations and proctor station that includes two components, a ‘satellite proxy server’, and a student/proctor/administrator interface.

At some point prior to test administration, network access to the central servers must be available, to download the client application, to download student enrollment and test session/schedule information, and to download the actual test content to the local ‘satellite’ servers. The client software install includes both the test administration piece and the server piece on each machine, so any computer is capable of acting as a satellite server.

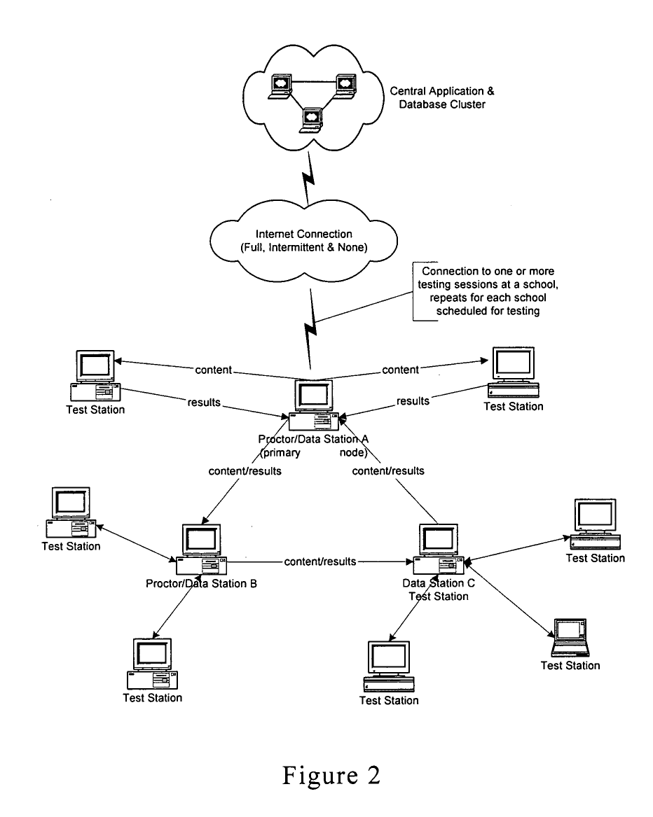

See FIG. 2

1.5 Central Application & Database Cluster

The main server cluster is responsible for storing all reference and transactional data. Data connections to update data (e.g. schedule a testing session) may be real time or processed in batch mode (e.g. uploading batches of student responses). All reporting and data imports and exports are performed on data residing here at the main servers (i.e. no reporting is done from the local client satellite proxy servers at schools). The main server cluster provides persistent database storage; result messaging queues, audit trail messaging queues, test session services, user administration services, and administrative services.

The main server cluster responds to requests from remote proxy stations to download testing content (items, graphics, etc) and reference data needed to remotely administer a testing session. Once test session data is downloaded to the local proxy, test sessions may commence without any communication (if needed) with the main server cluster. Business rules will determine how far in advance test content may be downloaded to remote testing sites. Since all content is encrypted during transmission and while residing on remote machines (except during test presentation), download lead times could vary from days/weeks to just-in-time for the testing session. The data required to remotely administer a disconnected test session is the school enrollment data (students, rosters, classes, grades, other non-student user data), test session schedule data (test times, rooms, assigned test stations, proctors assigned, rosters assigned, tests assigned) and the test content itself (test items, item cluster stimuli, ancillary test content such as headers, footers, instructions).

The main server cluster also responds to requests from remote proctoring stations to upload testing results (student responses) and new reference data created during the remote testing session (e.g. new student created to handle walk-in testing request). The main server cluster will have to first resolve any new reference data against existing data and assign unique identifiers as needed. The system response for result acquisition activity is not particularly critical, as there are no real-time impacts on users as there are in the actual test session. Expected upload processing time is in the 15-30 second range.

Requests to the main servers from remote sites to upload or download are handled in queued first-in-first-out (FIFO) order, where as many requests as possible are processed without affecting the performance of daily operations (esp. bogging down the database engine). Every request to download test content must match up with a corresponding request to upload results, e.g. cluster should see results for as many students as were scheduled to take the test or some administrative override (e.g. student got sick and could not finish the test).

Center cluster servers are configured as fully redundant at every point, from the VIP/load balancers to the RAID arrays and backup power supplies.

1.6 Internet Connection

Network connectivity between central cluster and distributed testing stations will vary from full availability to none. The connectivity will only affect the remote testing sites as all requests for uploading and downloading data will be originated by the remote site itself.

1.7 Proctor/Data Station

These workstations function as remote proxy servers during test administration. All test content is downloaded to 2 or more of these stations prior to the test. Student test results are stored on 2 or more and transmitted back to the main central cluster after the testing session has completed (or in batches during test administration if network connectivity is available). Each proctor station may have an administrative user present during test administration or simply function as a redundant data cache for test content and results. Test content is served to testing stations on demand during the testing session. Both content download and results upload are performed on a “push” basis with the central server, where the request is processed along with requests from other testing session proxy stations, on a FIFO basis.

Proctor/data stations will have to perform housekeeping tasks during application startup to detect if there is any local data stranded by an interruption or other failure during a prior testing session. Any data that has not been cached in a redundant location or is waiting to be uploaded to the central cluster must be processed before normal operations resume.

Proctor/data stations also store cached application reference data needed during the test administration. This data includes user enrollment for authentication, which may be updated offline from the database on the central cluster. Any remote updates to reference data have to be resolved when the data is uploaded and processing on the central cluster. This may involve replicating changes to existing students (e.g. correcting spelling of name) or the creation of a new student during the remote testing session. Unique identifiers for new students will be created at the time of upload.

These stations do not need to be configured using server-class hardware; they can simply be standard off-the-shelf workstations (single processor, IDE drives, single power supply, etc.). UPS backups are not required for these stations, but are recommended.

1.8 Testing Station

These workstations are standard, common computers as would be found in a school computer lab, on which a student takes tests. Testing stations will download all test content from one of the proctor/data stations configured for the testing session if one is available, or directly from the main cluster servers if no local proxies have been configured and Internet connectivity is available. Student test results are temporarily cached locally and on at least one other proctor station.

Testing stations also have housekeeping to perform during application startup, e.g. looking for prior testing session that has failed or was interrupted prior to completion, and polling the local area network for proxy data stations that may be running. Any local data that has not been stored on at least one other proctor stations will be processed before normal operations continue.

These stations also do not need any special hardware configuration and can be standard off-the-shelf desktop computers. UPS backups are not required for these stations, but are recommended.

1.9 Client-Side Setup Process

Log on to the central servers and register as an administrator or proctor.

Download software install from central servers; install the software on a local machine that will be a ‘proctoring’ station.

While connectivity to central servers is available, launch the software and log in with the registration information provided by Measured Progress.

The software will prompt a setup session, and initiate a connection to central servers, to download requisite session, enrollment, and test data. During this setup, the proctor station will be configured as a satellite server, capable of administering electronic tests to local test stations with or without connectivity to central servers.

The software is then installed on the test stations, which are then configured to ‘point’ to the proctor station.

The local test stations will then recognize the local proctor computer as the local satellite host, and will retrieve cached test content from that machine.

The local proctor ‘satellite server’ computer will then allow you to select, (or will select for you) two or more local test stations or other proctor stations that will act as ‘primary local cache servers’, to provide data redundancy. Any test station with the test/server software installed may act as a primary local server, with the server functionality being essentially invisible to the person using the computer as a test station . . . the server functionality is only visible to proctors and administrators.

1.10 Test Session Process

The previously configured local proctor satellite server software on the proctor computer is launched, and then the student test stations are launched.

The student test stations automatically establish a connection to the local satellite server, and/or directly to the central servers if they're available.

The students log in to the student test stations to begin their testing. Alternatively, the proctor performs the login on behalf of the student.

While the students are going through the opening dialogs, the test stations poll the local satellite and/or the central servers for session information and test content, and load the tests.

The proctors start the tests. Students may now interact with the test materials and record answers.

The student responses are incrementally encrypted and saved to the local disk, and simultaneously passed to the local satellite server.

The satellite server mirrors the response data to it's local ‘helpers’, the primary local cache servers, and if there is connectivity with the central servers, also pushes the response data incrementally up through the messaging interface.

Once the local satellite server has created redundant copies of the data on the local caches or has successfully uploaded the response data to the central servers, it sends a message to the student test station software, confirming the data. In receipt of confirmation, the student test station software then deletes the local disk copy of the data (it retains the response data in memory, to facilitate paging back through the test)

At all times there are at least two physical copies of all test response data in the local system, until the system receives confirmation that the central servers have safely received the data.

The test session closes.

When connectivity is available to the central servers, the local satellite server makes a connection, and uploads the session data, in the following order:

First, roster and enrollment changes (students added, dropped, changed)

Second, session and schedule data, to synchronize the main server schedule with the local revisions (i.e. changes to venue, time, etc.)

Next, the student response data.

Finally, the audit data.

The satellite server(s) and primary cache servers will continually poll for a connection to the central servers

### Failure & Recovery Scenarios

1. Lack of Internet connectivity pre-testing: Test content & reference data cannot be downloaded & cached in time for scheduling testing session (e.g. network connectivity is lost).

2. Lack of Internet connectivity post-testing: Student results cannot be uploaded in a timely fashion after testing session completed (e.g. network connectivity is lost).

3. Student testing session is interrupted and then restarted on another station (e.g. trivial hardware failure like bad keyboard)—student test session state needs to be available on the replacement test station.

4. Student testing session is interrupted due to catastrophic hardware failure and restarted on another station (e.g. hard disk crash, power supply fails)—student test session state needs to be available on the replacement test station.

5. All student-testing sessions for a given test are interrupted due to environmental issue (e.g. HVAC failure in the computer lab) and must be restarted on another set of stations—session state must be restored for each student.

6. All student-testing sessions for a given test are interrupted due to external failure (e.g. power failure to that computer lab) and must be restarted with student session states intact.

7. All student testing sessions in a school (e.g. includes all proctor/data stations) are interrupted due to widespread power failure, and must be restarted intact.

8. Loss of internet connectivity to the central servers during data operations—system must either roll back and retransmit the entire transaction when connectivity is restored, or be capable of resuming an incremental upload or download at the point of interruption.

9. Loss of local connectivity between the student test stations and the local satellite server/proctor station—test station must be able to complete the student session and retain the response data locally until connectivity can be reestablished.

10. Loss of power or other unexpected interruption of the test station.—system must be able to recover the test session up to the last student response, and recreate the student session either on the same test station or a different test station.

11. Loss of power or other unexpected interruption of the local satellite proxy server—system must maintain all student session data up to the point of failure, and must automatically establish a new local satellite proxy server (promote one of the existing primary cache servers to that role), ensure local data redundancy, and resume student test sessions.

Loss of power or other unexpected interruption of a local primary cache server—system must automatically establish a new primary cache server and rebuild the cached data.

### 1. Introduction

Measured Progress uses many applications that can be placed into three categories:

Tools used in business operations

Services provided to Customers

Products offered for use by Customers

These applications have evolved independently over time. It is a goal of Measured Progress to integrate these tools, services, and products into a unified workflow system. The system is the realization of that goal.

1.11 1.1 System Purpose

The system will fulfill three major corporate objectives.

1. Provide an internally owned, developed, and maintained full-service online assessment system. This system is essential to the ongoing success of Measured Progress in a fast growing and technology aware educational marketplace.

2. Provide an internal integrated workflow system for managing business operations and facilitating standardized data handling procedures. This system will enable divisions within Measured Progress and their Customers to easily access, transfer, share, and collaborate on development and distribution of assessment-related data and content.

3. Reduce costs associated with services by improving productivity of operational divisions and reducing contract errors. This will allow Measured Progress to become more competitive and grow market share.

The system shall meet the needs of short-term contract requirements by providing an online assessment system in the first phase of a three-phase development process, as described in the system Features by Phase table on page 9 of this document.

1.12 1.2 System Scope

The system shall consist of several key components, including:

Item Bank Management

Assessment Bank Management

User Management

Test Publication

Test Administration

Scoring

Analysis

Reporting

Rule-Based Design

Workflow Systems

Security

The following table is an overview of the system's functional components.

| # | Component | Description |
|---|---|---|
| 1 | Item Bank | An online item bank management tool |
| | Management | that allows Measured Progress and |
| | | customers the ability to import/export, |
| | | delete, access, author, and edit items |
| | | and/or item components (e.g., graphics). |
| 2 | Assessment Bank | An online assessment bank management |
| | Management | tool that allows Measured Progress and |
| | | customers the ability to import/export, |
| | | delete, access, author, edit, or build |
| | | tests and assessment materials. |
| 3 | User Management | An online user management tool that |
| | | allows registered students to access |
| | | the system and take tests under highly |
| | | secure or non-secure administration |
| | | conditions. The user management system |
| | | also provides student, teacher, and |
| | | administrator import and export interfaces |
| | | for batch updates and modifications. |
| 4 | Test Publication | An online assessment system that takes an |
| | | item set and applies pre-established |
| | | styles to publish a test for online use |
| | | or to create print ready copy. |
| 5 | Test Administration | An online test administration tool that |
| | | includes test classroom assistance and |
| | | a secure Web browser. |
| 6 | Scoring | Tools that enable a user to manually |
| | | grade open response items. |
| 7 | Analysis | Tools that use algorithms for analysis |
| | | of student results. |
| 8 | Reporting | Tools that use algorithms for reporting |
| | | of student results. |
| 9 | Rule-Based Design | The behavior of the system is described |
| | | in explicitly stated rules. |
| 10 | Workflow Systems | A set of online workflow tools that allows |
| | | choices as to what process steps are |
| | | required and enforces those steps for a |
| | | particular test or testing program (for |
| | | example, an item cannot be selected for |
| | | use in a test unless two content experts |
| | | have signed off on the content and one |
| | | editor has signed off on the usage. |
| 11 | Security | Enables a user to completely control |
| | | access to system resources. |

1.13 1.3 System Overview

The following diagram is an overview of the fully functional product suite at the completion of Phase III development (targeted for winter 2004). Components developed by phase are indicated. See FIG. 1

1.14 1.4 Project Overview

1.14.1. 1.4.1 Apportioning of Requirements by Phase

The system will be implemented in phases. While requirements will be developed and codified for all phases of the project on an ongoing basis, the initial product development (Phase I) will only target the minimum functional requirements to satisfy the Client operational online assessment administration. The first three phases are targeted as follows.

1.14.2. 1.4.1.1 Phase I—March 2003

Phase I will deliver an online assessment administration system to meet the specific requirements of the Client contract and will include the following features:

Item Bank Management

Item bank for test publication

Content independent of style presentation

Import, export, and delete items—system-level interfaces for batch processing

Assessment Bank Management

Assessment bank for test administration

Import, export, and delete tests—system-level interfaces for batch processing

User Management

Import, export, and delete users—system interface for batch processing

Security management—group-based permissions

Staff management—manage appropriate core staff groups

Student enrollment management—enrollment for online testing

District management—add, view, modify, and delete district

School management—add, view, modify, and delete school

Class management—add, view, modify, and delete class

Roster management—add, view, modify, and delete roster

Student management—add, view, modify, and delete student

View school, class, roster, and student data—access and view data according to permissions

Test Publication

Test construction—multilingual content

Test Administration

Test definition—multiple choice items, centralized administration, secure delivery, system monitoring, cross platform delivery

Test session management—create and modify operational test sessions, designate test parameters such as date, time, location, and assign proctor

Proctor test session—start-and-stop operational test, restart interrupted operational test, monitor test administration

Take operational test

Scoring

Response data bank—test results export interface

Analysis

Import and export item statistics for analysis

Reporting

View test scores and results

Immediate results reporting

View disaggregated detail reports

Rule-Based Design

Contract rules—reporting categories based on state curriculum frameworks, presentation rules for items and assessments

Personalize view—administrator-designated views

System permissions—role-based permissions

Workflow Systems

Data processing—test results export interface

Professional development—training (includes help tutorials), view help

Security

Monitor system status in real time

Audit trails—certify item and test data integrity, student data, and system data access

View item test audit reports (system monitoring tool)

1.14.3. 1.4.1.2 Phase II—December 2003

Phase II will continue development of the online test delivery system, add item development, and include the following features:

Item Bank Management

Item bank—SCORM/IMS standards

Import, export, and delete items—user interfaces for batch processing

Author items and clusters—item and cluster authoring tool, create item clusters from item bank

Edit items and clusters—item and cluster editing tool

Assessment Bank Management

Import, export, and delete tests—user interfaces for batch processing

Author tests—test authoring tool

Edit tests—test editing tool

View tests in test bank

Build test—create test from item bank

User Management

User data bank—SIF-compliant enrollment

Import, export, and delete users—integration with state system

Staff management—manage customized staff groups

Class management—class and teacher scheduler

Test Publication

Test construction—algorithmic test construction

Test Administration

Test definition—short answer and constructed response items, printed tests, industry standard multi-media formats

Test session management—assign non-operational tests created from item bank, and print online test

Take teacher-assigned test

Scoring

Response data bank—iScore integration

Score test results—score operational short answer and constructed response items with integration of iScore (SCOR), and score short answer and constructed items in teacher assigned tests

Reporting

View test scores and results—ad hoc reporting

View aggregate and rollup reports

Rule-Based Design

Data rules—items align to multiple contracts

Personalize view—student-designated views

System permissions for individual by feature and function

Workflow Systems

Scoring workflow management—integration with iScore

MDA—integration with iAnalyze

Security

Report content and system fault

1.14.4. 1.4.1.3 Phase III—December 2004

Phase III will continue development of the online assessment administration system and workflow tools, provide distributed and disconnected test administration, and add the following features:

Item Bank Management

Item bank—generic item categorization (duplicate checking, item warehousing and mining)

View items and clusters—item and cluster review

Assessment Bank Management

Author tests—create test forms from item bank, and item selection for operational tests

View tests—online test review

User Management

User data bank—LMM integration

Student enrollment management—provide interoperability with DOE Student Information Systems

Test Publication

Create camera-ready and online layout for paper-and-pencil and online forms

Test Administration

Test definition—distributed administration, expanded item types

Take self assessment

Analysis

Analyze test results—analyze student and test results by selected criterion, for example, gender

Workflow Systems

Contract management—executive management view and manage contract information such as delivery dates, contract design tool

Add assessment plan—assessment plan design tool

Assessment plan management—manage assessment plan

Item workflow management—manage item and test construction workflow, and item review

Manage and support publications workflow—provide tools to assist in managing item, graphic, and test publication

Manage and support LMM workflow—provide tools to assist LMM in tracking LMM-related information (shipping, contact info, materials tracking)

Scoring workflow management—manage item and test scoring

Security

Adaptive testing

1.14.5. 1.4.1.4 Future Development—2005?

Future development will include enhanced test and scoring functions, such as the following features:

Publications

Test construction—adaptive testing

Workflow

Contract management—multilingual user interface

Analysis

Analyze test results—on-the-fly equating and scaling; scaling with tables, normative data lookup; readability analysis; classical item statistics; test analysis; DIF, IRT, statistics; and equating

1.14.6. 1.4.2 Features by Phase

The following four tables identify the major system components, rule-based design, workflow systems, and security, available by phase of the development cycle.

Features by Phase
Legend

| | | | | | | | |
|---|---|---|---|---|---|---|---|
| C&A | Curriculum and | LMM | Logistics and | PM | Program Management | SCOR | Scoring |
| | Assessment | | Materials Management | | | | |
| DA | District Administrator | P | Proctor | S | Student | T | Teacher |
| DOE | Department of Education | PUB | Publications | SA | School Administrator | TA | Technical |
| | | | | | | | Administrator |

Major System Components

| | | | |
|---|---|---|---|
| Component | Phase I | Phase II | Phase III |

Item Bank Management

| | | | |
|---|---|---|---|
| Item Bank | Content independent of | SCORM/IMS standards | Generic item |
| | style presentation | | categorization (duplicate |
| | Item bank | | checking, item warehousing |
| | for test publication | | and mining) |
| Import, Export, and | System-level interfaces | User interfaces for batch | |
| Delete Items | for batch processing | processing | |
| Author Items and | | Item and cluster authoring | |
| Clusters | | tool (C&A) | |
| | | Create item clusters | |
| | | from item bank (DOE) | |
| Edit Items and | | Item and cluster editing | |
| Clusters | | tool (C&A) | |
| View Items and | | | Item and cluster review |
| Clusters | | | (C&A, PM, PUB, DOE) |

Assessment Bank Management

| | | | |
|---|---|---|---|
| Assessment Bank | Assessment bank for test | | |
| | administration | | |
| Import, Export, and | System-level interfaces | User interfaces for batch | |
| Delete Tests | for batch processing | processing | |
| Author Tests | | Test authoring tool (C&A) | Create test forms from |
| | | | item bank (C&A) |
| | | | Item selection for |
| | | | operational tests |
| | | | (C&A, PM, DOE) |
| Edit Tests | | Test editing tool (C&A) | |
| View Tests | | View tests in test bank | Online test review (C&A, |
| | | (C&A, PM, PUB, DOE) | PM, PUB, DOE) |
| Build Test | | Create test from item bank | |
| | | (DOE, SA, T, S) | |

User Management

| | | | |
|---|---|---|---|
| User Data Bank | | SIF-compliant enrollment | LMM integration |
| Import, Export, and | System Interface for batch | Integration with state | |
| Delete Users | processing | system | |
| Security Management | Group-based permissions | | |
| | (TA) | | |
| Staff Management | Manage appropriate core | Manage customized staff | |
| | staff groups (DOE, SA) | groups (DOE, SA) | |
| Student Enrollment | Enrollment for online | | Provide interoperability |
| Management | testing (DOE) | | with DOE Student |
| | | | Information Systems (DOE, |
| | | | SA) |
| District Management | Add, view, modify, and | | |
| | delete district (DOE) | | |
| School Management | Add, view, modify, and | | |
| | delete school (SA) | | |
| Class Management | Add, view, modify, and | Class and teacher | |
| | delete class (SA, T) | scheduler | |
| Roster Management | Add, view, modify, and | | |
| | delete roster (SA, T) | | |
| Student Management | Add, view, modify, and | | |
| | delete student (SA, T) | | |
| View School, Class, | Access and view data | | |
| Roster, and Student | according to permissions | | |
| Data | (DOE, SA, T, S) | | |

Test Publication

| | | | |
|---|---|---|---|
| Test Construction | Multilingual content | Algorithmic test | |
| | | construction | |
| Create Camera-Ready | | | Camera-ready and online |
| and Online Layout | | | layout for paper-and-pencil |
| | | | and online forms (PUB) |

Test Administration

| | | | |
|---|---|---|---|
| Test Definition | Multiple choice items | Short answer and | Distributed administration |
| | Centralized administration | constructed response | Expanded item types |
| | Secure delivery | items | |
| | System monitoring | Printed tests | |
| | Cross platform delivery | Industry standard multi- | |
| | | media formats | |
| Test Session | Create and modify | Assign non-operational | |
| Management | operational test sessions, | tests created from item | |
| | designate test parameters | bank, and print online | |
| | such as date, time, location, | test (T/P) | |
| | and assign proctor (DOE, | | |
| | DA, SA) | | |
| Proctor Test Session | Start-and-stop operational | | |
| | test, restart interrupted | | |
| | operational test, monitor | | |
| | test administration (T/P) | | |
| Take Operational Test | Take operational test (S) | | |
| Take Teacher- | | Take teacher assigned | |
| Assigned Test | | test (S) | |
| Take Self Assessment | | | Take self-assessment (S) |

Scoring

| | | |
|---|---|---|
| Response Data Bank | Test results export | iScore integration |
| | interface | |
| Score Test Results | | Score operational short |
| | | answer and constructed |
| | | response items with |
| | | integration of iScore |
| | | (SCOR) |
| | | Score short answer and |
| | | constructed items in |
| | | teacher assigned tests (T) |

Analysis

| | | |
|---|---|---|
| Import and Export | Import and export of item | |
| Item Statistics | statistics for analysis | |
| | (MDA) | |
| Analyze Test Results | | Analyze student and test |
| | | results by selected criterion, |
| | | for example, gender (DOE, |
| | | SA, T) |

Reporting

| | | |
|---|---|---|
| View Test Scores and | View test scores and | Ad hoc reporting |
| Results | results (DOE, SA, T, S) | |
| | Immediate results | |
| | reporting | |
| View Aggregate and | | View aggregate and rollup |
| Rollup Reports | | reports (DOE, SA, T) |
| View Disaggregated | View disaggregated detail | |
| Detail Reports | reports (DOE, SA, T) | |

Rule-Based Design

| Rule | Phase I | Phase II | Phase III |
|---|---|---|---|
| Data Rules | | Items align to multiple | |
| | | contracts | |
| Contract Rules | Reporting categories | | |
| | based on State Curriculum | | |
| | Frameworks | | |
| | Presentation rules for | | |
| | items and assessments | | |
| Personalize View | Administrator-designated | Student-designated views | |
| | views | (S) | |
| System Permissions | Role-based permissions | Permissions for individual | |
| | | by feature and function | |

Workflow Systems

| Division | Phase I | Phase II | Phase III |
|---|---|---|---|
| Contract Management | | | Executive management |
| | | | view and manage contract |
| | | | information such as delivery |
| | | | dates, contract design tool |
| | | | (PM) |
| Add Assessment Plan | | | Assessment plan design |
| | | | tool (PM) |
| Assessment Plan | | | Manage assessment plan |
| Management | | | (PM) |
| Item Workflow | | | Manage item and test |
| Management | | | construction workflow(C&A) |
| | | | Manage item review |
| | | | (PUB) |
| Manage and Support | | | Provide tools to assist in |
| Publications Workflow | | | managing item, graphic, and |
| | | | test publication (PUB) |
| Manage and Support | | | Provide tools to assist |
| LMM Workflow | | | LMM in tracking LMM- |
| | | | related information |
| | | | (shipping, contact info, |
| | | | materials tracking) (LMM) |
| Data Processing | Test results export | | |
| | interface | | |
| Scoring Workflow | | Integration with iScore | Manage item and test |
| Management | | | scoring (SCOR) |
| MDA | | Integration with iAnalyze | |
| Professional | Training (includes help | | |
| Development | tutorials) (TA) | | |
| | View help | | |
| | (DOE, SA, T,S) | | |

Security

| Concern | Phase I | Phase II | Phase III |
|---|---|---|---|
| Monitor System Status | Monitor system status in | | |
| | real time (SA, TA) | | |
| Report Content and | | Report content and system | |
| System Fault | | fault (DOE, SA, TA, T, S) | |
| Audit Trails | Certify item and test data | | Adaptive testing |
| | integrity | | |
| | Certify student data | | |
| | Certify system data access | | |
| | View item test audit | | |
| | reports (system monitoring | | |
| | tool) | | |

Future
Adaptive testing
Multilingual user interface
On-the-fly equating and scaling; scaling with tables, normative data lookup; readability analysis; classical item
statistics; test analysis; DIP, IRT, statistics; and equating

1.15 1.6 About this Document

The SyRS presents the results of the definition of need, the operational concept, and the system analysis tasks for the system. As such, it is a description of what the Customers expect the system to do for them, the system's expected environment, the system's usage profile, its performance parameters, and its expected quality and effectiveness.

This document contains the following sections:

1. Introduction

2. General System Description

3. System Capabilities, Conditions, and Constraints

4. System Interfaces

### 2. General System Description

2.1 System Context

The system is intended to integrate assessment planning, item construction, test construction, online administration, paper-based administration, scoring, and reporting data. It will enhance communication and workflow, greatly improve efficiency and collaboration, reduce costs, and streamline development.

2.2 Major System Capabilities

1.15.1. 2.2.1 Pre-Test Administration

The system shall provide a repository and workspace for contract and assessment plan data, item content and metadata (e.g., item materials, clusters of items), and for test data.

The System shall provide workflow tools for reporting achievement of assessment plan milestones. It will provide tools for controlling and tracking the quality of item content and item metadata, and for controlling access to assessment materials. This will assist Measured Progress in meeting its contract obligations for item development, assessment quality, and security.

The system shall provide a toolset for item authoring and publishing. This will improve the efficiency and accuracy of item creation, evaluation, and selection for use in tests.

The system data management and workflow models shall ensure and certify item data integrity including version control.

The system shall store items and test data in a presentation-neutral format. This shall provide for presentation in a variety of formats. It will also enable a consistent presentation of tests across multiple delivery methods—preprinted, electronic, and on-demand printed.

The system shall provide for electronic search and comparison of items to prevent duplicate or conflicting items. This will assist in preventing item duplication and help prevent item enemies.

The system shall search and retrieve items independent of individual contracts. This will facilitate the reuse of items.

1.15.2. 2.2.2 Test Administration

The system shall provide the administration of secure tests via the Internet.

The system shall securely process and store class, roster, and test schedule data. It shall deliver test content to students, and receive and score student response data. It shall provide a secure environment to store, manage, process, and report student enrollment data.

The system shall enforce student privacy requirements. It shall implement a user, group, and role-based security system. This will protect student identification data and non-aggregated response data that uniquely identifies individuals. The system will implement “need-to-know” access rules that limit exposure of private student data.

1.15.3. 2.2.3 Post-Test Administration

The system shall score, analyze and report both raw and equated student results.

The system shall assure accuracy and reduce turn around time by providing an extremely accurate electronic test scoring system. For tests that can be scored electronically, results shall be available immediately.

The system shall allow ad-hoc reporting, and both aggregate and individual score reporting.

The system shall support federal and state mandated reporting standards. The online testing system shall provide an extendable student data interface for capturing and working with the federal and state mandated data.

The system shall efficiently and accurately integrate results from paper and electronic assessments. The online testing system will have the capability to access and assemble test results data from both paper-based assessments and electronic sources.

The system shall audit and certify assessment process, data, and results. Both the item bank management system and online testing system will implement audit and control processes. The system shall log every user access to information. This log shall include user access to student information and student results information. This logging provides access security with a high degree of confidence.

1.15.4. 2.2.4 Distributed Architecture

The online assessment administration component of the system shall be built with a distributed architecture. This shall provide the capacity for a variety of centralized and/or decentralized deployments of online assessment administrations.

1.15.5. 2.2.5 Framework

The products of Measured Progress must match the needs of each Customer. A Customer's needs are not fully known until a contract is negotiated. Constructing a new custom system for each Customer requires time and is expensive. The architecture of the products could provide a partial solution to this issue. The system would consist of two kinds of components:

1. Components with a design that is the result of the technology that is used to implement them. These components do not change from one Customer to the next. This part of the system would only need to be built once.

2. Components with a design that implement specific Customer-specified policies. If the policies are made an intrinsic part of the component, then the component would have to be redesigned for each Customer. If the policies are stated in a set of rules, and those rules are used by the component, then only the rules would have to be rewritten for each new Customer.

The system framework will be developed to enable implementation of Customer-specific features easily and efficiently. This framework includes the features detailed below:

2.2.5.1 User Management. User information shall be entered once and then integrated throughout the system.

2.2.5.2 Access and Security. The security and access control mechanism should be uniform across the products. This would allow the management of security and access definition to apply to all the products. While the security and access can be specified to completely implement a Customer's policy, the product shall have a default configuration that represents a typical pattern.

2.2.5.3 Rule-Based Behavior. Controlling the behavior of the system with a rule-based system provides the flexibility to customize the system by changing the definition of the rules. This provides the user the ability to make complex changes without requiring technical programming skills. The mechanism for changing the rules is a graphical user interface that allows the user to make their changes using “point-and-click.” Rule-based techniques provide generic control mechanisms and can be used at many levels in the system, from managing the configuration to determining item presentation.

2.2.5.3.1 Rule-Based System Design—An Overview. Software applications work through the use of events, operations, and states. An event is a stimulus or command, typically from outside the system. An operation is an activity or process that occurs within the system, usually in response to an event. A state (or, ‘the’ state) is the current condition of the application, its environment, and its data.

Typically, an event occurs, which triggers an operation that changes the state of the system. For example, receipt of a web client login triggers the serving of the user home page. This changes the state of the system: the system now has a new web login session and has perhaps accessed user data from the persistent data store and used it to build the home page.

System activity can also be considered in terms of ‘objects’ and ‘policies.’ Objects are the ‘things’ that are acted on in a software application, and policies are the definitions of what can happen to the objects and what the objects can do. Within The system, examples of objects include Users, Tests, Test Sessions, Schools, Districts, Rosters, etc.

Generally, a rule-based system is one in which the objects have been designed and coded along with the operations that can be performed on/by the objects, but the policies, or “rules” about how the objects interact have been abstracted out of code, and exist as a collection of statements or rules.

This collection of rules can be in a variety of forms. Typically they are organized as decision trees and lists of ‘if-then’ type statements. While there are strict guidelines for the syntax used to write rules, they can range from relatively straightforward English to complex programming language, such as XML-based rules.

The rule collection can describe security permissions. For example:

“if {user} is member of {Student group}, then allow [session.takeTest( )]” or “if {user} is not member of {Administrator group}, then disallow [student.result.access( )].”

Rule collections can also describe data cardinality. For example:

“if {user} is member of {Student group}, then {user} must be assigned to {school}.”

The rule collection can describe other aspects of the application—basically anything that is a ‘policy.’

Rule-based architecture marries object-oriented design concepts with computational intelligence models. The objects are built as programming code, and the policies are implemented using rule collections. Instead of having the business logic embedded in the programming code, it is instead accessible in human-readable form in the rules engine layer.

Instead of being an “event ∀ operation ∀ state” model, the system design becomes “event ∀ state+rule ∀ result.”

A ‘rules engine’ component of the system interprets the state of the system (including new information from the event) and ‘walks the rules’ until it finds one that matches, then performs the activity described in the rule to create the result, or new system state.

When a rule-based system is deployed, the functionality and operations of the system are implemented in the rules. When the system must be reconfigured for a different use or deployment, it is deployed with a new set of rule collections, which implement the new or different functionality and operations. Massive configurability of rule-based systems for multiple deployments is a primary advantage for the system.

2.2.5.4 Monitoring. The system application operations shall be continuously visible. They will be able to be continuously monitored to ensure performance, reliability and security. The system shall permit monitoring while it is operating and will include the operations of the applications as well as the platform.

2.2.5.5 Auditing. To ensure security (no tampering with sensitive data) and privacy, the system applications shall maintain and track records of specific user activities and system operations while those operations are performed. Each application shall record its operations and the reason for the operation. These stored records allow the system to be audited.

2.2.5.6 Generic Mechanism. All the applications shall use the same mechanisms for creating their audit trails. This allows the auditing tools to be developed without regard to any application. This promotes an evaluation operation that will work equivalently for all applications.

2.2.5.7 Logs. The operations performed by an application are entered in the system log. This would include any error or exceptional conditions that the application encountered. These logs can be scanned during operations.

2.2.5.8 Journals. The system shall keep journals of the transactions it performs. These journals include the data that was used in the transaction.

2.2.5.9 Workflow. An object shall move from operation to operation until its state is the desired value. The flow of an object through process shall be controlled by:

1. A work-in-process application that tracks changes in state, and

2. A set of rules that indicate the next operation based on the current operation and the state of the object, as shown in the workflow process example below.

For example, after field-testing, an item is in the state “spelling error,” and the rules are:

| Current Operation | Object State | Next Operation |
|---|---|---|
| Field Test | Spell Error | Text Editing |
| Text Editing | Field Ready | Field Test |
| Field Test | Bad Graphic | Graphic Editing |
| Graphic Editing | Field Ready | Field Test |

The rules result in the object being routed to the “text editing” operation.

2.2.5.10 Work-In-Process. A work-in-process application shall track the state of each object processed by other applications. The application shall record the state of an object with two values: (1) the object's unique identification and (2) the state of the object.

Each time an operation is performed on an object, the object's state shall change. For example, when an editor approves an object for distribution, the state of the object shall change from “needs editing” to “distributable.”

To track changes in an object's state, the application shall be notified each time the state of the object changes. When operations are performed in conjunction with other applications, these applications shall automatically provide this notification.

1.15.6. 2.2.6 Scalability

The online assessment administration shall scale to have one million uses, and with 10% of the users having concurrent access.

Scalability of the online assessment administration shall be achieved by modular design and construction. The design shall separate the operations so that multiple “standard” PC computers acting in concert can accomplish them. Adding more PC modules can increase capacity.

1.15.7. 2.2.7 Continuous Availability

The goal of continuous operation increases the number of resources required. All resources used by the product must be replaceable. As there is no system “downtime,” the mean time to repair/replace (MTTR) of failures resourced must be less than their mean time between failures (MTBF).

1.15.8. 2.2.8 Security

Access to information can be restricted by explicitly specifying rules. For example, a rule may state that assessment experts may modify an item but a proctor may not.

2.2.9 Data Integrity

The data integrity requirements of the product could increase the amount of resources needed. Consider the case of a product with two disks. If a disk fails, the product operation can continue. If the second disk fails, the data would be lost. The data integrity requirement states that no data can be lost. This requires that product operations cease after a disk failure. If a third disk is configured in the product, the product operations could continue without the risk of lost data.

The system shall not lose or alter any data that is entered into the system. The mechanisms for the data entering may fail during a data entry transaction, and the data of the failed transaction may be lost.

1.15.9. 2.2.10 Diagnostics

There will be a set of diagnostics that will be able to detect faults.

1.15.10. 2.2.11 Fault Recovery

Availability and data integrity of the products require use of fault tolerance, transactions, and resource replacement. Tolerance covers the removal of resources from active operations. Transactions minimize damage caused by a fault. Resource replacement adds a working resource to active operations.

2.2.12 Tolerance

The tolerance of resource failure is based on having redundant resources.

A fault is tolerated by five operations:

1. Detecting the fault;

2. Removing the failed resource from the active configuration;

3. Recovering from the effects of the fault, such as, removing incomplete transactions;

4. Resuming operations; and

5. Replacing the failed resource if it is replaceable.

1.15.11. 2.2.13 Transactions

A transaction is a unit of work. There are events in the life of a transaction as follows:

1. Information in the product is in a self-consistent state;

2. The transaction begins;

3. All changes to information are performed, and the information is once again in a self-consistent state; and

4. The transaction ends.

The transaction has this property; either all the changes to the information are made or none of the changes to the information are made. This means that if a fault occurs in the operations of a transaction, all the changes since the start of the transaction are removed.

Transactions limit the effect of a fault on information. Only the information used in the active transaction can be effected. Transactions insure that partially-modified information will not be left in the product. If the transaction involves new information, and the transaction fails, the new information will be lost.

Small transactions lose small amounts of data when they fail. Large transactions lose large amounts of data when they fail.

Transactions are not free. They cost time and resources. The cost of transactions must be weighted against the cost of losing data.

1.15.12. 2.2.14 Resource Replacement

There are two types of resources:

1. Resources that cannot be repaired or replaced during active operations; and

2. Resources that can be repaired or replaced during active operations.

To tolerate a fault in a resource that can be repaired, the product:

1. Removes it from the active configuration;

2. Causes an available repair operation; and

3. Adds it to the active configuration.

To tolerate a fault in a resource that can only be replaced, the product:

1. Removes it from the active configuration;

2. Selects an available resource as a replacement;

3. Performs operations necessary to make the new resource compatible with the current state of the active configuration (for example, a clean disk replacing a disk that held a database would be loaded with the last backup of the database and then “rolled forward” with the database's after image journal); and

4. Adds it to the active configuration.

1.15.13. 2.2.15 Estimating Required Tolerance

The amount of fault tolerance in a product can be determined by three considerations:

1. Reliability of the resources;

2. Availability requirements; and

3. Data Integrity requirements.

2.2.16 Reliability

The number of redundant resources that are required can be estimated. Each type of resource must be considered in turn.

A way to measure the reliability of a resource is the mean time between failures (MTBF). The MTBF varies for each type of resource, its brand, and its model. The MTBF indicates the time between failures. A way to measure the time it takes to replace or repair a resource is the mean time to repair/replace (MTTR). The MTTR varies for each type of resource and the operations of the platform.

If the MTBF is less than the MTTR, then the product will continuously lose resources during its operation. There must be enough redundancy of the failing resource to last through the time of operation.

If continuous operation is not required, then “downtime” could be used to repair the failed resources. If the MTTR is less than the MTBF, then failed resources will be replaced/repaired more quickly than they fail.

Failures are not always random events. Consider:

There is an effect, called infant-mortality that describes the high failure rates during the early use of brand new resources.

If the failure rate is related to the use of the product, such as it is in light bulbs, then a group of new resources that enter into service at the same time might all wear out about the same time.

Causes of failures that come from the manufacturing of many new resources could result in all the resources in the operational pool to having a time-between-failure that is significantly different from the MTBF.

2.2.17 Resource State

A replacement resource may not have the required state to join the operations of the product. Consider the failure of a disk drive that held a database. The new disk would function correctly as a disk, but could not operate with the product until after the database had been reloaded and brought up to date. This extra time should be added to the MTTR for this resource. The products consider both resources and the state of the resource.

2.2.18 Rule-Based Configuration Management

Configuration management shall be driven by an explicitly specified set of rules.

The system shall indicate when it is nearing a threshold and automatically responds, e.g., scales up, shuts down, etc.

2.2.19 Items

1. Iterative Item Workflow. Process that creates and maintains items.

2. Rule-based Access. Access to items shall be rule-based.

3. Structure. An item contains both content and information about the presentation of that content.

4. Single Language Items. An item in only one language is considered a multilingual item with only one language.

5. Multilingual Items. For a multilingual item, there is a separate copy of the content in each language. Information about presentation is stored separately for each language.

6. Item Translation. For the English language item Item 123 that needs to be translated into Spanish and French, the translations from the original language would be:

| Language | Version | | Language | Version |
|---|---|---|---|---|
| English | 2.4 | => | Spanish | 1.1 |
| English | 2.4 | | French | 1.1 |

7. Checking Translations. To check translations, the translated versions are retranslated to the original language, for example:

| Language | Version | | Language | Version |
|---|---|---|---|---|
| French | 1.1 | => | English | 2.5 |
| Spanish | 1.1 | | English | 2.5 |

9. Cross-Checking Translations. To cross check translations, the translated versions are used to generate another copy of each translation, e.g., the cross translation of Item 123 would be:

| Language | Version | | Language | Version |
|---|---|---|---|---|
| French | 1.1 | => | Spanish | 1.2 |
| Spanish | 1.1 | | French | 1.2 |

2.3 Major System Conditions

A baseline system configuration shall be tested and certified to support 1 million total users at 20% concurrency. To meet this baseline availability, Customer and Measured Progress usage will be as follows.

2.3.1 Customer Side

Sustain a load of 200,000 concurrent user sessions. Provide 99.99% of response times<5 seconds. Have mean response times<1 second. Archive student data for 5 years. Suffer a worst-case data loss of 5 minutes of clock time.

2.3.2 Measured Progress Side

Support 10,000 users and 1,000 concurrent user sessions. Provide 99.99% of response times<5 seconds. Have mean response times<1 second. Archive student data for 5 years. Suffer a worst-case data loss of 5 minutes of clock time.

The largest constraint upon the performance of The system as an online test administration system will be extremely “spiky” high usage loads.

Curriculum-based assessments are typically administered on a statewide basis, with the same test presented to thousands of students on the same day and hour, and in fact within virtually the same span of minutes. This results in surges in application traffic as user sessions request authentication (log-in) or submit test results at approximately the same time.

System performance shall not degrade as a result of this “spiky” load phenomenon.

The system cluster architecture and modular design shall enable The system to meet performance requirements. System performance shall incorporate monitoring tools to ensure that The system will deliver acceptable processing times under heavy load conditions.

2.4 User Characteristics

| User Types | Description |
|---|---|
| Auditor | The auditor analyzes and performs compliance |
| | and acceptance reporting on the security, |
| | availability, and performance of the online |
| | assessment system. |
| Curriculum and | C&A produces the assessment plan, and |
| Assessment (C&A) | conducts the item and test authoring |
| | processes. |
| Department of | DOE is the usual signatory to a Measured |
| Education (DOE) | Progress contract, and provides assessment |
| | plan requirements, provides for adequate |
| | facilities for testing, and receives |
| | reports via the test results and the |
| | testing process. |
| Measurement, | MDA uses raw score data to perform |
| Design, and Analysis | sophisticated analysis of tests: |
| (MDA) | appropriateness to curriculum, difficulty, |
| | and item performance. |
| Proctor | An individual who administers tests. As |
| | part of managing the room during |
| | an administration, the proctor may |
| | identify students, assist with the test |
| | process, and monitor students for |
| | inappropriate activity. |
| Program Manager | The Program Manager (PM) manages the |
| | Customer relationship and is the |
| | escalation point of contact for issues |
| | and problems relating to the contract. |
| | The Program Manager also manages the |
| | deliverables and schedule, and marshals |
| | the resources necessary for Measured |
| | Progress responsibilities under the |
| | contract. |
| Publications | Publications perform the pre-press |
| | processing for printed tests and booklet |
| | layout. The Publications department also |
| | performs item and test quality assurance. |
| School | A school administrator manages teachers |
| Administrator | and provides direction and oversight for |
| | the testing process within a school or |
| | school system. |
| Scoring | Scoring receives test materials back from |
| | students and schools, and processes them |
| | to extract raw score data. |
| Student | A uniquely identified individual in grades |
| | K through 12 who takes online tests using |
| | the system. |
| Teacher | A uniquely identified individual who |
| | manages students, classes, and rosters. |
| Technical | A technical administrator provides technical |
| Administrator | support for exceptions such as hardware |
| | failures, network outages, etc., to the |
| | testing process at the local facility. The |
| | technical administrator responsibilities |
| | may be local to the school or district, or |
| | may not exist at all on the Customer side. |
| | If there is no technical administration |
| | provided by the Customer, these |
| | responsibilities shift to Measured Progress |
| | support staff. |
| Trainer | A trainer will educate teachers, |
| | administrators, and proctors on how the |
| | system functions. |

2.5 Assumptions and Dependencies

1. The system shall be developed with technologies appropriate for each component of the system. The server side components shall be developed using the J2EE language and environment (Java 2 Enterprise Edition). The client side components shall be developed using Macromedia Flash, J2EE, SVG, or another authoring environment. This is currently being researched.

2. Internet connectivity shall be required at some point in time for all deployment models (disconnected and continuously connected).

3. There shall be sufficient resources on client and server (CPU, RAM, disk space) to run applications within the performance requirements.

4. There shall be sufficient bandwidth on client and server for a specific deployment model to support the performance requirements.

5. Buffering/caching shall be used to alleviate network latency and response time.

6. Security requirements for item and test content shall be implemented and enforced on both the client side and server side.

7. Federal requirements for assistive technology shall be met on the client side.

8. Existing Measured Progress systems and technologies shall be integrated with application interfaces and data sharing.

9. The system shall scale to meet Measured Progress concurrent workflow needs.

10. The system shall be built with rule-based policies. This provides the ability to custom configure each contract implementation without changing the application core.

11. Item types shall include industry standard multimedia formats (audio, video, text, images, DHTML).

12. Item presentation shall use template driven presentation for finer control, e.g., able to adjust rendering within a specific type of item.

2.6 Operational Scenarios

The following four operational scenarios describe incrementally diminishing levels of Measured Progress administration and control responsibilities, and increasing levels of Customer ownership and responsibility. The first scenario assumes complete Measured Progress responsibility and ownership, and the last assumes complete Customer ownership. This ownership includes all item bank development and management, test administration, and scoring/reporting functions.

2.6.1 Scenario 1. Measured Progress Centrally Managed Solution

Measured Progress owns and controls all aspects of the system. A distinct and separate online assessment system can be deployed for each contract. The online assessment system is hardware-provisioned to fit the anticipated student population and assessment plan, which includes the number of students per test, frequency of tests, and the anticipated concurrent users.

Pre-Test Administration. The various deployed online assessment systems are served by an item bank management system across all contracts. It functions as the ‘master’ item and test content source. Items and tests used by various online assessment systems initially ‘pull’ master test content from the item bank. Item and test revisions occurring in the master item bank are be ‘pushed’ to the deployed online assessment systems.

Test Administration. When an online assessment system is put into service, school administrators can perform student enrollment tasks by either entering student data via an online user interface or by batch process.

Next, they can set up teachers, classes, and rosters and establish a testing schedule, again, either by individual entry or batch process. They may, from time to time, update their enrollment and test databases via an online user interface or batch process. Data integrity and privacy rules constrain access. Contract and assessment plan specified pre-testing, field-testing, and pilot testing commence, producing item and test performance metrics. Operational tests are designed, constructed, and installed on the online assessment system. Assessment schedules are constructed.

After student information is installed:

1. The school can administer operational assessments using secured information;

2. Teachers can build testlets, practice tests, and curriculum and standard specific testlets; and

3. Under some contracts, the students can begin taking self-assessments. Post-Test Administration. When tests are complete, students, teachers, and administrators can access results reporting. This access is subject to privacy constraints for non-aggregate data.

2.6.2 Scenario 2. Measured Progress and Customer Shared Administration

Measured Progress owns the authoring, test administration, and scoring functions, but shares administration hosting with its Customers. The Customers control test administration servers and other network components at their sites, as well as control test administration in conjunction with Measured Progress.

2.6.3 Scenario 3. Customer-Managed and Managed Progress Provides Components

The Customer owns and controls the administration component and process. Measured Progress provides item bank development, administration, and the scoring/reporting components. The Customer owns all aspects of test administration.

2.6.4 Scenario 4. Standalone Implementation

The Customer owns and controls the solution. Measured Progress provides a shrink-wrapped product that Customer uses. The Customer controls all aspects of testing process.

### 3. System Capabilities, Conditions, and Constraints

The system shall support Measured Progress workflow. Modular components shall be developed for each phase of development. The system meets the parameters as specified below.

3.1 Physical

3.1.1 Construction

Specify the minimum hardware requirements for:

1. Server side—racked components shall be Commercial Off-The-Shelf (COTS) products;

2. Client side—hardware shall be COTS products; and

3. Network interface.

Note: Besides the above requirements, there are no physical characteristics to define.

3.1.2 Adaptability

The system shall evolve through three phases of development. The system shall scale up in terms of load and outward in terms of distribution.

3.1.3 Environmental Conditions

The system shall be:

1. Hosted by Measured Progress or by Customers in controlled and secured environments.

2. Protected from power fluctuation and failure by Uninterruptible Power Supply (UPS) systems.

3. Hosted in locations with redundant connectivity to public networks.

4. Operated with 24/7 Network Operations Center (NOC) coverage.

3.2 System Performance Characteristics

Application response time during the Test Administration mode is one of the most important characteristics of the system. This is also true for the Pre- and Post-Administration modes of the application but to a much lesser extent.

3.2.1 Performance. Response time for an entire screen to display shall be less than 5 seconds per screen for all screens, and have a mean time of less than 1 second, based on the expected number of 200,000 concurrent users.

3.2.1.1 Control of Client Side Platform. During a test administration, the test station operates the following constraints:

1. Does not permit the execution of any other applications.

2. Maintains continuous network connection to the server.

3. Keeps all assessment material in volatile memory.

4. Keeps all assessment material encoded until it is used.

3.3 System Security

The system shall conform to the following security standards:

| | |
|---|---|
| 1.15.14. Security | 1.15.15. Description |
| Standard | |
| 1.15.16. Test Data | 1.15.17. Item and test data shall be secured |
| Security | on Measured Progress servers through user, |
| on Servers | group, and role-based access permissions. |
| | Authorized users log in and are authenticated. |
| 1.15.18. Test Data | 1.15.19. Item and test data shall be secured |
| Security in | in transit on public networks from the server |
| Transit | to the client side platform by standard data |
| | encryption methods. |
| 1.15.20. Test Data | 1.15.21. Item and test data shall be secured |
| Security on the | on the client side platform to prevent caching |
| Client Side | or copying of information, including item |
| Platform | content, for retransmission or subsequent |
| | retrieval. |
| 1.15.22. Student | 1.15.23. Student data shall be secured on |
| Enrollment Data | Measured Progress servers through user, |
| | group, and rule-based access permissions. |
| | Federal and local privacy regulations dictate |
| | specific scenarios for student data access, |
| | including ‘need to know.’ |
| | Non-aggregated data that allows the unique |
| | discernment of student identity will be |
| | strictly controlled. Audit of accesses shall |
| | be implemented. Any transmission of student |
| | data over public networks shall be secured |
| | by standard data encryption methods. |
| 1.15.24. Class/Roster/ | 1.15.25. Class and roster information, and |
| Test Schedule Data | test schedules shall be protected from view |
| | and access via user, group, and rule-based |
| | access permissions. Data that uniquely |
| | identifies a student shall be highly secured. |
| | Access to all student data shall be audited. |
| 1.15.26. Student | 1.15.27. Student responses shall be protected |
| Response Data | from view and access via user, group, and |
| | rule-based access permissions. Data that |
| | uniquely identifies a student shall be |
| | highly secured. Access to all student data |
| | shall be audited. |

Security concerns shall be addressed through firewall and intrusion detection technologies.

3.3.1 Intrusion Detection System (IDS)

An Intrusion Detection System (IDS) is a device that monitors and collects system and network information. It then analyzes and differentiates the data between normal traffic and hostile traffic.

Intrusion Detection Technologies (IDT) encompass a wide range of products, such as:

1. ID Systems,

2. Intrusion Analysis,

3. Tools that process raw network packets, and

4. Tools that process log files.

Using only one type of Intrusion Detection device may not be enough to identify between normal traffic and hostile traffic, but used together, IDTs can be used to determine if an attack or an intrusion has occurred. Every IDS has a sensor, an analyzer and a user interface, but the way they are used and the way they process the data varies significantly.

IDS can be classified into two categories: host-based and network-based IDS.

1.15.28. 3.3.1.1 Host-Based IDS

Host-based IDS gathers information based on the audit logs and the event logs. It can examine user behavior, process accounting information and log files. Its aim is to identify patterns of local and remote users doing things they should not be.

Weakness of Host-Based IDS. Vendors pushing the host-based model face problems. A significant hurdle, similar to that of any agent-based product, is portability. BlackIce and similar products run only on Win32-based platforms, and though some of the other host-based systems support a broader range of platforms, it may not support the OS that the system will use. Another problem that can arise is when the company decides to migrate to another OS in the future that is not supported.

1.15.29. 3.3.1.2 Network-Based IDS

Network-based IDS products are built on the wiretapping concept. A sensor-like device tries to examine every frame that goes by. These sensors apply predefined rule sets or attack “signatures” to the captured frames to identify hostile traffic.

Strengths of Network-Based IDS. Still, network-based systems enjoy a few advantages. Perhaps their greatest asset is stealth: Network-based systems can be deployed in a non-intrusive manner, with no effect on existing systems or infrastructure. Most network-based systems are OS-independent: Deployed network-based intrusion-detection sensors will listen for all attacks, regardless of the destination OS type or any other cross-platform application.

Weakness of Network-Based IDS. The network-based intrusion-detection approach does not scale well. Network-based IDS has struggled to keep up with heavy traffic. Another problem is that it is based on predefined attack signatures, which will always be a step behind the latest underground exploits. One serious problem is keeping up with new viruses that surface almost daily.

1.15.30. 3.3.1.3 Multi-Network IDS

A multi-network IDS is a device that monitors and collects system and network information from the entire internal network—on all segments (sitting behind a router). It then analyzes the data and is able to differentiate between normal traffic and hostile traffic.

Strengths of Multi-Network IDS. There is no need to put a device (like a sniffer) on each segment to monitor all the packets on the network. A company that has 10 segments would require 10 physical devices to monitor all the packets on all segments. 20 segments would require 20 devices, and so on. This increases the complexity and the cost of monitoring the network. When using a multi-network IDS, only one device is required no matter how many segments a network might have.

1.15.31. 3.3.2 Application Security

The purpose of Web Application Security is to keep the integrity of the web application. It checks to see that the data entered is valid. For example, to log into a specific website, the user is requested to enter the user ID. If the user decides to enter 1000 characters in that field, the buffer may over-flow and the application may crash. The function of the

Web Application Security is to prevent any input that can crash the application.

b 1.15.32. 3.3.3 Risks in the Web Environment

Bugs or misconfiguration problems in the Web server that allow unauthorized remote users to:

1. Steal confidential documents or content;

2. Execute commands on the server and modify the system;

3. Break into the system by gaining information about the Web server's host machine; and

4. Launch denial-of-service attacks, rendering the machine temporarily unusable.

Browser side risks include:

1. Active content that crashes the browser, damages the user's system, breaches the user's privacy;

2. The misuse of personal information knowingly or unknowingly provided by the end user;

3. Interception of network data sent from browser to server or vice versa via network eavesdropping;

4. Eavesdroppers can operate from any point on the pathway between the browser and server, including:

a. The network on the browser's side of the connection;

b. The network on the server's side of the connection (including intranets);

c. The end user's Internet service provider (ISP);

d. The server's ISP; and

e. The end user's or server's ISP regional access provider.

1.15.33. 3.3.4 Types of Security Vulnerabilities

1. Exploits. The term “exploit” refers to a well-known bug/hole that hackers can use to gain entry into the system.

2. Buffer Overflow/Overrun. The buffer overflow attack is one of the most common on the Internet. The buffer overflow bug is caused by a typical mistake of not double-checking input, and allowing large input (like a login name of a thousand characters) “overflow” into some other region of memory, causing a crash or a break-in.

3. Denial-of-Service (DoS) is an attack whose purpose is not to break into a system, but instead to simply “deny” anyone else from using the system. Types of DoS attacks include:

a. Crash. Tries to crash software running on the system, or crash the entire machine

b. Disconnect. Tries to disconnect two systems from communicating with each other, or disconnect the system from the network entirely

c. Slow. Tries to slow down the system or its network connection

d. Hang. Tries to make the system go into an infinite loop. If a system crashes, it often restarts, but if it “hangs”, it will stay like that until an administrator manually stops and restarts it.

DoS attacks can be used as part of other attacks. For example, in order to hijack a TCP connection, the computer that is taken possession of must first be taken offline with DoS. By some estimates, DoS attacks like Smurf and the massive Distributed DoS (DDoS) attacks account for more than half the traffic across Internet backbones.

A DDoS is carried out by numerous computers against the victim. This allows a hacker to control hundreds of computers in order to flood even high-band Internet sites. These computers are all controlled from a single console.

1.15.34. 3.3.5 Back Door

A back door is a hole in the security of a computer system deliberately left in place by designers or maintainers. It is a way to gain access without needing a password or permission. In dealing with this problem of preventing unauthorized access, it is possible, in some circumstances, that a good session will be dropped by mistake. The usage of this feature can be disabled, but is well worth having in order to prevent a back door breach into the system.

1.15.35. 3.3.6 Trojan Horse

A Trojan horse is a section of code hidden inside an application program that performs some secret action. NetBus and Back Orifice are the most common types of Trojans. These programs are remote user, and allow an unauthorized user or hacker to gain access into the network. Once inside, they can exploit everything on the network.

1.15.36. 3.3.7 Probes

Probes are used to scan networks or hosts for information on the network. Then, they use these same hosts to attack other hosts on the network. There are two general types of probes:

1. Address Space Probes. Used to scan the network in order to determine what services are running on the hosts

2. Port Space Probes. Used to scan the host to determine what services are running on it

1.15.37. 3.3.8 Attacks We Must Handle

This Application Security Module is capable of handling the following attacks in the Web environment:

1. Denial Of Service (DOS) attacks

2. Distributed Denial Of Service (DDOS) attacks

3. Buffer overflow/overrun

4. Known bugs exploited

5. Attacks based on misconfiguration and default installation problems

6. Probing traffic for preattacks

7. Unauthorized network traffic

8. Backdoor and Trojans

9. Port scanning (connect and stealth)

The System shall require:

1. High performance of the application security module.

2. Port multiplexing. A server will normally use the same port to send data and is therefore susceptible to attack. Within the system architecture, the input port is mapped to another configurable output port. Having the ability to disguise the port by using a different port each time prevents the server from being tracked.

3. Built-in packet filtering engine. Packets can be forwarded according to priority, IP address, content and other user-assigned parameters

4. A server can have a private IP address. With the load balancing system, a request that comes in from the outside can only see a public IP address. The balancer then redirects that traffic to the appropriate server (which has a different IP address). This protects the server from the outside world knowing what the true IP address that is assigned to that specific server.

1.15.38. 3.3.9 Configuration

The concept of this architecture is to have a predefined list of security policies or options for the user to select from by enabling or disabling the various features. This simplifies the configuration of the device (the device is shipped with Application Security enabled). The device has out-of-the-box definitions of possible attacks that apply to the web environment. The user can simply define their environment in terms of server type for a quick configuration.

1.16 3.4 Application Security Module

1.16.1. 3.4.1 Overview

The Application Security module of the system is broken down into four components.

3.4.1.1 Detection. In charge of classifying the network traffic and matching it to the security polices. Next, the Response Engine executes the actions.

3.4.1.2 Tracking. Not all attacks are activated by a single packet that has specific patterns or signatures. Some attacks are generated by a series of packets, whereby their coexistence causes the attack. For this reason, a history mechanism is used, which is based on five separate components, each identified in a different way:

1. Identification by source IP

2. Identification by destination IP

3. Identification by source and destination IP

4. Identification by Filter type

5. TCP inspection mechanism—which keeps track of each TCP session (source and destination IP and source and destination Port) and used to identify TCP port scanning.

3.4.1.3 Response. The response actions are executed based on rules from policies. Types of actions are:

1. Discard Packets (Drop, Reject);

2. Accept Packets (Forward);

3. Send Reset (drops packet and sends a Reset to the sender);

4. Log Actions

3.4.1.4 Reporting. Generates reports through log messages. The message the module logs is one of the following:

1. Attack started

2. Attack terminated

3. Attack occurred

3.4.2 Cryptography

Applications that transmit sensitive information including passwords over the network must encrypt the data to protect it from being intercepted by network eavesdroppers.

The system shall use SSL (Secure Sockets Layer) with 128 bit encryption for Phase I.

3.4.3 Authentication/Authorization

1. For security reasons, Client/Server and Web based applications must provide server authorization to determine if an authenticated user is allowed to use services provided by the server.

2. Client/Server applications must not rely solely on client-based authorization, since this makes the application server and/or database vulnerable to an attacker who can easily bypass the client-enforced authorization checks. Such security attacks are possible via commercially available SQL tools and by modifying and replacing client software.

3. For three-tiered Client/Server applications, the middleware server must be responsible for performing user authorization checks. The backend database server must also be configured so that it will only accept requests from the middleware server or from privileged system administrators. Otherwise, clients would be able to bypass the authorization and data consistency checks performed by the middleware server.

3.4.4 Vandal Inspection

1. Use SSL/RSA encryption as necessary

2. Use messaging payload encryption as necessary

3. Use persistent storage (database) encryption as necessary

4. Establish login policies and procedures (password expiration, failed login attempts)

5. Enforce user/group permission structure for access to functionality

6. Maintain complete audit history of all data changes

7. Automatic monitoring of auditing changes

1.17 3.5 Information Management

The system application data shall be managed to meet State and/or Federal requirements for student data privacy and certification. This will be accomplished by maintaining a complete audit history of all data changes, which will provide the ability to certify user and system access and ensure data integrity. The integrity of information will be protected via backup and recovery procedures.

Audit history shall be maintained for all critical data so that changes can be monitored and reported. This audit history, along with secure and controlled user access, will provide the ability to certify the privacy of the data by an outside auditor. Audit history will also provide the ability to view item and test content as seen by a student at any point in time.

Backup and recovery procedures will be established that meet the business requirements for downtime and data loss.

Acceptable downtime is defined as less than 5 minutes per year, and acceptable data loss is no more than the last logical transaction. For example, an “unaccepted” item response on a test is not restorable, but all prior test answers for that student are restorable. In the event of a system failure, data from a student's test shall be restored to the point when the failure occurred.

1.18 3.6 System Operations

1.18.1. 3.6.1 System Human Factors

1. Special needs access requirements.

2. Ergonomic minimums for client side platforms.

3. User workstations and ergonomic requirements met on the client-side in accordance with educational-based requirements and standards.

4. Interface to user audience varying from youthful computer novices to computer-savvy educators and administrators.

5. Refer to applicable standards in Federal Education Standard 508.

1.18.2. 3.6.2 System Maintainability

1. The server side will consist of standard units connected in a cluster.

2. The dynamic configuration capability of the system allows units to be removed from the cluster and then added back into the cluster. This allows both periodic maintenance and repairs while the system is active.

3. Many hardware units can be replaced during system operation.

4. A computerized version control shall track every version of each software component.

5. A problem reporting and tracking system shall drive maintenance and ensure all problems are reported.

6. Use standardized coding and naming conventions

7. Use source code change management software

8. Use regression test plans to verify incremental code changes

9. It will often be necessary for applications to gain full knowledge of a modules API in order to make specific calls. The full API of each module should be available to an application. By querying a module, an application should be able to get a location to the full API.

1.18.3. 3.6.3 System Reliability

The system shall be defined as requiring “mission critical” reliability during the operating window (between the hours of 7:00 AM and 4:00 PM) in any test locale, and “good” reliability during the evening/night window (between the hours of 4:00 PM and 7:00 AM), for that test (assessment) locale.

Mission-critical reliability means 99.999% uptime, roughly equivalent to 5 minutes or less of unanticipated downtime per year during the operating window.

Good reliability means 99% uptime, or 72 hours or less of unanticipated downtime per year during the evening/night window.

Anticipated downtime is defined as downtime where users have received at least 24 hours notice (e.g., periods of regularly scheduled maintenance).

1.18.4. 3.6.4 System Portability

1. Use OS/HW/JVM independent (e.g. J2EE) architecture

2. Avoid vendor specific coding (e.g. Weblogic)

3. Use generic data objects to access ODBC compatible database

4. Modules should be internationalized. They need to conform to the local language, locales, currencies etc, according to the settings specified in the configuration file or the environment in which they are running in.

1.19 3.7 Policy and Regulation

3.7.1 Regulatory

The system will be built and operated under state and federal government contracts and, therefore, each deployed system shall comply with government contract bidding, procurement, and operational guidelines.

Student data privacy and access shall adhere to requirements defined by the No Child Left Behind Act of 2001 (NCLB) and the Family Educational Rights and Privacy Act (FERPA). This will require that the application provide strict access to and certify the validity of all student data. This will require a robust application security model and data auditing functionality be implemented in the first phase of the application.

3.7.2 Data Portability Standards User data shall adhere to SIF standards (see http://www.sifinfo.org/ for more information). This will require that all data elements for each phase of development be identified and sourced in the SIF standards, and physical data models be constructed to align with those standards. Item, content and course data shall adhere to SCORM/IMS standards (see http://www.imsproject.org/ and http://www.adlnet.org/ for more information). This will require that all data elements be sourced and physical data models be constructed accordingly.

3.7.3 Auditing and Control

Data certification requirements will require that audit information be collected whenever any application data is modified. The overhead required to generate and save this auditing data shall not interfere with the performance and reliability of the application.

The business rules for tolerable data losses will require that application data must be restorable to a specific point in time. The database backups required to support this requirement shall not interfere with the performance and reliability of the application and must be accounted for in the secondary memory requirements.

1.20 3.8 System Life Cycle Sustainment

The product will be modified many times during its life. The cause for each change shall come from one of three sources:

1. Extensions of the product's functions;

2. Adapting the product to different technologies; or

3. Defects in the system.

Users can report problems. Manual and automatic logging and prioritization of problems will be collected and reviewed.

### 4. System Interfaces

1.21 4.1 Item Bank Management

1. Item content and metadata import interface (batch)

2. Item content and metadata export interface (batch)

3. Item export interface (batch)

4. Item authoring/editing interface (GUI)

5. Item content independent of style presentation

1.22 4.2 Assessment Bank Management

1. Test content and metadata import interface (batch)

2. Test content and metadata export interface (batch)

3. Test export interface (batch)

4. Test authoring/editing interface (GUI)

5. Style sheets varied by contract

6. Instruction lines varied by contract

7. Content, process, other categorization, statistics, program styles, instructions, front and back cover templates

8. Integration with IMS standards for assessment

1.23 4.3 User Management

User Management is an online user management tool that allows registered students to access the system and take tests under highly secure or non-secure administration conditions. The user management system also provides student, teacher, and administrator import and export interfaces for batch updates and modifications. User management includes the following:

1. Integration with LMM database;

2. User management import interface (batch);

3. User management export interface (batch);

4. User management add, delete, and edit interface (GUI); and

5. Enables integration with state student information systems.

1.24 4.4 Test Publishing

Test publishing includes the following features:

1. Online;

2. Print;

3. Secure and nonsecure;

4. Create and edit single, multiple overlap, multiple non-overlap forms;

5. Item ordering;

6. Adaptive testing;

7. Online help shall include a FAQ list, online help system, user feedback, logging that tracks defects and issues, and assigns priority, etc.;

8. Integration with SIF and IMS standards for assessment; and

9. Others to be determined in consultation with Steering Committee, functional divisions, and Program Management.

1.25 4.5 Test Administration

1. Ad-hoc student enrollment/management (GUI)

2. Batch student enrollment/management (batch)

3. Class/roster test scheduling management (GUI)

4. Class/roster test scheduling management (batch)

5. Student interaction interface (GUI)

6. Teacher interaction interface (GUI)

7. Administrator interaction interface (GUI)

8. System admin dashboard (GUI)

9. Test response data interface (batch)

10. Secure delivery

11. Cross platform

12. Online help

13. Scheduling

14. Usage monitoring

15. Supports multiple choice, short answer, extended response, fill in the blank (other IMS item types to be added in subsequent versions)

16. Other features as determined and considered in consultation with DP, MDA, LMM, and Program Management.

1.26 4.6 Scoring

1. Results import from iScore interface (batch)

2. Results export to iScore interface (batch)

3. Score import from iScore interface (batch)

4. Score to reporting function interface (batch)

5. Immediate analysis and reporting of computer-scorable student results

6. Hooks to and from iScore for constructed response scoring

7. Test administration data

8. Other features to be determined in consultation with DP, MDA, and Program Management.

1.27 4.7 Analysis

1. Results export to iAnalyze interface (batch)

2. On-the-fly equating (future version)

3. Scaling with tables

4. On-the-fly scaling with functions (future version)

5. Table lookup of normative data (future version)

6. Hooks to iAnalyze

7. Test administration data

8. Readability analysis

9. Classical item statistics

10. Test analysis

11. DIF, IRT statistics, equating

12. Other features to be determined in consultation with DP, MDA, and Program Management.

1.28 4.8 Reporting

1. Receive raw responses both electronic and scanned (batch)

2. Statistics that feed back into the item bank (batch)

3. Immediate analysis and reporting of computer-scorable student results

4. Application of inclusion rules for reporting disaggregated results (future version)

5. Predefined report formats for student, class, school, and state

6. Online immediate reporting of individual student results

7. Test administration data

8. Other features to be determined in consultation with DP, MDA, and Program Management.

1.29 4.9 Rule-Based Configuration

1. Contract Measured Progress level rules

2. Curriculum framework

3. Style presentation

4. Report analysis rules that go into a deployed system

5. Client rules

6. Permissions configuration

7. Data structure allows reporting categories based on contract

8. Items aligned to multiple contracts

9. Integration with SIF and IMS for content standards

10. Other features as determined and considered in consultation with Curriculum Assessment and Program Management.

1.30 4.10 Workflow

4.10.1 Measured Progress workflow

1. High level—Publications, Editorial

2. Low level—Items

3. Item migration

4. Item authoring tools (purpose setting statement, stimulus, item, scoring guide, training pack, common names for people of different ethnicity and nationality, spell check with specification of specialized dictionaries, item edit, item set creation)

5. Construction tools for item sets and tests

6. Editorial

7. Publication (create and apply styles, edit publication, scannable publications and styles, spell check with specification of specialized dictionaries)

8. Local and distributed entry of items

9. Creation of camera-ready copy

10. Spell check with specification of specialized dictionaries

11. Generate list of permissions required for use of stimulus materials

12. Online help

13. Other features as determined and considered in consultation with functional divisions and Program Management.

1.30.1. 4.10.4 Duplication

Duplication of item content shall be analyzed by an algorithm that:

1. Ignores words without semantic significance

2. Calculates a value that represents the degree of “matching” between content.

3. For words that do not match, the algorithm searches an online thesaurus to discover a semantic relationship between the words. The system shall relate the two items:

“Who is the current governor of Client?”

“Who is the present governor of Client?”

4. Generates an alert for items that are identical or show some degree of matching.

5. Allows expert scrutiny of these items to resolve any issue.

1.30.2. 4.10.5 Identification of Enemies

4.10.5.1 Analysis. A method for analyzing the possibility of semantically related content in closed response items shall be used. The items shall be identified by using the same algorithm that is used for detecting duplicates. However, this analysis also includes the content of the closed responses. This would relate the items:

Who discovered America in 1492?

A. Christopher Columbus B. Michelangelo . . .

When did Christopher Columbus discover America?

A. 1492 B. 1992 . . .

What did Christopher Columbus do in 1492?0

A. Discover America B. Discover pizza . . .

The analysis shall send alerts that enable an expert to resolve any issues.

1.30.3. 4.10.29 Scheduling Tests

1. Interoperability

2. Installation

3. Configuration

4. Interoperability

5. Administering

6. Controlling and operating

7. Testing

8. Types of Tests

9. Generation

10. Types of Interactions

11. Dynamics

12. Scoring

13. Doing It Online

14. Doing It Offline

15. Reporting

16. Results Reporting

17. Standard Reports

18. Data Analysis

19. Enhancements

20. Versioning. There is an explicit version associated with every element. These version numbers are used when selecting items for a test. They are used when selecting a test to be administered. Every time an element changes its version changes.

1.30.4. 4.10.33 Customer Database Interoperability

Products can interoperate with a customer's database. This can be done by use of standard interfaces, such as, SQL, ODBC, JDBC, etc.

1.30.5. 4.10.34 Customer Operations Interoperability

Interoperability with customer operations, e.g. analysis of data, research

1.30.6. 4.10.35 Measured Progress Application Interoperability

1. Interoperability with other Measured Progress applications

2. Scalable solutions

3. Data integrity

4. High availability

5. Framework

6. Rule based

7. Generic rules

8. Contract specified rules

9. Access to change rules

10. Access and control mechanism

11. Proctor Features

### Overview

This document provides a description of the hardware and software requirements for the CLIENT TEST Computer-Based Testing System. The system is divided into two functional areas: a Data Administration System that allows users to maintain all information necessary to provide computer-based testing and an Operational Testing System that allows students to take tests in a proctored environment.

The Data Administration System requires a browser-capable workstation (Data Administration Workstation) that can connect via the network (UEN) to the centrally hosted Data Administration Servers. The Operational Testing System is comprised of three applications or subsystems that work together to provide a well-managed testing environment. The applications are written in the Java development language allowing for a wide variety of hardware and software platforms. A Test Delivery Server (running on a Test Delivery Workstation) manages all aspects of a test session by acting as a data repository and hub for communication between the other subsystems. The Proctor Software (Proctor Test Workstation) provides a user interface for managing a test session by communicating with the Test Delivery Server. The Student Test Software (Student Test Workstation) provides a user interface for displaying test items and recording responses.

The Test Delivery Workstation can host the Test Delivery Server and the Proctor Software. When using a workstation in a dual mode, use the requirements for the Test Delivery Workstation (not the Proctor Test Workstation) to determine workstation specification.

### Technology Specifications

Diagram 1 provides examples of the network connectivity requirements, hardware configurations and testing software needed in schools to support access to the Data Administration System and to use the CLIENT TEST Computer-Based Testing System for operational testing.

This example shows the back-end servers required to support the Data Administration System and two examples for possible school configurations. School A is an example of a smaller school that may have one testing center with the proctor's workstation operating in a dual role supporting the Test Delivery Server and the Proctor Software. School B is an example of a larger school where a dedicated Test Delivery Workstation serves as a local repository for Operational Test System data. Two testing centers are also represented in School B, with slightly different configurations for each.

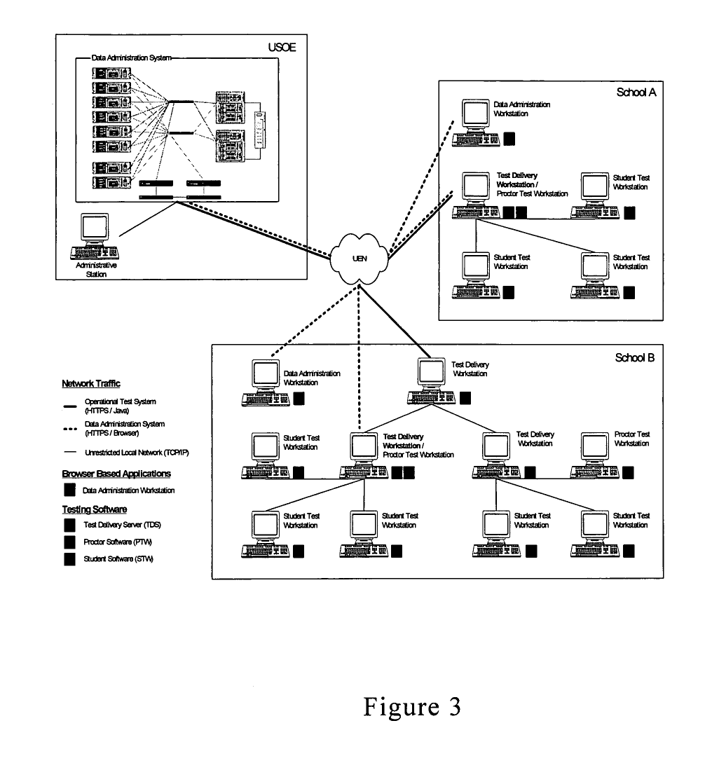

See FIG. 3: Network Connectivity Requirements Hardware Configuration and Testing Software Required

1.31 Server Environment (USOE)

The server configuration needed to support the Data Administration System is based on a Web server farm accessing data on a clustered database. In addition, two servers are allocated as utility servers to perform data transformations and as a staging area for downloadable files.

1.31.1. Hardware Configuration

Diagram 2 shows an example of the hardware estimated to support the CLIENT TEST Computer-Based Testing System. Although specific hardware is specified in the diagram, equivalent hardware from any vendor is acceptable.

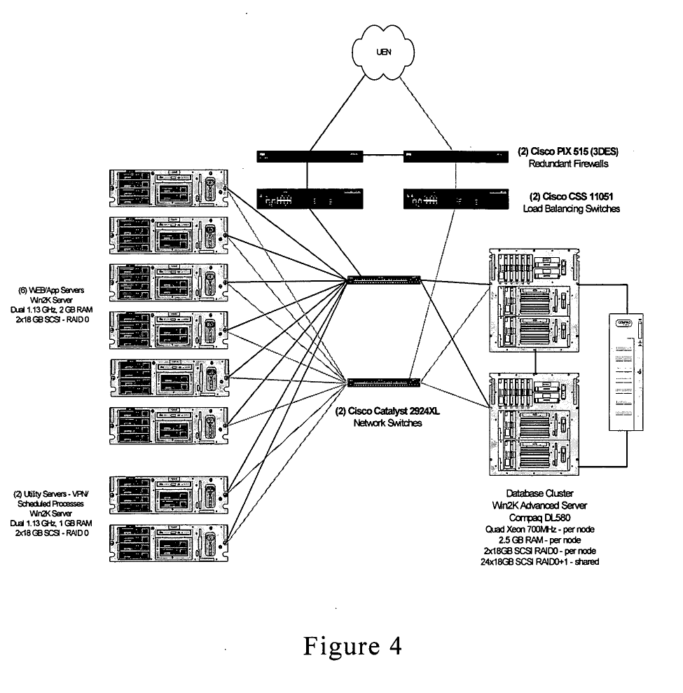

See FIG. 4: Data Administration System, Server Hardware Configuration

1.31.2. Software Configuration

Web Server/Application Cluster

Microsoft Windows 2000 Server (Advanced Server is necessary for software load balancing)

Microsoft NET Framework Runtime

Database Server Cluster

Microsoft Windows 2000 Advanced Server

Microsoft SQL 2000 Enterprise Server

SSL Certificates

VeriSign certificates

128 bit encryption level

1 certificate per server

Hardware SSL accelerators optional (not specified)

1.32 Network Configuration

The network supports communication between the Data Administration System servers and web browsers. It also supports communication between the components of the Operational Testing System and between the Test Delivery Server and Data Administration System.

Table 1 describes the protocols and ports necessary to enable communication between system components.

TABLE 1
Protocols and Ports Required

| | Data Administration | Test Delivery | | Student Test |
|---|---|---|---|---|
| To From | System | System | Proctor System | System |
| Data Administration | https (port 443) | NA | NA | NA |
| (Browser) | | | | |
| Test Delivery System | https (port 443) | secure sockets | secure | secure |
| | | (ports 7800, | sockets (ports | sockets (ports |
| | | 7801, 7802) | 7800, 7801, | 7800, 7801, |
| | | browser | 7802) | 7802) |
| | | required for | | |
| | | software | | |
| | | installation | | |
| Proctor System | NA | secure sockets | NA | NA |
| | | (ports 7800, | | |
| | | 7801, 7802) | | |
| | | browser | | |
| | | required for | | |
| | | software | | |
| | | installation | | |
| Studen Test System | NA | secure sockets | NA | NA |
| | | (ports 7800, | | |
| | | 7801, 7802) | | |
| | | browser | | |
| | | required for | | |
| | | software | | |
| | | installation | | |

1.32.1. Internal Connectivity

Internal networks are those available behind a firewall for an organization. This section describes the connectivity requirements needed within internal networks to support the systems.

Server Environment

Within the server environment, at least a 100 mbps TCP/IP network is recommended. It is understood that the server environment will likely have isolated virtual networks (VLANs) separating the Web servers, database servers, and utility servers. Final release documents will outline the ports necessary for communication between those VLANs.

School Environment

Within the school system, local networks should be at least 10mbps TCP/IP. Schools with a high number of concurrent tests will benefit from any additional bandwidth. Components of the Operational Test System (Test Delivery Server, Proctor Test Software, Student Test Software) will need to communicate using secure sockets connections on ports 7800 through 7802. These port settings are configurable within the testing software, but it is recommended for maintenance consistency reasons not to change these settings.

In addition, all workstations should have a Web browser capable of accessing the Test Delivery Server on the secured ports to install any components of the Operational Test System.

1.32.2. External Connectivity

External connectivity describes instances where systems or browsers are required for access from one network to another. This may require configuring proxies, firewalls and routers to allow specific network requests to flow.

Access to the Data Administration Servers through browsers and from the Test Delivery Server will require https on port 443 to be opened from within the schools and on the USOE network.

Any workstations requiring access to the Data Administration System through browsers will require network access (UEN) via https on port 443. Any workstation running the Test Delivery Server will require network access (UEN) via https on port 443 to communicate with the Data Administration Servers.

1.33 School Environment—Workstation Requirements

| Component | Minimum | Recommended |
|---|---|---|
| PC/Windows | Pentium II; | Pentium III/IV or better; |
| | 200 MHz; 64 MB RAM; | 500 MHz +; 128 MB RAM +; |
| | Windows 95 | Windows 98/2000/XP or better |
| OR | | |
| Macintosh | iMac/PowerMac/G3; | iMac/eMac/PowerMac/G3/G4 or |
| | 120 MHz; 64 MB RAM; | better; |
| | MacOS 8.1 or higher | 350 MHz +; 128 MB RAM +; |
| | | MacOS 9.2/MacOS X or better |
| Web Browser | Netscape 4.78+ OR Internet Explorer 5+; | |
| | Cookies and JavaScript enabled; SSL Enabled | |
| Monitor | 15-inch monitor; | 17-inch monitor; |
| | 8-bit, black & white | 24-bit, color; |
| | 800 × 600 resolution | 800 × 600 resolution |
| Internet/ | High speed network (UEN) connectivity | High speed network (UEN) connectivity |
| Network | 10 Base-T Ethernet | 100 Base-T Ethernet or better |
| Connection | | |
| Keyboard | Standard Keyboard | Extended Keyboard |
| Mouse | Standard Mouse | Enhanced/Wheel Mouse |

1.33.2. Operational Testing System—Workstation Requirements

| | | |
|---|---|---|
| Component | Minimum | Recommended |

Student Test Workstation or Proctor Test Workstation

| PC/Windows | Pentium II; | Pentium III/IV or better; |
|---|---|---|
| | 200 MHz; 64 MB RAM; | 500 MHz+; 128 MB RAM+; |
| | Windows 95 or higher | Windows 98/2000 or better |
| OR | | |
| Macintosh | iMac/PowerMac/G3; | iMac/eMac/PowerMac/G3/G4 or |
| | 200 MHz; 128 MB RAM; | better; |
| | MacOS X (10.2.3 Jaguar) | 350 MHz+; 128 MB RAM+; |
| | | MacOS X (10.2.3 Jaguar) or better |
| Test Delivery | JVM (Java Virtual Machine 1.3.1 supported) | |
| Software | (Supplied by Measured Progress) | |
| Monitor | 15-inch monitor; | 17-inch monitor; |
| | 8-bit, color; | 24-bit, color; |
| | 800 × 600 resolution | 800 × 600 resolution |
| Internet/ | High speed local connectivity to Test | High speed local connectivity to Test |
| Network | Delivery Workstation | Delivery Workstation |
| Connection | 10 Base-T Ethernet | 100 Base-T Ethernet or better |
| Keyboard | Standard Keyboard | Extended Keyboard |
| Mouse | Standard Mouse | Enhanced/Wheel Mouse |

| | |
|---|---|
| Notes: | The requirements for a Proctor Workstation when used also as a Test Delivery |
| | Workstation should follow the specification for the Test Delivery Workstation, |
| | Section 2.3.2.2. |

Test Delivery Workstation (Test Delivery Server)

| PC/Windows | Pentium III; | Pentium III/IV or better; |
|---|---|---|
| | 400 MHz; 128 MB RAM; | 500 MHz+; 256 MB RAM+; |
| | Windows 95 | Windows 98/2000/XP or better |
| OR | | |
| Macintosh | iMac/PowerMac/G3; | iMac/eMac/PowerMac/G3/G4 or |
| | 300 MHz; 128 MB RAM; | better; |
| | MacOS X (10.2.3 Jaguar) | 350 MHz+; 256 MB RAM+; |
| | | MacOS X (10.2.3 Jaguar) or better |
| Test Delivery | JVM (Java Virtual Machine 1.3.1 supported) | |
| Software | (Supplied by Measured Progress) | |
| Monitor | 15-inch monitor; | 17-inch monitor; |
| | 8-bit, color; | 24-bit, color; |
| | 800 × 600 resolution | 800 × 600 resolution |
| Internet/ | High speed local and network (UEN) | High speed local and network (UEN) |
| Network | connectivity | connectivity |
| Connection | 10 Base-T Ethernet | 100 Base-T Ethernet or better |
| Keyboard | Standard Keyboard | Extended Keyboard |
| Mouse | Standard Mouse | Enhanced/Wheel Mouse |

| | |
|---|---|
| Notes: | The requirements for the Test Delivery Workstation should take into account the |
| | intended size of the population it will concurrently serve. The configuration |
| | recommended in this specification is intended to serve a test to 60 students within |
| | a testing center. Additional RAM and processing capability should be considered |
| | as a test lab size increases. |

Infrasturcture Guidelines and Recommendations

1.34 Testing Labs

Testing labs are sufficient to support an entire class of students.
Student Test workstations are connected to network.
Proctor Workstations are connected to network and the Internet.
Test Delivery Workstations are connected to network and the Internet.
Delivery/Proctoring/Test workstations are connected to uninterruptible
power supplies.
Delivery/Proctoring/Test workstations are connected to surge suppression
devices.
Delivery/Proctoring/Test workstations have current software, patches, and
drivers.

1.35 Security & Internet Filtering

IP filter and firewall configurations support and permit HTTP/SSL
transfer.
Client security permits use of JavaScript and Cookies in Web-browser.

1.36 Network/Bandwidth

Schools/Districts have sufficient connection to the Internet.
School connectivity through WAN not overburdened at district level.
Network wiring capable of supporting concurrent use during testing sess-.
ions.
Network hardware (switches, routers, servers) capable of supporting con-
current use during testing sessions.
Network hardware connected to uninterruptible power supplies.
Network hardware connected to surge suppression devices.
School/system network supports full concurrent use during testing sess-
ions.

1.37 Support Personnel

Computer technicians are available for hardware and software trouble-
shooting.
Network technicians are available for hardware and software troubleshoot-
ing.
Technology personnel have reviewed and ensured capcity certification.
A system/school test coordinator has participated in the CLIENT TEST
Computer-Based Testing System training.

Certification

1.38 District/School Readiness

| Description | Date |
|---|---|
| Self Certification/Signup | Nov. 2002 |
| USOE Confirmation (Dry Run) | Mar.-Apr. 2003 |

### 1. Introduction

Measured Progress uses many applications that can be placed into three categories:

Tools used in business operations

Services provided to Customers

Products offered for control and use by Customers

These applications have evolved independently over time. It is a goal of Measured Progress to integrate these tools, services, and products into a unified workflow system. The system is the realization of that goal.

The system will fulfill three major corporate objectives:

1. Provide an internally owned, developed, and maintained full-service online assessment system. This system is essential to the ongoing success of Measured Progress in a fast growing and technology aware educational marketplace.

2. Provide an internal integrated workflow system for managing business operations and facilitating standardized data handling procedures. This system will enable divisions within Measured Progress and their Customers to easily access, transfer, share, and collaborate on development and distribution of assessment-related data and content.

3. Reduce costs associated with services by improving productivity of operational divisions and reducing contract errors. This will allow Measured Progress to become more competitive and grow market share.

1.39 1.1 Purpose

The purpose of this Software Requirements Specification is to:

Describe specific requirements, external interfaces, performance parameters, attributes, and design constraints for the system software.

Foster communications and clear understanding of requirements between Measured Progress and Client State Office of Education.

Establish a basis for engagement between Measured Progress and The system Development Team.

Help reduce time and effort required to develop the software.

Provide a basis for estimating costs and schedules.

Provide a baseline for software validation and verification of the system requirements.

Audiences for this document include Measured Progress executive and departmental leads, the system Development Team, and various states of Department of Education (DOE). All audiences of this document should first be familiar with the System Requirements Specification.

1.40 1.2 Scope

This Software Requirements Specification includes the following:

An introduction to The system;

Phases of software development of the system product suite;

An overview of Phase I requirements (Release 2.0, Online Test Delivery and Administration); and

Specific, detailed, and uniquely identifiable requirements for the system, e.g., user interfaces, inputs and outputs (stimulus and response), functions performed by the system, etc.

The system is a suite of software applications that will provide Measured Progress an internal integrated workflow system to manage business processes and facilitate standardized data handling procedures. The system will also include for its Customers an internally-owned, developed, and maintained full-service online test assessment system, including an item bank and content development, test delivery and administration, scoring, results, and report data delivery, analysis, and management.

Phase I will include an online operational test administration that meets the Client State Office of Education requirements for an operational test delivery system.

With a national focus on standardized assessment, the system will adhere to standards relevant to the educational assessment enterprise. To facilitate application interoperability, Phase I will incorporate SIF and IMS standards, e.g., import and export processes will be provided for student enrollment data. The School Interoperability Framework (SIF) (http://www.sifinfo.org) and IMS Global Learning Consortium (IMS) (http://www.imsproject.org) are standards organizations that drive some of the educational standardization of student, assessment, and content hierarchies.

1.41 1.3 Definitions, Acronyms, and Abbreviations

1.42 1.5 Overview

The remaining parts of this Software Requirements Specification contain the following:

Section 2—Overall Description of The system

Section 3—Specific Requirements

### 2. Overall Description of The system

This section provides an overall description of the system product suite and general factors that affect the product and its requirements. This section does not state specific requirements. Instead, it provides a background for the requirements specified in Section 3 and makes them easier to understand.

The complete product suite consists of several key components, including:

Item Bank Management

Assessment Bank Management

User Management

Test Publication

Test Administration

Scoring

Analysis

Reporting

Rule-Based Design

Workflow Systems

Security

The following table is an overview of the system's functional components.

| # | Component | Description |
|---|---|---|
| 1 | Item Bank | An online item bank management tool that |
| | Management | allows Measured Progress and customers the |
| | | ability to import/export, delete, access, |
| | | author, and edit items and/or item |
| | | components (e.g., graphics). |
| 2 | Assessment Bank | An online assessment bank management tool |
| | Management | that allows Measured Progress and customers |
| | | the ability to import/export, delete, access, |
| | | author, edit, or build tests and assessment |
| | | materials. |
| 3 | User Management | An online user management tool that allows |
| | | registered students to access the system |
| | | and take tests under highly secure or non- |
| | | secure administration conditions. The user |
| | | management system also provides student, |
| | | teacher, and administrator import and export |
| | | interfaces for batch updates and modifications. |
| 4 | Test Publication | An online assessment system that takes an |
| | | item set and applies pre-established styles |
| | | to publish a test for online use or to |
| | | create print ready copy. |
| 5 | Test Administration | An online test administration tool that |
| | | includes test classroom assistance and a |
| | | secure Web browser. |
| 6 | Scoring | Tools that enable a user to manually |
| | | grade open response items. |
| 7 | Analysis | Tools that use algorithms for analysis |
| | | of student results. |
| 8 | Reporting | Tools that use algorithms for reporting |
| | | of student results. |
| 9 | Rule-Based Design | The behavior of the system is described |
| | | in explicitly stated rules. |
| 10 | Workflow Systems | A set of online workflow tools that allows |
| | | choices as to what process steps are |
| | | required and enforces those steps for a |
| | | particular test or testing program (for |
| | | example, an item cannot be selected for |
| | | use in a test unless two content experts |
| | | have signed off on the content and one |
| | | editor has signed off on the usage. |
| 11 | Security | Enables a user to completely control |
| | | access to system resources. |

1.43 2.1 Product Perspective

From a Customer perspective, the system increases efficiency, reduces test delivery time, and enhances the quality of Measured Progress products and services. From an internal perspective, the system provides an integrated system that facilitates efficient intra-departmental integration and collaboration.

The system also eliminates processes that transfer information from many databases, including paper-based methods, and often by entering data again.

Measured Progress conducts business operations such as assessment planning, item and test construction, online and paper-based testing, scoring, and results reporting. Each of these business operations is supported by computer systems and software applications. A major goal of the system is to integrate these systems and applications, enabling the business functional groups to efficiently access, move, process, and archive data as well as effectively communicate with one another.

The system development has been divided into three phases. With each phase, business operations become incrementally more efficient and effective. This methodology enables product integration with least disruption to ongoing operations.

The system product suite is independent and totally self-contained, even though its architecture will interface with a variety of internal and external systems and applications.

Test delivery and administration will be developed with extensive configurability to support a wide variety of customer-specific requirements. To minimize the cost of redeployment, requirements will be modified by simply changing a set of configurable rules.

The following diagram is an overview of the fully functional the system product suite at the completion of Phase III development (targeted for winter 2004). Components developed by phase are indicated.

See FIG. 1. Completed Suite of The system Products at End of Phase III Development

1.43.1. 2.1.5 Communications Interfaces

In order for The system to operate, data will need to flow from server to client, client to server, and from client to client and server in some cases. Listed below are the protocols expected to accommodate these flows of data.

Standard TCP/IP Internet protocol—All client computers will be required to have a standard TCP/IP connection to the Internet. The connection is required while using the system or, in the case of a disconnected system, at the time the application's information is downloaded. The system's current architecture allows for users connecting to the Internet through any means (Dialup, ISDN, DSL, LAN, WAN, etc.). These means of connecting may have architectural impact on other aspects of the system. For example, a client computer accessing the Internet through a LAN via a router with NATing may have an obfuscated IP address. Any processes requiring it, such as any messaging systems developed, would then use this potentially incorrect IP address.

HTTP & SHTTP—Data and presentation elements will be distributed and available via HTTP. Secure data will be accessed via SHTTP. This protocol includes the methods (“post” and “get”) for retrieving information from the client, as well as cookie technology to preserve information on the client's computer.

FTP—When necessary, FTP will be used to facilitate the efficient exchange of files between client computers and the server (e.g. software updates).

Messaging System Interface—A protocol will be used to enable peer to peer messaging for various applications (e.g. student to proctor, teacher to student). This protocol has yet to be determined and proven in implementation. The final architecture of the messaging system may create new or impose constraints on existing communications interface requirements.

1.43.2. 2.1.6 Memory Constraints

Primary and secondary client memory shall be defined as minimum baselines for supported platforms (e.g. Windows and Macintosh). Both minimums will be sized according to client software architecture and to meet application performance requirements. Client workstations must adhere to minimum requirements in order to be supported by the application.

Primary server memory (e.g. RAM) shall be sized appropriately during unit, system and load testing to meet application performance and scalability requirements. This shall apply to all physical tiers of the centralized server cluster: presentation/web, application/business and database. Primary server memory is constrained only by the maximum allowable amount in a specific hardware configuration. This constraint shall be resolved by scalability architected into that physical tier (e.g. adding more web or application servers to support increased load).

Secondary server memory (e.g. disk space) shall also be sized during testing to meet current and future storage requirements. This includes but is not limited to database storage, database backups, application/error log files and archived/historical data. Secondary server memory shall not be a constraint to any application functionality.

1.43.3. 2.1.7 Operations

2.1.7.1 Modes of Operation

When the system is not required to be continuously available for testing, other functions and housekeeping tasks will require that the system be taken offline for short periods of time. Application features and functions will not be available during these maintenance windows. Examples of these maintenance tasks would include data import or export, database backups and software upgrades.

2.1.7.2 Backup and Recovery Operations

The frequency of full and transaction log backups will be balanced against the cost of performing these backups.

Data loss requirements (save the last screen or response) will be met using other techniques such as transactional messaging.

1.43.4. 2.1.8 Site Adaptation Requirements

Phase I of the application shall be administered from centralized servers that do not require any special setup or configuration, other than what is required for the initial installation. This applies to the entire life cycle of operational testing for Client in 2003. As application load increases during the school year, servers may be reconfigured with additional resources to handle the increased usage. This may include additional primary memory, additional or faster CPUs, additional secondary memory, or by adding another server to a given tier (e.g. web or application server).

1. Phase III of the application is slated to deliver remotely administered servers in a disconnected deployment scenario. This scenario implies multiple remote servers, which may or may not have continuous network connectivity, that communicate with a centralized server. Remote servers would have to be configured to reliably perform regular data transfers, and the centralized server would have to be setup to validate and process transfer requests from the remote servers.

1.44 2.2 Product Functions

Functions
1. Item Bank
Item content independent of style presentation
Other features to be determined and considered in
consultation with Curriculum Assessment and Publications
2. Assessment Bank
Style-sheets varied by contract
Instruction lines varied by contract
Content, process, other categorization, statistics,
program styles, instructions, front and back cover
templates
Integration with IMS standards for assessment
Other features to be determined and considered in
consultation with Curriculum Assessment and Publications
3. User Management
Integrates with LMM database
Allows for integration with state student information systems
Browser-based
Run in one of three modes: local hard drive, intranet, and Internet
Users granted or denied access based on function being performed,
testing program, or specific function within a test
Password requirements
Generation of initial user passwords
Online help
Integration with SIF standards for Student and Teacher identification
Other features as determined and considered in consultation with DP,
MDA, LMM, and Program Management
4. Test Publishing
Online
Print
Secure and nonsecure
Create and edit single, multiple overlap, multiple non-overlap forms
Item ordering
Adaptive testing
Online help
Integration with SIF and IMS standards for assessment
Others to be determined in consultation with Steering Committee,
functional divisions, and Program Management
5. Test Administration
Secure delivery
Cross platform
Online help
Scheduling
Usage monitoring
Supports multiple choice, short answer, extended response, fill in
the blank (other IMS item types to be added in subsequent versions)
Other features as determined and considered in consultation with DP,
MDA, LMM, and Program Management
6. Scoring
Immediate analysis and reporting of computer-scorable student results
Hooks to and from iScore for constructed response scoring
Test administration data
Other features to be determined in consultation with DP, MDA, and
Program Management
7. Analysis
On-the-fly equating (future version)
Scaling with tables
On-the-fly scaling with functions (future version)
Table lookup of normative data (future version)
Hooks to iAnalyze
Test administration data
Readability analysis
Classical item statistics
Test analysis
DIF, IRT statistics, equating
Other features to be determined in consultation with DP, MDA, and
Program Management
8. Reporting
Immediate analysis and reporting of computer-scorable student results
Application of inclusion rules for reporting disaggregated results
(future version)
Predefined report formats for student, class, school, and state
Online immediate reporting of individual student results
Test administration data
Other features to be determined in consultation with DP, MDA, and
Program Management
9. Rules-Based Configuration
Contract Measured Progress level rules
Curriculum framework
Style presentation
Report analysis rules that go into a deployed system
Client rules
Permissions configuration
Data structure allows reporting categories based on contract
Items aligned to multiple contracts
Integration with SIF and IMS for content standards
Other features as determined and considered in consultation with
Curriculum Assessment and Program Management
10. Work-in-Process and Workflow.
Measured Progress workflow
High level - Pubs, Editorial
Low level - Items
Item migration
Item authoring tools (purpose setting statement, stimulus, item,
scoring guide, training pack, common names for people of different
ethnicity and nationality, spell check with specification
of specialized dictionaries, item edit, item set creation)
Construction tools for item sets and tests
Editorial
Publication (create and apply styles, edit publication, scannable
publications and styles, spell check with specification of specialized
dictionaries)
Local and distributed entry of items
Creation of camera-ready copy
Spell check with specification of specialized dictionaries
Generate list of permissions required for use of stimulus materials
Online help
Other features as determined and considered in consultation with
functional divisions and Program Management
11. Security
Monitor system status
Report content and system fault
Certify item and test data integrity
Certify student data
Certify system data access

The system is intended to integrate assessment planning, item construction, test construction, online administration, paper-based administration, scoring, and reporting data. It will enhance communication and workflow, greatly improve efficiency and collaboration, reduce costs, and streamline development.

1.44.1. 2.2.1 Pre-Test Administration

Once a contract has been established between Measured Progress and a client, an assessment plan is created based on requirements outlined in the RFP and contract. The assessment plan contains information for pre-test activities: the curriculum framework; test scheduling; item and test development; pilot and field-testing; and operational test development and administration.

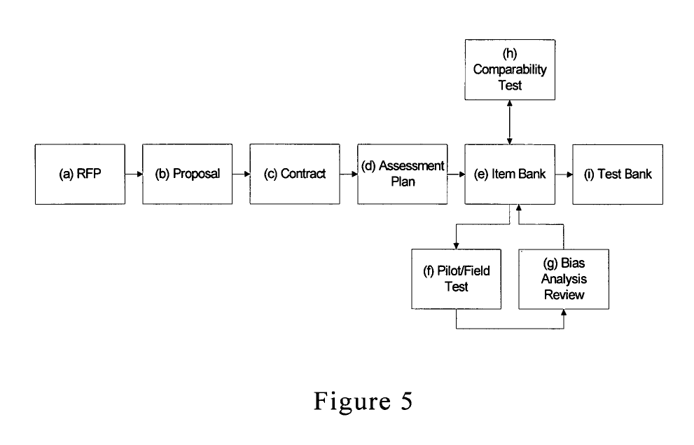

See FIG. 5—Pre-Test Administration

Pre Test Administration Description

| | | |
|---|---|---|
| (a) | RFP | Issued by a client state, describes testing |
| | | deliverables to be provided by the contractor - |
| | | including scope (content areas and grades) and |
| | | schedule of test administrations (pilot, field |
| | | and operational). |
| (b) | Proposal | Written by contractor in response to client |
| | | state RFP, describes how deliverables of RFP |
| | | will be achieved, cost estimates and personnel |
| | | qualifications. |
| (c) | Contract | Awarded by client state to the contractor, |
| | | formalizes deliverables as specified in the |
| | | client state RFP and contractor proposal. |
| (d) | Assessment | Detailed description of testing schedules and |
| | Plan | administration, item breakdown (by content, |
| | | grade, standard) - drives the breakdown of |
| | | content in the item bank |
| (e) | Item Bank | Repository of item content authored for |
| | | exposure at various levels of testing as |
| | | required by the contract (e.g. self assessments, |
| | | teacher sponsored and operational tests) |
| (f) | Pilot/Field | Exposure of item content on limited tests |
| | Test | yielding item statistics for further evaluation |
| | | of those items (e.g. are items biased or too |
| | | difficult?) |
| (g) | Bias Review | Analysis and review of pilot/field tested |
| | | items to determine if any items fail to perform |
| | | as expected for specific demographic groups |
| (h) | Comparability | Exposure of item content on limited tests |
| | Test | yielding item statistics to analyze how web |
| | | exposure of item content compares with the |
| | | corresponding print exposure |
| (i) | Test Bank | Repository of operational tests of approved |
| | | items (e.g. items that have passed the |
| | | comparability and bias review) |

The Item Bank will eventually replace the iREF item bank system and will enhance or replace the Publications test and item content acquisition process.

The system will provide an online operational test delivery system. For Phase I, content developers will work from print versions of operational tests to create online deliverable versions.

Phases II and III of The system will provide content developers the tools to build all content within the item and test banking system, and to deliver that content in both printed and online versions.

1.44.2. 2.2.2 Test Administration

The first set of deliverables for the system is an Online Test Delivery and Administration system. This system will provide three functional test delivery levels:

Self-Assessment

Teacher-Sponsored Testing

Secure Operational Testing

Phase I of The system will only include secure operational testing. Phase II will include self-assessment and teacher-sponsored testing.

2.2.2.1 Self-Assessment—The Online Test Delivery and Administration system will enable students to access and take sample curriculum-based tests online. This serves the dual purpose of training students to take online tests, and providing a self-assessment tool. The diagram below illustrates the self-testing component of the Online Test Delivery and Administration system. In this illustration, a student takes a test that has been generated from the item bank. The system analyzes the students test results and provides a score/analysis, which can be accessed by the student in the form of a student report.

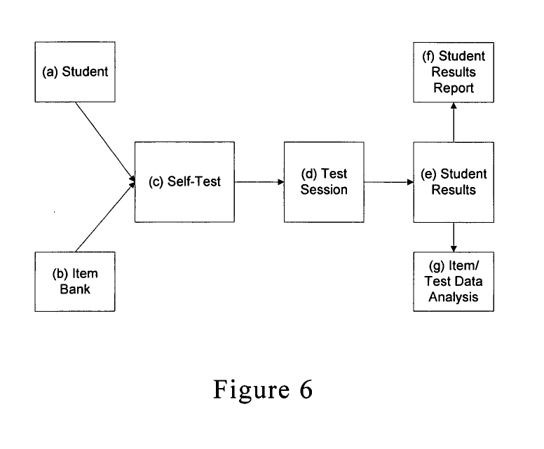

See FIG. 6—Self-Assessment Test Administration

Self Assessment Test Administration Description

| | | |
|---|---|---|
| (a) | Student | Users who are members of the ‘student’ |
| | | group may take self-tests (or ‘practice’ |
| | | tests). The student initiates the self-test |
| | | process. |
| (b) | Item Bank | The system item bank contains a pool of |
| | | curriculum-qualified, approved test items |
| | | that are public (or, non-secure). The |
| | | client (dept. of ed.) may pre-build tests at |
| | | varying levels of difficulty and time (e.g. |
| | | 30 min expected completion) for the various |
| | | curriculum categories, or the system will |
| | | generate a random test based on the |
| | | difficulty and time limit and curriculum |
| | | to be tested. The test, pre- or custom- |
| | | built, is assigned to the student's self- |
| | | test session. |
| (c) | Self-Test | A test comprised of non-secure public items |
| | | that is self-administered by the student. |
| | | The test may be dynamically generated from |
| | | the Item Bank or selected from preloaded |
| | | tests, depending on contract requirements. |
| | | The test may simply be a ‘practice’ |
| | | test for upcoming operational tests, or it |
| | | may be intended to provide enrichment for |
| | | the student and give the student a measure |
| | | of how they are doing in the curriculum |
| | | criterion. |
| (d) | Test Session | The self-test session is the quasi- |
| | | controlled delivery of a self test to |
| | | the student. |
| (e) | Student Results | The student responses as raw data. |
| (f) | Student Results | The deliverable report of the student's |
| | Report | interaction with the self-test. The report |
| | | shows the raw scores, the percent correct, |
| | | and performance/grading result according |
| | | to preselected grade ranges (e.g. ⅔ |
| | | correct or 67% is designated to be a |
| | | ‘C’, or passing). |
| (g) | Item/Test Data | The system feeds results of student self- |
| | Analysis | assessments back to Measured Progress as |
| | | raw data for use by MDA. |

Self-assessment functionality does not currently exist in the paper-and-pencil test administration. It will be exclusive to the system software. Student users will interface with the system to take self-administered tests and review test results from previous self-assessments.

2.2.2.2 Teacher-Sponsored Testing—The Online Test Delivery and Administration system will enable teachers to develop curriculum-based practice tests and assign them to students. The system will record and score test data. The diagram below illustrates the Teacher-sponsored testing component.

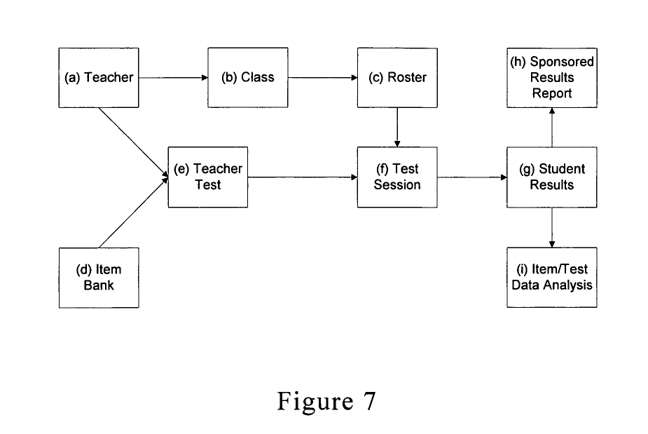

See FIG. 7—Teacher-Sponsored Test Administration

Teacher-Sponsored Test Administration Description

| | | |
|---|---|---|
| (a) | Teacher | User who is a member of the ‘teacher’ |
| | | group in the system. This group, like its |
| | | real-world counterpart, may build and assign |
| | | tests and spot quizzes. The teacher will use |
| | | the system to build practice tests to prepare |
| | | students for upcoming operational tests and |
| | | to measure student performance within the |
| | | classroom. The teacher initiates the sponsored- |
| | | assessment process, building/creating tests |
| | | according to curriculum, difficulty and time |
| | | criteria, and conducts/proctors the test |
| | | session itself, as well as receiving reports |
| | | of the student results. The teacher also grades |
| | | manually-graded items on sponsored tests. |
| (b) | Class | as in schools, the grouping of students |
| | | together around a teacher/room/subject. The |
| | | teacher may access and manage classes to |
| | | which he/she is assigned. |
| (c) | Roster | Group of students for a test session. Roster |
| | | is built from classes assigned to the teacher. |
| (d) | Item Bank | The system item bank contains a pool of |
| | | curriculum-qualified, approved test items |
| | | that are public (or, non-secure). The |
| | | teacher may pre-build tests at varying |
| | | levels of difficulty and time (e.g. 30 min |
| | | expected completion) for the various |
| | | curriculum categories, or the system will |
| | | generate a random test based on the difficulty |
| | | and time limit and curriculum to be tested. |
| | | The test, pre- or custom-built, is assigned |
| | | to the sponsored-test session. |
| (e) | Teacher Test | A test comprised of non-secure public items |
| | | that is administered by the teacher. The |
| | | test may simply be a ‘practice’ test for |
| | | upcoming operational tests, or it may be |
| | | intended to provide performance measurement |
| | | for the student against the curriculum |
| | | criterion. |
| (f) | Test Session | The scheduled session where a sponsored test |
| | | is administered. The teacher may proctor a |
| | | formal session, or the students may take |
| | | their test individually within a time window. |
| (g) | Student | The student responses as raw data. |
| | Results | |
| (h) | Sponsored | The deliverable report of the student's |
| | Results Report | interaction with the sponsored-test. The |
| | | report shows raw scores, percent correct, |
| | | and performance/grading results according |
| | | to preselected grade ranges (e.g., ⅔ |
| | | correct or 67% is designated to be a ‘C’, or |
| | | passing grade), as an aggregate presentation |
| | | for the entire roster and also as individual |
| | | student reports. |
| (i) | Item/Test Data | The system provides results of sponsored- |
| | Analysis | assessments to Measured Progress as raw |
| | | data for use by MDA. |

Teachers and authenticated users with appropriate permissions will interface with The system to define rosters of students, build and assign curriculum-based tests, manually grade test items, and view reports.

2.2.2.3 Secure Operational Testing—Test Delivery and Administration Managers will provide a secure, reliable platform for curriculum-based operational testing, as illustrated below.

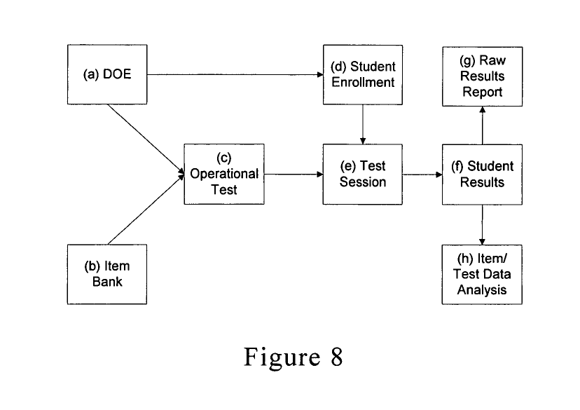

See FIG. 8—Secure Operational Test Administration

| | Secure Operational Test Administration Description | |
|---|---|---|
| (a) | Department of | Governing body and sponsor for assessments |
| | Education (DOE) | within a state. The DOE initiates and |
| | | ultimately controls the operational |
| | | testing process. |
| (b) | Item Bank | The system item bank contains a pool of |
| | | curriculum-qualified, approved test items |
| | | that are secure. Measured Progress pre- |
| | | builds tests for the various curriculum |
| | | framework categories, based on a variety |
| | | of factors including difficulty, item |
| | | performance, etc. The tests are assigned |
| | | to the operational-test session. |
| (c) | Operational Test | Prebuilt secure test. |
| (d) | Student Enrollment | Students from various schools and classes |
| | | selected to participate in online testing. |
| (e) | Test Session | Formal, proctored, controlled-environment |
| | | end-of-year or end-of-course test session |
| | | that is typically statewide and conducted |
| | | within rigid time windows, with high |
| | | security. |
| (f) | Student Results | Raw test response data. |
| (g) | Raw Results Report | Student, School, and District reports of |
| | | scored results. |
| (h) | Item/Test Data | Metrics generating process for test items. |
| | Analysis | |

Operational test development, delivery, administration, and scoring are the core business of Measured Progress. The system provides a more efficient method for operational test delivery, and online administration of operational tests is a primary business need addressed by Phase I of The system. Initially, The system online test administration will augment existing paper-and-pencil test administration methods. Operational test development is typically a collaborative effort between Measured Progress and its clients. Online operational tests are typically scheduled concurrently with paper-and-pencil test administrations.

Students will log into the system to take online operational tests within a secure environment and in the presence of at least one test proctor. For Client, raw score results will be available immediately to authenticated users—primarily teachers and users with teacher permissions.

1.44.3. 2.2.3 Post-Test Administration

Handling results, scoring and reporting data are an important component of the Measured Progress business model. As illustrated below, secure student test results are imported into iScore where they are merged with paper and pencil based scanned results.

For Phase I of The system, raw score data will feed into the iScore system. Subsequent phases will address the further integration of scoring into the system.

The secure student test scores/analyses are imported into iAnalyze, which provides analysis/metrics based on contract criterion. In future phases of the system, additional analysis capability may be integrated. The iAnalyze system generates a report or multiple reports for the client. The item bank is updated with the appropriate item statistics.

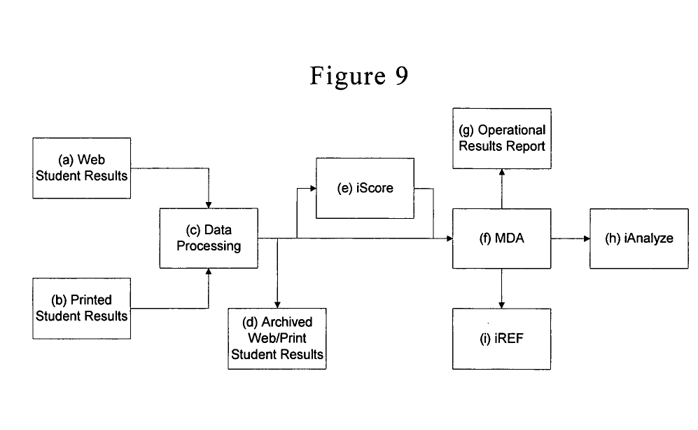

See FIG. 9—Data Flow in Post-Administration Process

Data Flow in Post-Administration Process Description

| | | |
|---|---|---|
| (a) | Web Student | Raw results from students taking the web version |
| | Results | of an operational test. |
| (b) | Printed Student | Raw results from students taking the print |
| | Results | version of an operational test. |
| (c) | Data Processing | Internal Measured Progress department which |
| | | functions as the primary collection point for |
| | | raw web and printed student results, passing |
| | | the combined results through scoring and into |
| | | MDA for analysis and results reporting. |
| (d) | Archived | Repository of raw and printed student results |
| | Web/Printed | that functions as a backup for historical |
| | Results | reporting. |
| (e) | iScore | Internal Measured Progress application which |
| | | scores constructed response and short answer |
| | | test items and provides results to MDA for |
| | | analysis and reporting. |
| (f) | MDA | Internal Measured Progress department that |
| | | scores multiple choice items and merges results |
| | | with CR/SA scored items from iScore, to |
| | | produce statistical results reports and item |
| | | statistics that feed back into the item bank |
| | | (currently iREF), and output for suitable for |
| | | input to the iAnalyze application. |
| (g) | Operational | Statistical results reports (IRT, DIF, p- |
| | Results Reports | values) as well as equated and scaled score |
| | | reports. |
| (h) | iAnalyze | Internal Measured Progress application that |
| | | processes formatted test results from MDA, |
| | | and produces detailed analytical reports in a |
| | | number of formats - typically used for state |
| | | level reporting. |
| (i) | iREF | Measured Progress' current item bank |
| | | containing all item content, associated |
| | | test usages, and item statistics. |

1.45 2.3 User Characteristics

| User Types | Description |
|---|---|
| Auditor | The auditor analyzes and performs compliance |
| | and acceptance reporting on the security, avail- |
| | ability, and performance of the online assess- |
| | ment system. |
| Curriculum and | C & A produces the assesment plan, and conducts |
| Assessment (C & A) | the item and test authoring processes. |
| Department of | DOE is the usual signatory to a Measured Pro- |
| Education (DOE) | gress contract, and provides assessment plan |
| | requirements, provides for adequate facilities |
| | for testing, and receives reports regarding the |
| | test results and the testing process. |
| Measurement, | MDA uses raw score data to perform sophisti- |
| Design, and Analysis | cated analysis of tests appropriateness to |
| (MDA) | curriculum, difficulty, and item performance. |
| Proctor | An individual who adminsters tests. As part of |
| | managing the room during an administration, the |
| | proctor may identify students, assist with the test |
| | process, and monitor students for inappropriate |
| | activity. |
| Program Manager | The Program Manager (PM) manages the Cus- |
| | tomer relationship and is the escalation point of |
| | contact for issues and problems relating to the |
| | contract. The Program Manager also manages the |
| | deliverable and schedule, and marshals the re- |
| | sources necessary for Measured Progress respons- |
| | ibilities under the contract. |
| Publications | Publications performs the pre-press process for |
| | printed tests, including booklet layout. Publica- |
| | tions also performs item and test quality ass- |
| | urance. |
| School | A school administrator manages teachers and pro- |
| Administrator | vides direction and oversight for the testing |
| | process within a school or school system. |
| Scoring | Scoring receives test materials back from students |
| | and schools, and processes them to extract raw |
| | score data. |
| Student | A uniquely identified individual in grades K |
| | through 12 who uses The system to take online |
| | tests. |
| Teacher | A uniquely identified individual who manages |
| | students, classes, and rosters. |
| Technical | A technical adminstrator provides technical supp- |
| Administrator | ort for exceptions such as hardware failures, net- |
| | work outages, etc., to the testing process at |
| | the local facility. The technical administrator |
| | reponsibilities may be local to the school or |
| | district, or may not exist at all on the Customer |
| | side. If there is no technical administration pro- |
| | vided by the Customer, these responsibilities shift |
| | to Measured Progress support staff. |
| Trainer | A trainer will educate teachers, administrators, |
| | and proctors on how the system functions. |

1.46 2.4 Constraints

1.46.1. 2.4.1 Performance

The largest constraint upon the performance of the system as an online test administration system will be extremely “spiky” high usage loads. Curriculum-based assessments are typically administered on a statewide basis, with the same (or similar) test presented to thousands of students on the same day and hour, within virtually the same span of minutes. This results in surges in application traffic as user sessions request authentication (log-in) or submit test results at approximately the same time. It is critical that system performance does not degrade as a result of this “spiky” load characteristic. The system architecture and design will address this constraint. A deployed configuration will be defined that certifies adequate system response under a particular session load.

1.46.2. 2.4.2 Design Constraints

2.4.2.1 Assistive technology requirements defined by State and/or Federal government.

2.4.2.2 Student privacy requirements defined by State and/or Federal government.

2.4.2.3 SIF, IMS, and other standards for data interfaces.

2.4.2.4 Severability of client specific custom code.

2.4.2.5 Avoidance of platform and vendor specific technologies and programming extensions.

2.4.2.6 Uptime requirements requires: extensive database backup and recovery procedures, data and transaction redundancy throughout system.

2.4.2.7 Client and server lock-down implies third-party software, administrative and training requirements.

2.4.2.8 Auditing requirements implies significant data and processing overhead, i.e., every data change implies another piece of data that describes the change.

2.4.2.9 Multiple deployments implies flexible object oriented design.

1.47 2.5 Assumptions and Dependencies

The system online test administration will be dependent on the quality of client workstations and Internet connectivity. Assumptions related to this and other considerations are as follows:

Internet connectivity required for all deployment model

Sufficient resources on client and server (CPU, RAM, disk space) to run application within performance requirements

Sufficient bandwidth between client and server for specific deployment model to support performance requirements

All assistive technology requirements on the client side will be met by resources and functionality external to the product suite. NOTE: This is an assumption for Phases I and II and a requirement for Phase III.

1.48 2.6 Apportioning of Requirements

The system will be implemented in phases. While requirements will be developed and codified for all phases of the project on an ongoing basis, the initial product development (Phase I) will only target the minimum functional requirements to satisfy the Client operational online assessment administration. The first three phases are targeted as follows.

1.48.1. 2.6.1 Phase I—March 2003

Phase I will deliver an online assessment administration system to meet the specific requirements of the Client contract and will include the following features:

Item Bank Management

Item bank for test publication

Content independent of style presentation

Import, export, and delete items—system-level interfaces for batch processing

Assessment Bank Management

Assessment bank for test administration

Import, export, and delete tests—system-level interfaces for batch processing

User Management

Import, export, and delete users—system interface for batch processing

Security management—group-based permissions

Staff management—manage appropriate core staff groups

Student enrollment management—enrollment for online testing

District management—add, view, modify, and delete district

School management—add, view, modify, and delete school

Class management—add, view, modify, and delete class

Roster management—add, view, modify, and delete roster

Student management—add, view, modify, and delete student

View school, class, roster, and student data—access and view data according to permissions

Test Publication

Test construction—multilingual content

Test Administration

Test definition—multiple choice items, centralized administration, secure delivery, system monitoring, cross platform delivery

Test session management—create and modify operational test sessions, designate test parameters such as date, time, location, and assign proctor

Proctor test session—start-and-stop operational test, restart interrupted operational test, monitor test administration

Take operational test

Scoring

Response data bank—test results export interface

Analysis

Import and export item statistics for analysis

Reporting

View test scores and results

Immediate results reporting

View disaggregated detail reports

Rule-Based Design

Contract rules—reporting categories based on state curriculum frameworks, presentation rules for items and assessments

Personalize view—administrator-designated views

System permissions—role-based permissions

Workflow Systems

Data processing—test results export interface

Professional development—training (includes help tutorials), view help

Security

Monitor system status in real time

Audit trails—certify item and test data integrity, student data, and system data access

View item test audit reports (system monitoring tool)

1.48.2. 2.6.2 Phase II—December 2003

Phase II will continue development of the online test delivery system, add item development, and include the following features:

Item Bank Management

Item bank—SCORM/IMS standards

Import, export, and delete items—user interfaces for batch processing

Author items and clusters—item and cluster authoring tool, create item clusters from item bank

Edit items and clusters—item and cluster editing tool

Assessment Bank Management

Import, export, and delete tests—user interfaces for batch processing

Author tests—test authoring tool

Edit tests—test editing tool

View tests in test bank

Build test—create test from item bank

User Management

User data bank—SIF-compliant enrollment

Import, export, and delete users—integration with state system

Staff management—manage customized staff groups

Class management—class and teacher scheduler

Test Publication

Test construction—algorithmic test construction

Test Administration

Test definition—short answer and constructed response items, printed tests, industry standard multi-media formats

Test session management—assign non-operational tests created from item bank, and print online test

Take teacher-assigned test

Scoring

Response data bank—iScore integration

Score test results—score operational short answer and constructed response items with integration of iScore (SCOR), and score short answer and constructed items in teacher assigned tests

Reporting

View test scores and results—ad hoc reporting

View aggregate and rollup reports

Rule-Based Design

Data rules—items align to multiple contracts

Personalize view—student-designated views

System permissions for individual by feature and function

Workflow Systems

Scoring workflow management—integration with iScore

MDA—integration with iAnalyze

Security

Report content and system fault

1.48.3. 2.6.3 Phase III—December 2004

Phase III will continue development of the online assessment administration system and workflow tools, provide distributed and disconnected test administration, and add the following features:

Item Bank Management

Item bank—generic item categorization (duplicate checking, item warehousing and mining)

View items and clusters—item and cluster review

Assessment Bank Management

Author tests—create test forms from item bank, and item selection for operational tests

View tests—online test review

User Management

User data bank—LMM integration

Student enrollment management—provide interoperability with DOE Student Information Systems

Test Publication

Create camera-ready and online layout for paper-and-pencil and online forms

Test Administration

Test definition—distributed administration, expanded item types

Take self assessment

Analysis

Analyze test results—analyze student and test results by selected criterion, for example, gender

Workflow Systems

Contract management—executive management view and manage contract information such as delivery dates, contract design tool

Add assessment plan—assessment plan design tool

Assessment plan management—manage assessment plan

Item workflow management—manage item and test construction workflow, and item review

Manage and support publications workflow—provide tools to assist in managing item, graphic, and test publication

Manage and support LMM workflow—provide tools to assist LMM in tracking LMM-related information (shipping, contact info, materials tracking)

Scoring workflow management—manage item and test scoring

Security

Adaptive testing

1.48.4. 2.6.4 Future Development—2005?

Future development will include enhanced test and scoring functions, such as the following features:

Publications

Test construction—adaptive testing

Workflow

Contract management—multilingual user interface

Analysis

Analyze test results—on-the-fly equating and scaling; scaling with tables, normative data lookup; readability analysis; classical item statistics; test analysis; DIF, IRT, statistics; and equating

| # | | Phase I | Phase II | Phase III | Future |
|---|---|---|---|---|---|
| 1 | Item and | Item bank for test | SCORM/IMS standards | Generic item | |
| | Assessment | delivery | Item and test authoring | categorization (dup | |
| | Banks | Content independent of | | checking, item | |
| | | style presentation | | warehousing and | |
| | | Batch import only | | mining) | |
| 2 | User | Enrollment for online | SIF compliant | LMM integration | |
| | Management | testing | enrollment | | |
| | | Batch import | State system integration | | |
| | | Group based | | | |
| | | permissions | | | |
| 3 | Test Delivery | Multilingual content | | | Adaptive Testing |
| 4 | Test | Practice Tests | Level 2 teacher | Level 1 self-assessment | |
| | Administration | Level 3 operational | assigned | Distributed | |
| | | Online tests | SA and CR items | administration | |
| | | MC items | Printed tests | Expanded item types | |
| | | Proctored tests | | | |
| | | Centralized | | | |
| | | administration | | | |
| | | Secure delivery | | | |
| | | System monitoring | | | |
| | | Cross platform delivery | | | |
| 5 | Analysis and | Test results export | iScore integration | iAnalyze integration | On-the-fly equating |
| | Reporting | interface | | | On-the-fly scaling |
| | | Immediate results | | | Scaling with tables? |
| | | reporting | | | Normative data lookup |
| | | | | | Readability analysis |
| | | | | | Classical item statistics |
| | | | | | Test analysis |
| | | | | | DIF, IRT Statistics, |
| | | | | | Equating |
| 6 | Curriculum | Contract based | Items align to multiple | | |
| | Frameworks | categories | contracts | | |
| 7 | Workflow | | Multilingual user | Contract design tool | |
| | | | interface | Assessment design tool | |
| | | | Item and test authoring | | |
| | | | (pubs, editorial, spell | | |
| | | | check) | | |

### 3. Specific Requirements

This section provides the specific, detailed, uniquely identifiable requirements for the system, which include:

Inputs (stimulus) into the system

Outputs (response) from the system

Functions performed by the system in response to an input or in support of an output

This section is based on an analysis of users and their respective needs and interactions with the system. The itemized nature of software requirements in this section will address every input (stimulus) and output (response) to and from the system.

1.49 3.1 External Interface Requirements

1.49.1. 3.1.1 User Interfaces

3.1.1.1 Introduction to the User Interface Prototype

The first step in developing the user interface for the system will be to rapidly develop a user interface prototype to the extent that a limited number of students and teachers can interact with the prototype as if it were a functioning system.

3.1.1.2 Scope

Build a limited working user interface prototype for Phase I implementation. As time permits, provide client functionality and concept development of post-Phase I features for internal review.

Measured Progress-specific requirements, such as item authoring and scoring workflow, will be developed.

3.1.1.3 Establish Look and Feel—It is important for the user interface to be easily modifiable to suit each Customer's needs. The visual design should be intuitive, clean, and attractive. The user interface should be modular so a different look and feel can be implemented by simply loading a different graphic set and/or treatment. A minimum of three designs will be developed to demonstrate this feature as follows:

Generic Graphics. Logos, buttons, and all graphics will be generated as simple gray rectangles with identifying text in the middle.

Measured Progress Graphics. A full graphic set using the Measured Progress graphic identity.

Client test Graphics. A full graphic set using our Client's CLIENT TEST graphic identity.

3.1.1.4 Proctor Workstation—a computer on a LAN that shares connectivity with student workstations. Used by a proctor to administer student tests, monitor student usage and performance, and distribute test instructions and supplementary materials.

1.49.2. 3.1.2 Hardware Interfaces

As an online assessment administration tool, the system will integrate with paper-and-pencil test administration functionality. The following hardware components may be used in conjunction with online test administration and will interface with the system.

3.1.2.1 Primary and Secondary Memory—There are no constraints on either primary or secondary memory. Both resources will be sized appropriately before production system operation, by using system and stress testing to determine proper amounts.

3.1.2.2 Modes of Operation—When the system is not required to be continuously available for testing, other functions and housekeeping tasks will require that the system be taken offline for short periods of time. Application features and functions will not be available during these maintenance windows. Examples of these maintenance tasks would include data import or export, database backups and software upgrades.

3.1.2.3 Backup and Recovery Operations—The frequency of full and transaction log backups will be balanced against the cost of performing these backups, data loss requirements (save the last screen or response) will be met using other techniques such as transactional messaging.

1.49.3.

1.49.4. 3.1.2.4 Site Adaptation—The system will integrate many systems and applications. Many of these systems and applications are specific to Measured Progress operations. Where this is the case, the applications have been or will be designed to operate at the Measured Progress site. The policies and operations of each deployed online testing system are designed to fit a particular customer's contract needs.

Installation of the system at an ISP or hosting provider may impose restrictions on system operations.

1.49.5. 3.1.3 Software Interfaces

The system will integrate to existing Measured Progress software products and interfaces including:

| | |
|---|---|
| iAnalyze | Software that generates item metric data and aggregated |
| | reports from operational tests and field tests. The |
| | system will export score data to MDA that will in turn |
| | provide exported data to the iAnalyze system. |
| iREF | Item Database containing each item's content and |
| | statistical data. The system will import and export Item |
| | content data from iREF. Eventually the system Item Bank |
| | will replace iREF. |
| iScore | Electronic system for grading scanned, open-response, |
| | item answers. The system will export open-responses from |
| | electronically delivered tests to the iScore system. |
| Pubs | Publications department, responsible for taking Item |
| | data from iREF and other sources and compiling camera- |
| | ready PageMaker files for paper tests. |

1.49.6. 3.1.4 Communications Interfaces

In order for The system to operate, data will need to flow from server to client, client to server, and from client to client and server in some cases. Listed below are the protocols expected to accommodate these flows of data.

3.1.4.1 Standard TCP/IP Internet Protocol—All client computers will be required to have a standard TCP/IP connection to the Internet. The connection is required while using the system or, in the case of a disconnected system, at the time the application's information is downloaded. The system's current architecture allows for users connecting to the Internet through any means (Dialup, ISDN, DSL, LAN, WAN, etc.). These means of connecting may have architectural impact on other aspects of the system. For example, a client computer accessing the Internet through a LAN via a router with NATing may have an obfuscated IP address. Any processes requiring it, such as any messaging systems developed, would then use this potentially incorrect IP address.

Specific Requirements

The system's server will be accessible through TCP/IP

Client computer will have access to the Internet through TCP/IP

3.1.4.3 HTTP & SHTTP—Data and presentation elements will be distributed and available via HTTP. Secure data will be accessed via SHTTP. This protocol includes the methods (“post” and “get”) for retrieving information from the client, as well as cookie technology to preserve information on the client's computer.

Specific Requirements

The system's server will be available through HTTP

The system's server will have a security certificate to enable SHTTP

Client computer will be able to request and receive data through HTTP and SHTTP

Client computer will support the sending of “post” and “get” methods

Client computer will allow The system to place, retrieve, and delete cookies

3.1.4.4 FTP—When necessary, FTP will be used to facilitate the efficient exchange of files between client computers and the server (e.g. software updates).

Specific Requirements

The system's server will have space available through FTP

Authorized client computer will be able to access The system's FTP server to retrieve documents

Authorized client computer will be able to access The system's FTP server to deposit documents

3.1.4.5 Messaging System Interface—A protocol will be used to enable peer to peer messaging for various applications (e.g. student to proctor, teacher to student). This protocol has yet to be determined and proven in implementation. The final architecture of the messaging system may create new or impose constraints on existing communications interface requirements.

1.50 3.2 System Features

The table below describes the system features. Each of these is described in detail in the section that follows.

| | | The system | |
|---|---|---|---|
| 3.2 | System Features | Phase 1 | Notes |
| 3.2.1 | Batch Import | + | |
| 3.2.2 | Certify Item and Test Data Integrity | + | |
| 3.2.3 | Import/Export Item Statistics | + | |
| 3.2.4 | Certify System Data Access | ★ | Privacy must be in core on Day 1. |
| 3.2.5 | Certify Student Data | ★ | In real time is important. |
| 3.2.6 | Manage Security | ★ | |
| 3.2.7 | Manage Staff | ★ | |
| 3.2.8 | Manage District | ★ | Must accommodate variable terms for “school,” |
| | | | “district”, etc., to accommodate state rhetoric, |
| | | | i.e., allow naming conventions to fit state |
| | | | requirements. |
| 3.2.9 | Manage School | ★ | Must accommodate variable terms for “school,” |
| | | | “district”, etc., to accommodate state rhetoric, |
| | | | i.e., allow naming conventions to fit state |
| | | | requirements. |
| 3.2.10 | Manage Class | ★ | |
| 3.2.11 | Manage Roster | ★ | Must allow multiple relationships among units. |
| 3.2.12 | Manage Student | + | |
| 3.2.13 | Personalize View | + | Client requirement: Display pre-built Spanish |
| | | | Tests to selected students. Does not need to be |
| | | | user-selectable, but might be nice. |
| 3.2.14 | View School Class Roster Student Data | ★ | |
| 3.2.15 | Proctor Test | ★ | Example: Set up, queue up, monitor tests, Get |
| | | | electronic feedback. Client is extremely, |
| | | | interested in having this feature. |
| 3.2.16 | Take Operational Test | ★ | Client requires fixed tests only. |
| 3.2.17 | Score Test Results | + | |
| 3.2.18 | View Disaggregated Detail Reports | ★ | Client requirement: Teacher reviews Student test |
| | | | data. This is automatically covered if we |
| | | | implement Use Case Analyze Test Results (see |
| | | | Use Case doc). |
| 3.2.19 | Monitor System Status | ★ | |

Legend:
★ = Required
+ = Required, but can be a brute-force implementation at MP

1.50.1. 3.2.1 Batch Import/Export

3.2.1.1 Introduction/Purpose—This feature allows a system user to import all application data (both structure and content) necessary to deliver and administer an operational test. The batch import will allow for the creation, modification and deletion of application data. The batch export will allow a system user to export selected application data from the application (e.g. Student and Result data.).

3.2.2.2 Stimulus/Response Sequence—

| # | Stimulus | Response |
|---|---|---|
| 1 | Administrative user accesses | System presents Main screen. |
| | Batch Import/Export function. | |
| 2 | User selects import. | System presents list of importable |
| | | data types (e.g. student data: |
| | | district, class, student; item |
| | | content: items, tests). |
| | User enters the data type and | System opens indicated file, |
| | location of source file. | loads data. |
| | User selects export. | System presents list of export- |
| | | able data items. |
| | User enters data type (enroll- | System opens or creates export |
| | ment or result), selection | file, exports indicated data |
| | criteria and path/name of | to export file. |
| | destination file. | |
| 3 | User selects data type to | System confirms actions and |
| | process and requests | executes import or export. |
| | confirmation. | |

3.2.2.3 Associated Functional Requirements

1. Batch import and export functionality will be accessible only to support staff.

2. Batch import and export file formats will be limited to predetermined types (delimited, XML, Excel, etc).

3. Data importable in the batch import interface:

a. Items

b. Tests (Content)

c. Test Instructions

d. Users (1 or more groups, including built-in group)

e. Groups

f. Classes

g. Rosters

h. Rooms

i. Test Schedules

j. Schools

k. Districts

4. Batch import data is edited and consistency checked prior to actual database load. System will not perform validity checks on batch imported data.

5. Data exportable in the batch export interface:

a. Users

b. Groups

c. Classes

d. Rosters

e. Rooms

f. Test Schedules

g. Schools

h. Districts

i. Results

1.50.2. 3.2.2 Certify Item and Test Data Integrity

3.2.2.1 Introduction/Purpose—Item and test content data stored in the test delivery system and item bank are subject to stringent security constraints. The ability to track system data access and to certify that the data is not compromised is critical.

3.2.2.2 Certify Test Data Access—Test data includes item and test content, schedule information, and meta data. A primary security concern is that tests or items will be viewed prior to administration of operational tests, thereby skewing the results. Assessment scaling and equating rely on uncompromised item access for validity.

Stimulus/Response Sequence

| # | Stimulus | Response |
|---|---|---|
| 1 | User accesses “Certify Test | System presents Main screen. |
| | Data Access” function. | |
| 2 | User enters date range to | System presents a list of users |
| | view. | that have accessed test data |
| | | along with level of user |
| | | permissions. |
| 3 | User selects an individual | System presents tabular display |
| | listing for drilldown. | of detail data: date/time and |
| | | type (view, modify, create, |
| | | date) of access for selected |
| | | user. The system shows two |
| | | levels of access: First, access |
| | | that has been in the context of |
| | | a scheduled test session, and |
| | | second, access that has been |
| | | outside the context of a |
| | | scheduled test session. |
| 4 | The user determines if any | |
| | unauthorized access has | |
| | occurred. | |

Certify Test Data Integrity—The second security/quality check to be performed while auditing test and item data is to certify the changes that have been made to items and tests.

Stimulus/Response Sequence

| # | Stimulus | Response |
|---|---|---|
| 1 | User accesses Certify Test | System presents Main screen. |
| | Data Integrity function. | |
| 2 | User enters date range to | System presents list of changes |
| | view. | to test and item content |
| | | data for selected date range. |
| 3 | User selects an individual | System presents tabular display |
| | listing for drilldown. | of date/time and type (view, |
| | | modify, create, date), and |
| | | old/new values. |
| 4 | The user determines if any | |
| | unauthorized data revision | |
| | has occurred. | |

3.2.2.3 Associated Functional Requirements

1. The system shall flag occurrences of low-level database access log entries with no corresponding audit entry in the system (indicates direct access to data from outside the system).

2. The system shall flag occurrences of any view or modify events to secure test content (indicates improper exposure of secure test content).

3. The timeframe of a Certification function shall be user definable (start date/time of report window, end date/time of report window).

4. The end date/time of a Certification report must be later than the start date/time, and may include future date/times.

5. The start date/time of a Certification report may be any time past or future.

6. A Certification report may be saved for future reference.

1.50.3. 3.2.3 Import Item Statistics

3.2.3.1 Introduction/Purpose—This feature will allow a system user to import item statistics (e.g. P-Value, B-Value . . . ) from an external source. In phase 1 of the application, MDA will calculate these statistics and provide input to the batch import process.

Stimulus/Response Sequence

| # | Stimulus | Response |
|---|---|---|
| 1 | User accesses “Import Item | System presents Main screen. |
| | Statistics” function. | |
| 2 | User enters path/name of the | System confirms batch import and |
| | file to be processed and | processes selected file. |
| | requests confirmation. | |

3.2.3.3 Associated Functional Requirements

1. Batch import will be limited to support staff

2. Batch import file formats will be limited to predetermined types (delimited, XLS, etc)

3. Batch import data is edit and consistency checked prior to actual database load.

4. Batch import files will contain unique item number and statistics.

Include but are not limited to:

a. Item difficulty

b. Standard deviation

c. “CORRW” total

d. “IRT B” values

1.50.4. 3.2.4 Certify System Data Access

3.2.4.1 Introduction/Purpose—Data stored in the test delivery system and item bank are subject to stringent privacy and security constraints. The ability to track system data access and to certify that the data is not compromised is critical.

3.2.4.2 Certify Student Data Access—The certify student data access feature allows an auditor to review and report on all access to sensitive student enrollment data. The system provides the ability to review user access to student data within specific time periods.

Stimulus/Response Sequence

| # | Stimulus | Response |
|---|---|---|
| 1 | User accesses Certify System | System presents Main screen. |
| | Data Access function. | |
| 2 | User enters date range to view. | System presents tabular display |
| | | of groups that have accessed |
| | | student data, and the level of |
| | | those permissions. |
| 3 | User selects an individual listing | System presents display of |
| | for drilldown. | users in the selected group. |
| 4 | The user may determine that a | System changes the incorrect |
| | user group or system user with | permissions or removes them |
| | permission to access student data | altogether. |
| | should not have those | |
| | permissions. | |

1.50.5. 3.2.4.4 Certify Test Content Data Access—The auditor will require certification that test content data access was appropriate within a determined timeframe.

Stimulus/Response Sequence

| # | Stimulus | Response |
|---|---|---|
| 1 | User accesses Certify Test | System presents Main screen. |
| | Content Data Access function. | |
| 2 | User enters date range to | System presents tabular display |
| | view. | of groups that have accessed |
| | | content data, and the level of |
| | | those permissions. |
| 3 | User selects an individual | System presents display of |
| | listing for drilldown. | users in the selected group. |
| 4 | The user may determine that | System changes or removes the |
| | a group or system user with | incorrect permissions. |
| | permission to access content | |
| | data should not have those | |
| | permissions | |

3.2.4.5 Certify Test Result Data Access

Stimulus/Response Sequence

| # | Stimulus | Response |
|---|---|---|
| 1 | User accesses Certify Test | System presents Main screen. |
| | Result Data Access function. | |
| 2 | User enters date range | System presents tabular display |
| | to view. | of groups and users that |
| | | have accessed student results |
| | | data, and the level of those |
| | | permissions. |
| 3 | User selects an individual | System presents display of |
| | listing for drilldown. | users in the selected group. |
| 4 | The user may determine that | System changes or removes |
| | a group or system user with | the incorrect permissions. |
| | permission to access content | |
| | data should not have those | |
| | permissions | |

3.2.4.6 Associated Functional Requirements

1. The system shall flag occurrences of users changing groups, particularly a user in the ‘student’ group becoming a member of any other group (indicates a potential security breach).

2. The system shall flag occurrences of low-level database access log entries with no corresponding audit entry in the system (indicates direct access to data from outside the system).

3. The system shall flag occurrences of any view or modify events to secure test content (indicates improper exposure of secure test content).

4. The system shall flag occurrences of test results with date/time stamps outside the range of the scheduled test session (indicates possible tampering with student results).

5. The system shall flag any occurrence of a user being added to the administration group.

6. The timeframe of a Certification function shall be user definable (start date/time of report window, end date/time of report window).

7. The end date/time of a Certification report must be later than the start date/time, and may include future date/times.

8. The start date/time of a Certification report may be any time past or future.

9. A Certification report may be saved for future reference.

1.50.6. 3.2.5 Certify Student Data

3.2.5.1 Introduction/Purpose—Student information stored in a testing system has stringent federal privacy requirements, as well as any additional local level requirements. The system maintains audit information on all access and view of student data, and also maintains security attributes for access to student data (i.e., permissions). The Certify Student Data function allows a system user to review and report on access to student information.

3.2.5.2 Certify Access Permissions

Stimulus/Response Sequence

| # | Stimulus | Response |
|---|---|---|
| 1 | User accesses Certify Student | System presents Main screen. |
| | Data Permissions function. | |
| 2 | User enters date range to | System presents tabular display |
| | view. | of groups and users that have |
| | | accessed student data, and the |
| | | level of those permissions. |
| 3 | User selects an individual | System presents display of |
| | listing for drilldown. | users in the selected group. |
| 4 | The user may determine that | System changes or removes the |
| | a group or system user with | incorrect permissions. |
| | permission to access content | |
| | data should not have those | |
| | permissions | |

1.50.7. 3.2.5.3 Certify Student Data

Stimulus/Response Sequence

| # | Stimulus | Response |
|---|---|---|
| 1 | User accesses Certify Student | System presents Main screen. |
| | Data function. | |
| 2 | User enters date range to | System presents tabular display of |
| | view. | groups and users that have accessed |
| | | student data, and changes (new/old) |
| | | to student data. |
| 3 | User selects an individual | System presents display of users |
| | listing for drilldown. | in the selected group. |

1.50.8. 3.2.5.4 Associated Functional Requirements

1. The system shall be able to identify “orphaned” student records, which have no link to a school, a teacher, or a grade.

2. The system shall maintain audit records of changes to student data, including the date changed, changed by, the data field that changed, the old value and the new value.

3. The system shall maintain audit records (logs) of student data views, including date/time viewed, viewed by.

4. The system shall as a default disallow any access (view, create, modify) to student data from users in the ‘student’ group, except to the user's own data (i.e., view SELF).

5. The system shall disallow any access at all to student data from the ‘default’ user group.

6. The ‘Certify Student Data’ report data shall include: the number of modifications to student data and the modifying group/user; the modification date/time. Student data should be relatively static once it is in the system, so excessive modifications could point to security breach.

7. The ‘Certify Access Permissions’ report data shall include: the user groups that have access to student data; the users who have access to student data; users and groups that have received access permission to student data since the last report.

1.50.9. 3.2.6 Manage Security

3.2.6.1 Introduction/Purpose—This feature allows a system user to view application users, groups, and associated privileges. Users, groups, and group associations will be created during the application data batch import process, where users are assigned to one or more of the built-in groups discussed below.

The permissions structure will be data driven, with group membership limited to built-in groups and permissions limited to what is defined for those groups.

3.2.6.2 View User

Stimulus/Response Sequence

| # | Stimulus | Response |
|---|---|---|
| 1 | User accesses Manage | System presents Main screen. |
| | Security/View function. | |
| 2 | User selects a user to view by | System displays the detail for |
| | drilling down through district, | selected user. |
| | school, teach and class. | User information can be viewed |
| | | but not changed. |

1.50.10. 3.2.6.3 View Group and Privileges

Stimulus/Response Sequence

| # | Stimulus | Response |
|---|---|---|
| 1 | User accesses Manage | System presents Main screen. |
| | Security/View Group and | |
| | Privileges function. | |
| 2 | Users selects a group to view. | System presents tabular display |
| | | of users in the selected group, |
| | | as well as permissions |
| | | associated for the group. |
| | | Group information can be viewed |
| | | but not changed. |

3.2.6.4 Associated Functional Requirements

1. Default/built-in user groups and permissions

2.

Student

Take tests to which they have been assigned (practice and operational)

Teacher

Maintain their own classes

Proctor

Assign student to room/station in their test session

Proxy login for students in their test session

Stop and start their test sessions

Stop and start student test sessions in their test session

Monitor their test sessions and associated student test sessions

School Administrator

Assign proctors to test sessions

Maintain classes

Maintain rosters

Maintain test schedules

Maintain users (inc. Teachers and proctors) and groups

View disaggregated reports

View certification reports

DOE

Maintain districts and schools

View certification reports

View disaggregated reports

Auditor

View certification reports

Trainer

View sample courses, classes, teachers, rosters, schedules

2. A user can belong to one or more groups.

3. Groups do not contain other groups.

1.50.11. 3.2.7 Manage Staff

3.2.7.1 Introduction/Purpose—In addition to student data, the test delivery system must also have data about the staff. This includes the teachers/instructors, aides, proctors, school administrators and their reporting structure, and other support staff such as system technical administrators, clerical, and guidance staff. In order to properly comply with student privacy mandates, and to manage test rosters and results reporting based on teacher/classroom, schools and school systems will find it necessary to set up and maintain staff user accounts and data in the system. The manage staff function allows a system user to create and manage the staff data.

In the test delivery system, all users who access the system are managed by defining a “user group” that has certain specific permissions within the system, and adding a user to that group. A user group is just a ‘bucket’ for containing some number of users who share access and permissions attributes in common. Managing access and permissions at the ‘group’ level makes it far easier to administer access, security, and reporting.

Using ‘groups’ also makes the system flexible and extensible, because new, custom groups can be created to suit a school's unique access requirements without requiring new development or coding. The system defines several ‘core’ groups, which will always be present in a deployed system: the “default” group; the “student” group; the “teacher/instructor” group; the “proctor” group; the “school administrator” group.

3.2.7.2 Manage Staff List

Stimulus/Response Sequence

| # | Stimulus | Response |
|---|---|---|
| 1 | User accesses ‘manage | System presents list of staff |
| | staff’ list | that user is authorized to |
| | | access, which includes access to |
| | | ‘create staff’, ‘view/modify |
| | | staff’, and ‘delete staff’ |
| | | functions. List is sorted by |
| | | District, School, then Staff |
| | | Name. The following data is |
| | | included in the list: |
| | | Name |
| | | User Group(s) |
| | | Staff ID Number |
| | | School ID Number |
| | | Phone |
| | | School |
| | | District |

3.2.7.3 Create Staff

Stimulus/Response Sequence

| # | Stimulus | Response |
|---|---|---|
| 1 | User accesses ‘create | System presents the ‘create |
| | staff’ function | staff’ screen |
| 2 | User enters staff data: | System checks for conflicts |
| | Name | with existing staff and |
| | Staff ID | presents the data for |
| | Phone | verification |
| | Fax | |
| | Email address | |
| | Home Address | |
| | Group(s) | |
| 3 | User accepts or rejects | System saves data if accepted, |
| | the new staff | or discards data if rejected |

3.2.7.4 View/Modify Staff

1.50.12. Stimulus/Response Sequence

| # | Stimulus | Response |
|---|---|---|
| 1 | User accesses ‘view/ | System presents the ‘view/ |
| | modify staff’ function | modify staff’ screen |
| 2 | User views/modifies | System checks for conflicts |
| | staff data: | with existing staff and |
| | Name | presents the data for |
| | Staff ID | verification |
| | Phone | |
| | Fax | |
| | Email address | |
| | Home Address | |
| | Group(s) | |
| 3 | User accepts or rejects the | System saves data if accepted, |
| | changes | or discards data if rejected |

1.50.13. 3.2.7.5 Delete Staff

Stimulus/Response Sequence

| # | Stimulus | Response |
|---|---|---|
| 1 | User accesses ‘delete staff’ | System presents the ‘delete |
| | function | staff’ confirmation screen, |
| | | which includes information |
| | | detail about the district |
| 2 | User accepts or rejects the | System deletes staff if accepted. |
| | deletion | System takes no action if user |
| | | rejects the deletion. |

3.2.7.6 Manage Group List

1.50.14. Stimulus/Response Sequence

| # | Stimulus | Response |
|---|---|---|
| 1 | User accesses ‘manage | System presents list of groups |
| | Group’ list | that user is authorized to |
| | | access, which includes access |
| | | to ‘create group’, ‘view/ |
| | | modify group’, and ‘delete |
| | | group’ functions. List is |
| | | sorted by Group Name. The |
| | | following data is included in |
| | | the list: |
| | | Group Name |

1.50.15. 3.2.7.7 Create Group

Stimulus/Response Sequence

| # | Stimulus | Response |
|---|---|---|
| 1 | User accesses ‘create group’ | System presents the ‘create |
| | function | group’ screen |
| 2 | User enters group data: | System checks for conflicts with |
| | Group Name | existing group and presents the |
| | Description | data for verification |
| | Group Permission(s) | |
| 3 | User accepts or rejects the | System saves data if accepted, |
| | new group | or discards data if rejected |

1.50.16. 3.2.7.8 View/Modify Group

Stimulus/Response Sequence

| # | Stimulus | Response |
|---|---|---|
| 1 | User accesses ‘view/modify | System presents the ‘view/ |
| | group’ function | modify group’ screen |
| 2 | User views/modifies group data: | System checks for conflicts |
| | Group Name | with existing group and |
| | Description | presents the data for |
| | Group Permission(s) | verification |
| 3 | User accepts or rejects the | System saves data if accepted, |
| | changes | or discards data if rejected |

1.50.17. 3.2.7.9 Delete Group

Stimulus/Response Sequence

| # | Stimulus | Response |
|---|---|---|
| 1 | User accesses ‘delete group’ | System presents the ‘delete |
| | function | group’ confirmation screen, |
| | | which includes information |
| | | detail about the district |
| 2 | User accepts or rejects the | System deletes group if accepted. |
| | deletion | System takes no action if user |
| | | rejects the deletion. |

3.2.7.10 Associated Functional Requirements

1. The user who will be managing staff must belong to the school administrator group or system admin group.

2. The required information for creating a teacher/instructor is: Fname, MI, Lname, federal ID (unique identifier), school system/state ID.

3. Any user in the system may be added to the Proctor group.

4. A student may not be both proctor and student for a given test session.

5. A student may not be assigned as proctor to a test session for a given test that they have taken, and may not be assigned as student to a test session for a given test that they have proctored.

1.50.18. 3.2.8 Manage District

3.2.8.1 Introduction/Purpose—The Manage District feature allows a system user to create one or more districts, set or modify district attributes (e.g., district name, contact information, district or school association), and delete districts.

A district shall be defined as one or more levels of aggregation that describes the grouping of schools (e.g. district, county, SAU/SAD), where two or more districts are related in a strict hierarchy.

3.2.8.2 Manage District List

Stimulus/Response Sequence

| # | Stimulus | Response |
|---|---|---|
| 1 | User accesses ‘manage district’ | System presents list of districts |
| | list | that user is authorized to access, |
| | | which includes access to ‘create |
| | | district’, ‘view/modify |
| | | district’, and ‘delete |
| | | district’ functions. List |
| | | is sorted by District Name. The |
| | | following data is included in |
| | | the list: |
| | | District Name |
| | | Contact |
| | | Phone |
| | | City |
| | | Email Contact |

3.2.8.3 Create District

Stimulus/Response Sequence

| # | Stimulus | Response |
|---|---|---|
| 1 | User accesses ‘create | System presents the ‘create |
| | district’ | district’ screen |
| | function | |
| 2 | User enters district data: | System checks for conflicts |
| | District Name | with existing districts and |
| | District Contact | presents the data for verification |
| | Title | |
| | First Name | |
| | Last Name | |
| | Phone | |
| | Fax | |
| | Email address | |
| | Shipping Address | |
| | Street1 | |
| | Street2 | |
| | City | |
| | State | |
| | Zip | |
| | Billing Address | |
| | Street1 | |
| | Street2 | |
| | City | |
| | State | |
| | Zip | |
| 3 | User accepts or rejects the | System saves data if accepted, |
| | new district | or discards data if rejected |

3.2.8.4 View/Modify District

1.50.19. Stimulus/Response Sequence

| # | Stimulus | Response |
|---|---|---|
| 1 | User accesses ‘view/modify | System presents the ‘view/ |
| | district” function | modify district’ screen |
| 2 | User views/modifies district | System checks for conflicts |
| | data: | with existing districts and |
| | District Name | presents the data for |
| | District Contact | verification |
| | Title | |
| | First Name | |
| | Last Name | |
| | Phone | |
| | Fax | |
| | Email address | |
| | Shipping Address | |
| | Street1 | |
| | Street2 | |
| | City | |
| | State | |
| | Zip | |
| | Billing Address | |
| | Street1 | |
| | Street2 | |
| | City | |
| | State | |
| | Zip | |
| 3 | User accepts or rejects the | System saves data if accepted, |
| | changes | or discards data if rejected |

3.2.8.5 Delete District

1.50.20. Stimulus/Response Sequence

| # | Stimulus | Response |
|---|---|---|
| 1 | User accesses ‘delete district’ | System presents the ‘delete |
| | function | district’ confirmation screen, |
| | | which includes information |
| | | detail about the district |
| 2 | User accepts or rejects the | System deletes district if |
| | deletion | accepted. System takes no action |
| | | if user rejects the deletion. |

3.2.8.6 Associated Functional Requirements

1. Access to manage district functions is defined by the user's group security permissions.

2. The system shall perform user permission checks on all changes to district data.

3. The system shall create an audit history of all changes to districts.

4. District names must be unique.

5. A district can be associated with one or more schools or one other district.

6. District contact information includes but is not limited to

a. Contact person(s), including phone number and email addresses

b. Street address

c. Shipping address.

7. Districts may only be deleted if there is no district or school associated.

8. Deleted districts are “logically removed” from view, but remain for certification and historical reporting.

1.50.21. 3.2.9. Manage School

3.2.9.1 Introduction/Purpose—The Manage School feature allows a system user to create schools, set or modify school attributes (e.g., district, school name, contact information, grades), and delete schools.

3.2.9.2 Manage School List

Stimulus/Response Sequence

| # | Stimulus | Response |
|---|---|---|
| 1 | User accesses ‘manage school’ | System presents list of schools |
| | list | that user is authorized to |
| | | access, which includes access |
| | | to ‘create school’, ‘view/ |
| | | modify school’, and ‘delete |
| | | school’ functions. List |
| | | is sorted by District Name |
| | | and School Name. The following |
| | | data is included in the list: |
| | | School Name |
| | | Contact |
| | | Phone |
| | | City |
| | | District Name |

3.2.9.3 Create School

Stimulus/Response Sequence

| # | Stimulus | Response |
|---|---|---|
| 1 | User accesses ‘create school’ | System presents the ‘create |
| | function | school’ screen |
| 2 | User enters school data: | System checks for conflicts |
| | School Name | with existing schools and |
| | School Contact | presents the data for |
| | Title | verification |
| | First Name | |
| | Last Name | |
| | Phone | |
| | Fax | |
| | Email address | |
| | Shipping Address | |
| | Street1 | |
| | Street2 | |
| | City | |
| | State | |
| | Zip | |
| | Billing Address | |
| | Streetl | |
| | Street2 | |
| | City | |
| | State | |
| | Zip | |
| 3 | User accepts or rejects the | System saves data if accepted, |
| | new school | or discards data if rejected |

1.50.22. 3.2.9.4 View/Modify School

Stimulus/Response Sequence

| # | Stimulus | Response |
|---|---|---|
| 1 | User accesses ‘view/modify | System presents the ‘view/ |
| | school’ function | modify school’ screen |
| 2 | User enters school data: | System checks for conflicts |
| | School Name | with existing schools and |
| | School Contact | presents the data for |
| | Title | verification |
| | First Name | |
| | Last Name | |
| | Phone | |
| | Fax | |
| | Email address | |
| | Shipping Address | |
| | Street1 | |
| | Street2 | |
| | City | |
| | State | |
| | Zip | |
| | Billing Address | |
| | Street1 | |
| | Street2 | |
| | City | |
| | State | |
| | Zip | |
| 3 | User accepts or rejects the | System saves data if accepted, |
| | changes | or discards data if rejected |

3.2.9.5 Delete School

1.50.23. Stimulus/Response Sequence

| # | Stimulus | Response |
|---|---|---|
| 1 | User accesses ‘delete school’ | System presents the ‘delete |
| | function | school’ confirmation screen, |
| | | which includes information |
| | | detail about the school |
| 2 | User accepts or rejects the | System deletes school if |
| | deletion | accepted. System takes no action |
| | | if user rejects the deletion. |

3.2.9.6 Associated Functional Requirements

1. Access to manage school functions is defined by the user's group security permissions.

2. The system shall perform user permission checks on all changes to school data.

3. The system shall create an audit history of all changes to schools.

4. School names must be unique within a district.

5. School contact information includes but is not limited to

a. Contact person(s), including phone number and email addresses

b. Principal name(s)

c. Street address

d. Shipping address.

6. A single district will be assigned to a school, with other “districts” related to the primary district.

7. Schools may only be deleted if there are no students associated.

8. Deleted schools are “logically removed” from view, but remain for certification and historical reporting.

1.50.24. 3.2.10 Manage Class

3.2.10.1 Introduction/Purpose—The Manage Class feature allows a system user to create classes, add/remove students from a class, set or modify class attributes (e.g., school, grade, class name, room, time, teacher(s), and associated students), and delete classes.

A class shall be defined as group of students selected from a single grade level across one or more schools and districts.

3.2.10.2 Manage Class List

Stimulus/Response Sequence

| # | Stimulus Response | |
|---|---|---|
| 1 | User accesses ‘manage class’ | System presents list of |
| | list | classes that user is |
| | | authorized to access, which |
| | | includes access to ‘create |
| | | class’, ‘view/modify class’, |
| | | and ‘delete class’ functions. |
| | | List is sorted by District, |
| | | School, Grade Level, and |
| | | Class Name. The following |
| | | data is included in the list: |
| | | Class name |
| | | Teacher(s) |
| | | Grade level |
| | | Content Area |
| | | School |

3.2.10.3 Create Class

1.50.25. Stimulus/Response Sequence

| # | Stimulus | Response |
|---|---|---|
| 1 | User accesses ‘create class’ | System presents ‘create |
| | function | class’ screen |
| 2 | User enters class data: | System checks for conflicts |
| | Class name | with existing classes and |
| | Teacher(s) | presents the data for |
| | Grade level | verification |
| | Content Area | |
| | Student(s) | |
| 3 | User accepts or rejects | System saves data if accepted, |
| | the new class | or discards data if rejected |

3.2.10.4 View/Modify Class

1.50.26. Stimulus/Response Sequence

| # | Stimulus | Response |
|---|---|---|
| 1 | User accesses ‘view/modify | System presents ‘view/modify |
| | class’ function | class’ screen |
| 2 | User enters class data: | System checks for conflicts |
| | Class name | with existing classes and |
| | Teacher(s) | presents the data for |
| | Grade level | verification |
| | Content Area | |
| | Student(s) | |
| 3 | User accepts or rejects the | System saves data if accepted, |
| | changes | or discards data if rejected |

3.2.10.5 Delete Class

1.50.27. Stimulus/Response Sequence

| # | Stimulus | Response |
|---|---|---|
| 1 | User accesses ‘delete class’ | System presents the ‘delete |
| | function | class’ confirmation screen, |
| | | which includes information |
| | | detail about the class |
| 2 | User accepts or rejects the | System deletes class if |
| | deletion | accepted. System takes no |
| | | action if user rejects the |
| | | deletion. |

3.2.10.6 Associated Functional Requirements

1. Access to manage class functions is defined by the user's group security permissions.

2. The system shall perform user permission checks on all changes to class data.

3. The system shall create an audit history of all changes to classes.

4. Class names must be unique within a school.

5. A student may not be in more than one room/time combination.

6. A teacher may not be in more than one room/time combination.

7. A class can only be assigned to one school (class is ‘within’ school).

8. A class can only be assigned to one grade (class is ‘within’ grade).

9. The room assigned to a class is limited to those available for the time slot in the assigned school.

10. One primary teacher must be assigned to a class.

11. Additional teachers may also be assigned to a class.

12. Teachers are selected from a list limited by district, school or grade.

13. A class may contain zero students.

14. Students are selected from a list limited by district, school or grade.

15. Removing a student from a class associated with a roster does not explicitly remove the student from that roster.

16. Deleted classes are “logically removed” from view, but remain for certification and historical reporting.

1.50.28. 3.2.11 Manage Roster

3.2.11.1 Introduction/Purpose—The Manage Roster feature allows a system user to create rosters, set or modify roster attributes (e.g., school, grade, roster name and associated students), and delete rosters.

A roster shall be defined as a group of students selected from one or more classes that can be scheduled to take an operational test.

1.50.29. 3.2.11.2 Manage Roster List

Stimulus/Response Sequence

| # | Stimulus | Response |
|---|---|---|
| 1 | User accesses ‘manage roster’ | System presents list of rosters |
| | list | that user is authorized to |
| | | access, which includes access |
| | | to ‘create roster’, ‘view/ |
| | | modify roster’, and ‘delete |
| | | roster functions. List is |
| | | sorted by District, School and |
| | | Roster Name. The following |
| | | data is included in the list: |
| | | Roster name |
| | | Grade level |
| | | School |
| | | District Name |

1.50.30. 3.2.11.3 Create Roster

Stimulus/Response Sequence

| # | Stimulus | Response |
|---|---|---|
| 1 | User accesses ‘create roster’ | System presents ‘create roster’ |
| | function | screen |
| 2 | User enters roster data: | System checks for conflicts |
| | Roster name | with existing rosters and |
| | Grade level | presents the data for |
| | Student(s) | verification |
| 3 | User accepts or rejects | System saves data if accepted, |
| | the new roster | or discards data if rejected |

1.50.31. 3.2.11.4 View/Modify Roster

b 1.50.32. Stimulus/Response Sequence

| # | Stimulus | Response |
|---|---|---|
| 1 | User accesses ‘view/modify | System presents ‘view/modify |
| | roster’ function | roster’ screen |
| 2 | User enters roster data: | System checks for conflicts |
| | Roster name | with existing rosters and |
| | Grade level | presents the data for |
| | Student(s) | verification |
| 3 | User accepts or rejects the | System saves data if accepted, |
| | new roster | or discards data if rejected |

1.50.33. 3.2.11.5 Delete Roster

1.50.34. Stimulus/Response Sequence

| # | Stimulus | Response |
|---|---|---|
| 1 | User accesses ‘delete roster’ | System presents the ‘delete |
| | function | roster’ confirmation screen, |
| | | which includes information |
| | | detail about the roster |
| 2 | User accepts or rejects the | System deletes class if |
| | deletion | accepted. System takes no |
| | | action if user rejects the |
| | | deletion. |

3.2.11.6 Associated Functional Requirements

1. Access to manage roster functions is defined by the user's group security permissions.

2. The system shall perform user permission checks on all changes to roster data.

3. The system shall create an audit history of all changes to rosters.

4. Roster names must be unique within a school.

5. The student grade and roster grade must match.

6. A roster will be assigned to a single school.

7. A roster will be assigned to a single grade.

8. A roster may contain no students.

9. Students are selected from a list limited by district, school, grade or class.

10. Adding or removing students from a roster may only happen if that roster is either not associated with a test session or the test session is scheduled in the future (or has not been started by the proctor).

11. Deleting rosters may only happen if that roster is not associated with a test session or that test session is in the future and the association may also be deleted.

12. Deleted rosters are “logically removed” from view, but remain for certification and historical reporting.

1.50.35. 3.2.12 Manage Student

3.2.12.1 Introduction/Purpose—The Manage Student feature allows the user to access student enrollment, demographic, test session, test result, school/grade/class/roster assignments and modify them if necessary

A student shall be defined as a unique individual user that is assigned to the ‘student’ core user group.

3.2.12.2 Add Student

Stimulus/Response Sequence

| # | Stimulus | Response |
|---|---|---|
| 1 | The user accesses the Add | The system presents the Add |
| | Student function. | Student screen. |
| 2 | The user enters student | The system checks for conflicts |
| | name, ID, and other student | with existing students (duplicate |
| | info, and/or selects primary | check) and presents the data |
| | school, grade level, and class. | for verification. The user |
| | | accepts or declines the new |
| | | student. |

3.2.12.3 View/Modify Student

Stimulus/Response Sequence

| # | Stimulus | Response |
|---|---|---|
| 1 | The user accesses the | The system presents the View/ |
| | View/Modify Student function. | Modify Student screen. |
| 2 | The user views and/or makes | The system checks for conflicts |
| | changes to the information | (as in ‘create student’) and |
| | given in the student detail. | presents the new information |
| | | for verification. The user |
| | | accepts or declines the changes |
| | | to the existing student record. |

3.2.12.4 Delete Student

Stimulus/Response Sequence

| # | Stimulus | Response |
|---|---|---|
| 1 | User accesses ‘delete student’ | System presents the ‘delete |
| | function | student’ confirmation screen, |
| | | which includes information |
| | | detail about the student |
| 2 | User accepts or rejects the | System deletes class if accepted. |
| | deletion | System takes no action if user |
| | | rejects the deletion. |

3.2.12.5 Assign Student

Stimulus/Response Sequence

| # | Stimulus | Response |
|---|---|---|
| 1 | The user accesses the Assign | The system presents the user |
| | Student function. | with an assignment option |
| | | list including SCHOOL, GRADE, |
| | | CLASS, and ROSTER. |
| 2 | The user selects roster. | The system displays two lists; |
| | | the available rosters, and the |
| | | rosters already assigned. The |
| | | user may select one or more |
| | | available rosters for assignment |
| | | to the student. The system |
| | | prompts for confirmation. The |
| | | user accepts or declines. |
| 3 | The user selects class. | The system displays available |
| | | classes, and classes already |
| | | assigned. The user may select |
| | | one and only one class from |
| | | available classes for PRIMARY |
| | | CLASS assignment. The user may |
| | | select zero or more classes |
| | | from available classes for |
| | | ADDITIONAL CLASS assignment. |
| | | The system prompts for confirm- |
| | | ation. The user accepts or |
| | | declines. |
| 4 | The user selects grade. | The system displays available |
| | | grades for assignment. The |
| | | user selects one and only one |
| | | grade. The system prompts for |
| | | confirmation. The user accepts |
| | | or declines. |
| 5 | The user selects school. | The system displays available |
| | | schools for assignment. The |
| | | user selects one and only one |
| | | primary school, and zero or |
| | | more additional schools. The |
| | | system prompts for confirmation, |
| | | and the user accepts or declines. |

3.2.12.6 Associated Functional Requirements

1. Access to manage student functions is defined by the user's group security permissions.

2. The system shall perform user permission checks on all changes to student data.

3. The system shall create an audit history of all changes to student data.

4. Students must be unique within the system.

5. A student will have one and only one primary school assignment.

6. A student may have zero or more additional school assignments.

7. Deleted students are “logically removed” from view, but remain for certification and historical reporting.

1.50.36. 3.2.13 Personalize View

3.2.13.1 Introduction/Purpose—The Personalize View feature allows a system user to view or modify application configuration settings.

A setting shall be defined as a user defined preference that affects security policies, and custom presentation and content of screens and/or results for one or more other system users.

3.2.13.2 View/Modify Setting

Stimulus/Response Sequence

| # | Stimulus | Response |
|---|---|---|
| 1 | The user accesses the | The user views and/or makes |
| | view/modify function and the | changes to the existing |
| | system presents the view/ | setting values. The system |
| | modify screen. | checks for conflicts and |
| | | presents the new information |
| | | for verification. |
| 3 | User accepts or rejects the | System saves data if accepted, |
| | changes | or discards data if rejected |

3.2.13.3 Associated Functional Requirements

1. Access to Personalize View is defined by the user's group security permissions.

2. The system shall perform user permission checks on all changes to data.

3. Student settings include but are not limited to

a. Default screen size

b. Default font and size

c. Default testing language (English, Spanish)

d. Other “assistive” technology requirements.

4. Teacher settings

a. Default security policy for owner objects (class, test . . . )

5. Proctor settings

a. Default testing language (for instructions)

6. Administrator settings

a. District naming standard (what to call aggregation level(s) above school, e.g., district, county, SAU/SAD)

b. Default grade scaling for teachers in a school

c. Default security policies for proctors, teachers and students

1.50.37. 3.2.15 Proctor Test

3.2.15.1 Introduction/Purpose—Student test sessions may be conducted in a number of situations, including a controlled/uncontrolled physical environment; a controlled/uncontrolled workstation; with a ‘private’ (student's keystrokes/mouse movement not captured) session or a ‘monitored’ (student's keystrokes/mouse movement captured) session. A secure, operational test is usually conducted in a controlled physical and workstation environment, and may also include interaction between the student's session and a remote proctoring workstation. The ‘Proctor’ is the system user that performs the controlling/monitoring.

A user becomes a ‘Proctor’ by being added to the proctor core user group. The proctor group enables the various permissions and access that allow a user to proctor tests.

Most system users have a ‘primary role’ in the system . . . for instance they are a student, or a teacher, or a school administrator. As such, they are added to the ‘student’ core user group, or the ‘teacher’ core user group, or the ‘administrator’ group. In addition to these primary roles, a user may also be added to the ‘proctor’ group.

Since test proctoring involves some significant security concerns, the proctor role is defined in it's own special user group, the proctor group. In order to proctor a test, a user (such as a teacher or administrator) must be added to the proctor group. (So, the user is now a member of BOTH their primary group AND the proctor group). When they log in to the system, both proctoring functions and their primary functions are available to them. (no need to use separate logins to access different features).

In order to actually proctor a specific test session, a user will have to be a member of the proctor group, and also be specifically assigned to that test session.

3.2.15.2 Set Test Session Proctor Configuration

Stimulus Response Sequence

In the section below, functions are split into functions that the proctor can access for the entire group of students (test session), and functions for the individual student in a test session (student test session).

| # | Stimulus | Response |
|---|---|---|
| 1 | User (Proctor) accesses the | System returns the Test |
| | Test Session | Session information screen |
| 2 | User (Proctor) sets up the | System checks for conflicts |
| | proctor configuration, which | and presents the data for |
| | has the following configur- | verification |
| | ation options: | |
| | Proctor proxy login | |
| | ONLY/student self-login | |
| | Proctor start | |
| | session/student self-start | |
| | Proctor stop | |
| | session/student self-stop | |
| | Proctor assign test | |
| | station/student self-assign | |
| 3 | User (Proctor) accepts or | System saves data if accepted, |
| | rejects the changes | or discards data if rejected |

1.50.38. 3.2.15.3 Assign Student to Room/Test Station

1.50.39.

1.50.40. Stimulus/Response Sequence

| # | Stimulus | Response |
|---|---|---|
| 1 | User (Proctor) accesses the | System returns the Test |
| | Test Session | Session information screen |
| 2 | User (Proctor) selects a student | System checks for conflicts |
| | record, a room, and/or a test | and presents the data for |
| | station. | verification |
| 3 | User (Proctor) accepts or rejects | System saves data if accepted, |
| | the changes | or discards data if rejected |

1.50.41. 3.2.15.4 Proxy Student Login

The Proxy Student Login function allows the proctor to start a student test session on a test station using the proctor login/password, rather than requiring that the student know/remember an individual password. This function would be used by a proctor who was ‘setting up a room’ for a group of students, and wanted to perform the login process on behalf of the students (e.g., for 1^{st} grade students).

| # | Stimulus | Response |
|---|---|---|
| 1 | User (Proctor) logs in to the | System returns the Test |
| | system from the intended | Session information screen |
| | student's test station and | |
| | selects a | |
| | test session from the schedule | |
| 2 | User (Proctor) selects the proxy | System presents a proxy |
| | login function | login screen |
| 3 | User (Proctor) selects a student | System returns a verification |
| | from the test roster, enters the | screen to the test station |
| | test station name, enters the | |
| | proctor password, and submits the | |
| | information | |

1.50.42. 3.2.15.5 Monitor Test Session

Monitor Test Session function allows the proctor to follow the progress of student test sessions in real time.

| # | Stimulus | Response |
|---|---|---|
| 1 | User (Proctor) accesses the | System returns the Test Session |
| | Test Session | information screen, which |
| | | includes graphical display of |
| | | the progress of each student |
| | | test session |
| 2 | User (Proctor) sends message | System delivers message to |
| | to student | student |
| 3 | User (Student) sends message | System delivers message to |
| | to Proctor | Proctor |

1.50.43. 3.2.15.6 Monitor Student Test Session

| # | Stimulus | Response |
|---|---|---|
| 1 | User (Proctor) accesses the | System returns the Test Session |
| | Test Session | information screen, which |
| | | includes graphical display of |
| | | the progress of the student |
| | | test session |
| 2 | User (Proctor) sends message | System delivers message to student |
| | to student | |
| 3 | User (Student) sends message | System delivers message to Proctor |
| | to Proctor | |

1.50.44. 3.2.15.7 Start Test Session

The proctor can start all the student test sessions in a test session from a proctoring station, rather than students starting their own sessions. Students in the test session will log on to the test session.

| # | Stimulus | Response |
|---|---|---|
| 1 | User (Proctor) accesses the Test | System returns the Test Session |
| | Session | information screen |
| 2 | User (Proctor) activates the | System transmits a ‘start’ |
| | ‘proctored session start’ function | message to each student logged |
| | | in to the test session. If it |
| | | is a timed test session, this |
| | | action will also begin the |
| | | session clock. |

1.50.45. 3.2.15.8 Stop Test Session

The proctor can stop all the student test sessions in a test session from a proctoring station, rather than students stopping their own sessions.

| # | Stimulus | Response |
|---|---|---|
| 1 | User (Proctor) accesses the Test | System returns the Test Session |
| | Session | information screen |
| 2 | User (Proctor) activates the | System transmits a ‘stop’ |
| | ‘proctored session stop’ function | message to each student logged |
| | | in to the test session. If it |
| | | is a timed test session, this |
| | | action will also begin the |
| | | session clock. |

1.50.46. 3.2.15.9 Start Student Test Session

The proctor can start an individual student test session from a proctoring station, rather than the student starting their own session.

| # | Stimulus | Response |
|---|---|---|
| 1 | User (Proctor) accesses the Test | System returns the Test |
| | Session | Session information screen |
| 2 | User (Proctor) activates the | System sends the student a |
| | ‘proctor start’ function for an | ‘start test’ message. If it |
| | individual student in the session | is a timed test session, |
| | (as compared to ‘all students’) | this action will also start |
| | | the student test session clock |

1.50.47. 3.2.15.10 Stop Student Test Session

The proctor can stop an individual student test session from a proctoring station, rather than the student stopping their own session. The proctor may mark the student test session as invalid, and must write a reason (e.g., the student was cheating, got sick, other extenuating circumstances).

| # | Stimulus | Response |
|---|---|---|
| 1 | User (Proctor) accesses the | System returns the Test |
| | Test Session | Session information screen |
| 2 | User (Proctor) activates the | System requests reason for |
| | ‘proctor stop’ function for | stopping the student's test |
| | an individual student in the | session from Proctor |
| | session (as compared to ‘all | |
| | students’) | |
| 2 | User (Proctor) enters reason | System sends the student a |
| | for stopping the student's | ‘stop test’ message and records |
| | test session | reason entered by Proctor. If |
| | | it is a timed test session, this |
| | | action will also start the |
| | | student test session clock |

1.50.48. 3.2.15.11 Restart Test Session

The proctor can restart a stopped test session from a proctoring station, rather than the students restarting their own student test sessions.

| # | Stimulus | Response |
|---|---|---|
| 1 | User (Proctor) accesses the | System returns the Test Session |
| | Test Session | information screen |
| 2 | User (Proctor) activates the | System sends the student a ‘start |
| | ‘proctor session resume’ | test’ message to each student |
| | function | logged in to the test session. |
| | | If it is a timed test session, |
| | | this action will also resume the |
| | | student test session clock |

1.50.49.

1.50.50. 3.2.15.12 Restart Student Test Session

The proctor can restart an individual student test session from a proctoring station, rather than the student restarting their own session.

| # | Stimulus | Response |
|---|---|---|
| 1 | User (Proctor) accesses the | System returns the Test Session |
| | Test Session | information screen |
| 2 | User (Proctor) activates the | System sends the student a ‘start |
| | ‘proctored session resume’ | test’ message to the student. If |
| | function for an individual | it is a timed test session, this |
| | student in the session (as | action will also resume the student |
| | compared to ‘all students’) | test session clock |

1.50.51. 3.2.15.13 Associated Functional Requirements

1. The user who will be proctor for a test session must be a member of the ‘proctor’ group.

2. The user who will proctor for a test session must be assigned to that session (members of the proctor group will only be able to proctor a particular test session if they are assigned to the test session).

3. A test session proctor will not be able to view actual student responses to test items.

4. The proctor may check an ‘invalid test’ flag on the student test session, to indicate a circumstance beyond the student's control, a system failure, or student malfeasance.

5. If the ‘invalid test’ flag is checked, then the proctor must enter a reason/comment.

6. If a proctor takes action with respect to a student test session, the system will not allow the student to override (e.g., if proctor stops student session, student cannot restart without proctor).

7. One or more proctors may be assigned to a session.

8. The proctor ‘monitor student test session’ function shall display the session start time, session time elapsed, session time remaining, current question number, number of answered questions, number of skipped questions, questions remaining, and for timed tests, a three-state ‘completion factor’, which will divide the elapsed minutes by the number of answered questions, multiply the result by the number of questions remaining, and subtract that result from the number of minutes remaining. If the student is pacing behind for the amount of time lapsed, the result of the calculation will be a negative number, indicating an ‘off pace’ status for the student. If the student is right on pace for the session, the result of the calculation will be near zero, indicating an ‘on pace’ status for the student. If the student is ahead, the result of the calculation will be a positive number, indicating an ‘ahead of pace’ status for the student. The ‘completion factor’ indicator gives the proctor a metric for how likely the student is to finish the test within the time allotted. The proctor may elect to communicate this information to the student via a message.

9. The proctor ‘monitor test session’ function shall display the session start time, session time elapsed, session time remaining, average number of answered questions, average questions remaining, and for timed tests, a three-state ‘completion factor’, as described above in (8) which will use the aggregate test session questions answered and questions remaining values for the calculation of the completion factor for the entire group of students.

10. The ‘monitor test session’ shall provide the proctor with an indicator of the number of students that have completed the test session, as a percent of the total number of students in the session.

11. The system will maintain start time, time remaining, and stop time individually for each student session.

1.50.52. 3.2.16 Take Operational Test

3.2.16.1 Introduction/Purpose—The Take Operational Test feature allows a system user (e.g., a student) to take a proctored, timed test or restart an interrupted test session.

3.2.16.2 Take Test

Stimulus/Response Sequence

| # | Stimulus | Response |
|---|---|---|
| 1 | Student accesses Take Test | System presents test. |
| | function from a test station | |
| | that has already been logged | |
| | and setup by a test proctor, | |
| | or by logging into (providing | |
| | security credentials) the | |
| | application at a designated | |
| | test station | |
| 2 | Item is answered and | System records response. |
| | submitted. | A student may revisit any |
| | | question already answered |
| | | and provide a new answer |
| | | if desired |
| 3 | Student accesses Help | Help appears with history |
| | function | and options for messaging |
| | | the Proctor. |
| 4 | Student requests and confirms | Student's test session ends. |
| | that the test and results have | |
| | been completed. | |

3.2.16.3 Restart Test

Stimulus/Response Sequence

| # | Stimulus | Response |
|---|---|---|
| 1 | Proctor login of the student | The interrupted test will auto- |
| | or the student login on the | matically restart with the question |
| | new station | after the last answered question. |
| | | This new test session may be |
| | | interrupted and completes in the |
| | | same fashion as the ‘take test’ |
| | | function. |

3.2.16.4 Associated Functional Requirements

1. Access to take operation test functions is defined by the user's group security permissions.

2. A student may only take an operational test if assigned to a roster associated with that test session.

3. A student may be added to the test session roster on the day of the test (by proctor?).

4. A student may only see the same operational test in the special case of an interrupted test session (see Restart Test).

5. A student has no visibility of raw test results during the test session.

1.50.53. 3.2.17 Score Test Results

1.50.54. 3.2.17.1 Introduction/Purpose—The Score Test Results feature allows a system user to score student responses for all test sessions given for selected tests. The user may also export scored student responses for processing by an external application (e.g. MDA analysis of printed and web results).

Stimulus/Response Sequence

| # | Stimulus | Response |
|---|---|---|
| 1 | User accesses Score Test | System presents a list of |
| | Results function. | tests that have corresponding |
| | | student results. |
| 2 | User selects one or more | If the user chooses export, |
| | tests from a list of tests | the user will be required to |
| | with student results, also | enter the location of the |
| | choosing whether to score, | export file. After confirmation, |
| | export or both. | the system scores the selected |
| | | test results and optionally |
| | | produces an export file of the |
| | | scored results. |

3.2.17.2 Associated Functional Requirements

1. Tests may be scored multiple times in the event of key changes

2. Test export file formats will be limited to predetermined types (delimited, XLS, etc)

3. Test export files will include but not be limited to the following values:

a. Student internal identifier (system primary key)

b. Student external identifier (SSN)

c. District

d. School

e. Class

f. Testing date

g. Test given

h. Test responses

i. Scored results

1.50.55. 3.2.18. View Disaggregated Reports

3.2.18.1 Introduction/Purpose—The View Disaggregated Reports feature allows a system user to view raw test results at the test, student or item level.

3.2.18.2 View Existing Report

Stimulus/Response Sequence

| # | Stimulus | Response |
|---|---|---|
| 1 | User accesses View | System presents View Existing |
| | Disaggregated Reports | Report options. |
| | function. | |
| 2 | User selects from list of | System presents search and sort |
| | existing reports, including | criteria for selected report. |
| | those reports that have | |
| | been customized and saved | |
| | as ad hoc reports. | |
| 3 | User requests confirmation | System generates report results |
| | to generate selected report. | for viewing and/or saving in a |
| | | downloadable format. |

1.50.56. 3.2.18.3 Create Ad Hoc Report

Stimulus/Response Sequence

| # | Stimulus | Response |
|---|---|---|
| 1 | User accesses View | System presents Ad Hoc Report |
| | Disaggregated Reports function. | options. |
| 2 | User modifies existing search | System prompts user to update |
| | and sort criteria and requests | an existing ad hoc report |
| | confirmation to generate | or create a new one. |
| | selected report. | |
| 3 | User must select name of | System generates results for |
| | existing report or enter | viewing and/or saving in a |
| | new (unique) one. | downloadable format. |

3.2.18.4 Associated Functional Requirements

1. Access to report functions is defined by the user's group security permissions.

2. The system shall perform user permission checks on all access to test result data.

3. Ad hoc report names must be unique for a system user.

4. Pre-existing reports include but are not limited to DOE report by district Administrator report by school, grade or roster Teacher report by class.

5. Report search and sort criteria include

a. District

b. School

c. Grade

d. Class

e. Roster

f. Student demographics

g. Test date.

6. Report results shall be saved in a user's choice of formats (e.g., HTML, PDF, RTF, XLS)

1.50.57. 3.2.19 Monitor System Status

3.2.19.1 Introduction/Purpose—The Monitor System Status feature allows a user to monitor various aspects of the application and underlying system, taking corrective actions when necessary.

3.2.19.2 Monitor System Interactively

Stimulus/Response Sequence

| # | Stimulus | Response |
|---|---|---|
| 1 | User accesses Monitor | System presents Monitor System Status |
| | System Status/View Inter- | options. |
| | active function. | |
| 2 | User selects diagnostic | System presents display of the latest |
| | parameter to monitor. | ‘statistics’ for that parameter |
| | | (e.g. concurrent application users) |

3.2.19.3 Take Corrective Action

Stimulus/Response Sequence

| # | Stimulus | Response |
|---|---|---|
| 1 | User accesses Monitor | System presents possible actions |
| | System Status/Take | to take. |
| | Correct Action function. | |
| 2 | User selects action to | System responds by implementing |
| | take and requests con- | action after checking for potential |
| | firmation. | conflicts (e.g. disable application |
| | | after checking that no test |
| | | sessions are in progress.) |

3.2.19.4 Match System Batch

1.50.58. Stimulus/Response Sequence

| # | Stimulus | Response |
|---|---|---|
| 1 | User accesses Monitor System | System presents Main screen. |
| | Status/Monitor Batch function. | |
| 2 | User selects parameter to | System responds by queuing |
| | monitor, frequency interval, | batch a process to monitor |
| | threshold setting and | the parameter at the desired |
| | corrective action to be | interval. |
| | taken, and requests confir- | |
| | mation. | |
| | For example, the parameter | |
| | may be the amount of free | |
| | disk space on the database | |
| | server, interval is hourly, | |
| | with the threshold set to | |
| | “below 10%” | |
| | The corrective actions to | |
| | be taken are sending email | |
| | to an administrator and | |
| | disabling new application | |
| | logins. | |

3.2.19.5 Associated Functional Requirements

1. Access to monitor system status class functions is defined by the user's group security permissions.

2. The system shall create an audit history of all corrective actions taken.

3. System attributes monitored included but are limited to

Server uptime

Application uptime

Total users

Concurrent users

Total tests by time period

Free Disk Space

4. Corrective actions include but are not limited to

Email notification

System/application shutdown

Limit new application sessions

Restricting access to or disabling system features.

1.50.59. 3.2.20 View Help

3.2.20.1 Introduction/Purpose—The View Help function allows a system user to request context sensitive help from any advertised location. Context sensitive help shall be defined as static help screens that describe functionality in the user's current view, and explains the implications of the various options available to the user.

1.50.60. Stimulus/Response Sequence

| # | Stimulus | Response |
|---|---|---|
| 1 | User accesses Help function. | System presents corresponding |
| | | help screen in a popup window. |
| 2 | User browses to new topic | System presents help in same |
| | in popup window. | manner. |
| 3 | Users request help session | System simply closes popup |
| | to end. | window. |

3.2.20.2 Associated Functional Requirements

1. Help will be displayed in the same popup window

2. Help will provide a table of contents for browsing of help for other functions

3. Help will not be searchable or have a keyword index

1.51 3.3 Performance Requirements

Phase I components of (e.g. test delivery software, client side user interfaces) will meet the following performance requirements:

1. Server will provide 99.99% of responses in less than 5 seconds

2. Have mean response times less than 3 seconds

3. Suffer a worst-case data loss of 5 minutes of clock time

4. Ability to archive and restore 5 years of historical data

5. Support 1 million users and 20% concurrency

6. Performance will not degrade under a sustained load of 200,000 concurrent user sessions

7. User sessions will timeout after 60 minutes of inactivity

1.52 3.4 Design Constraints

1.52.1. 3.4.1 Software Development Standards

Application development shall adhere to consistent, industry-standard coding and naming conventions, regardless of the platform and toolset chosen for the architecture. This will require that these standards be clearly defined, distributed to and followed by all project developers.

Application functionality that requires client specific logic or rules-based decisions shall be easily configurable from one customer to the next. This will require that such logic or rules be encapsulated external to the application code, e.g. settings extracted from XML files or database tables, rules processing engine, etc.

All code developed for the application shall avoid platform specific references (e.g. Windows API) and vendor specific implementations of technologies (e.g. Weblogic JMS). This will allow the application to be ported to variety platforms to meet customer requirements, including both performance and cost.

1.52.2. 3.4.2 Software QA Standards

All modules developed for the application shall be incorporated into system and stress testing from inception. This will require that modules be immediately integrated into the testing cycle, allowing QA to identify functional and performance issues early in the development of the application.

3.4.3 Data Portability Standards

User data shall adhere to SIF standards (see http://www.sifinfo.org for more information). This will require that all data elements for each phase of development be identified and sourced in the SIF standards, and physical data models be constructed to align with those standards.

Item, content and course data shall adhere to SCORM/IMS standards (see http://www.imsproject.org and http://www.adlnet.org for more information). This will require that all data elements be sourced and physical data models be constructed accordingly.

3.4.4 Regulatory

Student data privacy and access shall adhere to requirements defined by the No Child Left Behind Act of 2001 (NCLB) and the Family Educational Rights and Privacy Act (FERPA). This will require that the application provide strict access to and certify the validity of all student data. This will require a robust application security model and data auditing functionality be implemented in the first phase of the application.

3.4.5 Auditing and Control

Data certification requirements will require that audit information be collected whenever any application data is modified. The overhead required to generate and save this auditing data shall not interfere with the performance and reliability of the application.

The business rules for tolerable data losses will require that application data must be restorable to a specific point in time. The database backups required to support this requirement shall not interfere with the performance and reliability of the application and must be accounted for in the secondary memory requirements.

3.4.6 Security and Encryption:

Operational test and item content shall be encrypted when transmitted between client workstations and central servers. Any item or test content cached on the client shall also be encrypted, and no copies shall remain on the client after a test session has completed. Student responses shall be encrypted after being submitted by the client, up to the point of being successfully updated on the back-end database. This will require use of industry-standard encryption (e.g. SSL, RSA) and tight control over content caching on the clients.

3.4.7 Physical

There shall be no hardware constraints on the client other than minimum baselines defined for supported platforms (e.g. Windows, Macintosh). There shall be no constraints on the server hardware, other than what is required to meet performance and cost requirements.

There shall be no environmental constraints on the deployment of servers or clients for any phase of the application. Servers shall be deployed in secure facilities but will not require any different setup than what a standard enterprise ISP host provides.

3.4.8 Reliability and Performance

1. Concurrent user load (200K)

2. Spiky traffic (login/submit test)

3. Subsecond response time

4. High bandwidth→caching

5. Data loss and integrity

6. Uptime requirements/availability→data/trx redundancy

1.53 3.5 Software System Attributes

1.53.1. 3.5.1 Availability

1. Database backup schedule (full & transactional) that meets business requirements for acceptable loss of data (less than 5 minutes of clock time)

2. Ability to restore application up to point of failure

3. Client can function in ‘disconnected’ mode and upload/download data when needed and possible (e.g. use of remote proxy servers with distributed content)

4. The system service is available at all times, except whilst it is being backed up at a low demand time period.

5. The system hardware will provide high-availability through the use of hot swap peripherals, CPU failover and system redundancy.

1.53.2.

1.53.3. 3.5.2 Scalability

Architecture supports horizontal scaling in all tiers. Minimum requirements for this are UI & business tiers.

Use of messaging to handle high traffic volumes & manage database load

Cache data as close to “use point” as possible (e.g. items, tests)

System modules will operate in a Parallel and Distributed environment.

If the system is run in a distributed fashion, it will be necessary for applications and other modules to query for existing available modules. A central manager or preferably a networked directory of modules that can cascade updates (similar to DNS) should be in place.

To allow a module to be dynamic, it must be able to be configured at any moment. This will allow the characteristics of the modules' operation to be dynamically changed in order to adapt to new situations and data streams. Each module should be able to load its configuration from a file or and be ready to begin operation utilizing the new configuration.

1.53.4. 3.5.3 Fault Tolerance/Reliability

No single point of failure in any physical tier:

1. Load balancer

2. Web servers

3. App servers

4. Database servers

5. Switches

6. Power Supplies

Use of transaction messaging to prevent any data loss (e.g. last student response is recorded no matter what happens)

Redundant caching of user session state

1. Client can restart session after problem on client side

2. Client can restart session after problem on server side

System status monitoring and appropriate corrective action

Each module should be able to save its full state at any moment for persistence and mobility as well as providing insight into the current state of the module for observation and representation (possibly in a graphical manner). To this end, a state engine should be provided that allows multiple levels of description concerning the internal state. The highest level will equal persistence and the full internal state of the module, the intermediate levels will be for different observation tools and the lowest level would be for runtime output.

It is necessary for the modules to be unobtrusive to the normal operating environment of the host computer.

Any module using sockets should use ports allocated for application use.

A module should allow limits to be set on it's usage of the CPU and memory of the host computer.

1.54 3.6 System Security

The system shall conform to the following security standards:

| 1.54.1. Security | |
|---|---|
| Standard | 1.54.2. Description |
| 1.54.3. Test | 1.54.4. Item and test data shall be secured |
| Data Security | on Measured Progress servers through user, |
| on Servers | group, and role-based access permissions. |
| | Authorized users log in and are authenticated. |
| 1.54.5. Test | 1.54.6. Item and test data shall be secured |
| Data Security | in transit on public networks from the server |
| in Transit | to the client side platform by standard data |
| | encryption methods. |
| 1.54.1. Test | 1.54.8. Item and test data shall be secured |
| Data Security | on the client side platform to prevent caching |
| on the Client | or copying of information, including item |
| Side Platform | content, for retransmission or subsequent |
| | retrieval. |
| 1.54.9. Student | 1.54.10. Student data shall be secured on |
| Enrollment Data | Measured Progress servers through user, group, |
| | and rule-based access permissions. Federal |
| | and local privacy regulations dictate |
| | specific scenarios for student data access, |
| | including ‘need to know.’ Non-aggregated |
| | data that allows the unique discernment of |
| | student identity will be strictly controlled. |
| | Audit of accesses shall be implemented. Any |
| | transmission of student data over public |
| | networks shall be secured by standard data |
| | encryption methods. |
| 1.54.11. Class/ | 1.54.12. Class and roster information, and |
| Roster/Test | test schedules shall be protected from view |
| Schedule Data | and access via user, group, and rule-based |
| | access permissions. Data that uniquely identifies |
| | a student shall be highly secured. Access to |
| | all student data shall be audited. |
| 1.54.13. Student | 1.54.14. Student responses shall be protected |
| Response Data | from view and access via user, group, and rule- |
| | based access permissions. Data that uniquely |
| | identifies a student shall be highly secured. |
| | Access to all student data shall be audited. |

Security concerns shall be addressed through firewall and intrusion detection technologies.

3.6.1 Intrusion Detection System (IDS)

An Intrusion Detection System (IDS) is a device that monitors and collects system and network information. It then analyzes and differentiates the data between normal traffic and hostile traffic.

Intrusion Detection Technologies (IDT) encompass a wide range of products, such as:

1. ID Systems,

2. Intrusion Analysis,

3. Tools that process raw network packets, and

4. Tools that process log files.

Using only one type of Intrusion Detection device may not be enough to identify between normal traffic and hostile traffic, but used together, IDTs can be used to determine if an attack or an intrusion has occurred. Every IDS has a sensor, an analyzer and a user interface, but the way they are used and the way they process the data varies significantly.

IDS can be classified into two categories: host-based and network-based IDS.

1.54.15. 3.6.1.1 Host-Based IDS

Host-based IDS gathers information based on the audit logs and the event logs. It can examine user behavior, process accounting information and log files. Its aim is to identify patterns of local and remote users doing things they should not be.

Weakness of Host-Based IDS. Vendors pushing the host-based model face problems. A significant hurdle, similar to that of any agent-based product, is portability. BlackIce and similar products run only on Win32-based platforms, and though some of the other host-based systems support a broader range of platforms, it may not support the OS that The system will use. Another problem that can arise is when the company decides to migrate to another OS in the future that is not supported.

1.54.16. 3.6.1.2 Network-Based IDS

Network-based IDS products are built on the wiretapping concept. A sensor-like device tries to examine every frame that goes by. These sensors apply predefined rule sets or attack “signatures” to the captured frames to identify hostile traffic.

Strengths of Network-Based IDS. Still, network-based systems enjoy a few advantages. Perhaps their greatest asset is stealth: Network-based systems can be deployed in a non-intrusive manner, with no effect on existing systems or infrastructure. Most network-based systems are OS-independent: Deployed network-based intrusion-detection sensors will listen for all attacks, regardless of the destination OS type or any other cross-platform application.

Weakness of Network-Based IDS. The network-based intrusion-detection approach does not scale well. Network-based IDS has struggled to keep up with heavy traffic. Another problem is that it is based on predefined attack signatures, which will always be a step behind the latest underground exploits. One serious problem is keeping up with new viruses that surface almost daily.

1.54.17. 3.6.1.3 Multi-Network IDS

A multi-network IDS is a device that monitors and collects system and network information from the entire internal network—on all segments (sitting behind a router). It then analyzes the data and is able to differentiate between normal traffic and hostile traffic.

Strengths of Multi-Network IDS. There is no need to put a device (like a sniffer) on each segment to monitor all the packets on the network. A company that has 10 segments would require 10 physical devices to monitor all the packets on all segments. 20 segments would require 20 devices, and so on. This increases the complexity and the cost of monitoring the network. When using a multi-network IDS, only one device is required no matter how many segments a network might have.

1.54.18. 3.6.2 Application Security

The purpose of Web Application Security is to keep the integrity of the web application. It checks to see that the data entered is valid. For example, to log into a specific website, the user is requested to enter the user ID. If the user decides to enter 1000 characters in that field, the buffer may over-flow and the application may crash. The function of the

Web Application Security is to prevent any input that can crash the application.

1.54.19. 3.6.3 Risks in the Web Environment

Bugs or misconfiguration problems in the Web server that allow unauthorized remote users to:

1. Steal confidential documents or content;

2. Execute commands on the server and modify the system;

3. Break into the system by gaining information about the Web server's host machine; and

4. Launch denial-of-service attacks, rendering the machine temporarily unusable.

Browser side risks include:

1. Active content that crashes the browser, damages the user's system, breaches the user's privacy;

2. The misuse of personal information knowingly or unknowingly provided by the end user;

3. Interception of network data sent from browser to server or vice versa via network eavesdropping;

4. Eavesdroppers can operate from any point on the pathway between the browser and server, including:

a. The network on the browser's side of the connection;

b. The network on the server's side of the connection (including intranets);

c. The end user's Internet service provider (ISP);

d. The server's ISP; and

e. The end user's or server's ISP regional access provider.

1.54.20. 3.6.4 Types of Security Vulnerabilities

1. Exploits. The term “exploit” refers to a well-known bug/hole that hackers can use to gain entry into the system.

2. Buffer Overflow/Overrun. The buffer overflow attack is one of the most common on the Internet. The buffer overflow bug is caused by a typical mistake of not double-checking input, and allowing large input (like a login name of a thousand characters) “overflow” into some other region of memory, causing a crash or a break-in.

3. Denial-of-Service (DoS) is an attack whose purpose is not to break into a system, but instead to simply “deny” anyone else from using the system. Types of DoS attacks include:

a. Crash. Tries to crash software running on the system, or crash the entire machine

b. Disconnect. Tries to disconnect two systems from communicating with each other, or disconnect the system from the network entirely

c. Slow. Tries to slow down the system or its network connection

d. Hang. Tries to make the system go into an infinite loop. If a system crashes, it often restarts, but if it “hangs”, it will stay like that until an administrator manually stops and restarts it.

DoS attacks can be used as part of other attacks. For example, in order to hijack a TCP connection, the computer that is taken possession of must first be taken offline with DoS. By some estimates, DoS attacks like Smurf and the massive Distributed DoS (DDoS) attacks account for more than half the traffic across Internet backbones.

A DDoS is carried out by numerous computers against the victim. This allows a hacker to control hundreds of computers in order to flood even high-band Internet sites. These computers are all controlled from a single console.

1.54.21. 3.6.5 Back Door

A back door is a hole in the security of a computer system deliberately left in place by designers or maintainers. It is a way to gain access without needing a password or permission. In dealing with this problem of preventing unauthorized access, it is possible, in some circumstances, that a good session will be dropped by mistake. The usage of this feature can be disabled, but is well worth having in order to prevent a back door breach into the system.

1.54.22. 3.6.6 Trojan Horse

A Trojan horse is a section of code hidden inside an application program that performs some secret action. NetBus and Back Orifice are the most common types of Trojans. These programs are remote user, and allow an unauthorized user or hacker to gain access into the network. Once inside, they can exploit everything on the network.

1.54.23. 3.6.7 Probes

Probes are used to scan networks or hosts for information on the network. Then, they use these same hosts to attack other hosts on the network. There are two general types of probes:

1. Address Space Probes. Used to scan the network in order to determine what services are running on the hosts

2. Port Space Probes. Used to scan the host to determine what services are running on it

1.54.24. 3.6.8 Attacks We Must Handle

This Application Security Module is capable of handling the following attacks in the Web environment:

1. Denial Of Service (DOS) attacks

2. Distributed Denial Of Service (DDOS) attacks

3. Buffer overflow/overrun

4. Known bugs exploited

5. Attacks based on misconfiguration and default installation problems

6. Probing traffic for preattacks

7. Unauthorized network traffic

8. Backdoor and Trojans

9. Port scanning (connect and stealth)

The System shall require:

5. High performance of the application security module.

6. Port multiplexing. A server will normally use the same port to send data and is therefore susceptible to attack. Within the system architecture, the input port is mapped to another configurable output port. Having the ability to disguise the port by using a different port each time prevents the server from being tracked.

7. Built-in packet filtering engine. Packets can be forwarded according to priority, IP address, content and other user-assigned parameters

8. A server can have a private IP address. With the load balancing system, a request that comes in from the outside can only see a public IP address. The balancer then redirects that traffic to the appropriate server (which has a different IP address). This protects the server from the outside world knowing what the true IP address that is assigned to that specific server.

1.54.25. 3.6.9 Configuration

The concept of this architecture is to have a predefined list of security policies or options for the user to select from by enabling or disabling the various features. This simplifies the configuration of the device (the device is shipped with Application Security enabled). The device has out-of-the-box definitions of possible attacks that apply to the web environment. The user can simply define their environment in terms of server type for a quick configuration.

1.55 3.7 Application Security Module

1.55.1. 3.7.1 Overview

The Application Security module of the The system system is broken down into four components.

3.7.1.1 Detection. In charge of classifying the network traffic and matching it to the security polices. Next, the Response Engine executes the actions.

3.7.1.2 Tracking. Not all attacks are activated by a single packet that has specific patterns or signatures. Some attacks are generated by a series of packets, whereby their coexistence causes the attack. For this reason, a history mechanism is used, which is based on five separate components, each identified in a different way:

1. Identification by source IP

2. Identification by destination IP

3. Identification by source and destination IP

4. Identification by Filter type

5. TCP inspection mechanism—which keeps track of each TCP session (source and destination IP and source and destination Port) and used to identify TCP port scanning.

3.7.1.3 Response. The response actions are executed based on rules from policies. Types of actions are:

1. Discard Packets (Drop, Reject);

2. Accept Packets (Forward);

3. Send Reset (drops packet and sends a Reset to the sender);

4. Log Actions

3.7.1.4 Reporting. Generates reports through log messages. The message the module logs is one of the following:

1. Attack started

2. Attack terminated

3. Attack occurred

3.7.2 Cryptography

Applications that transmit sensitive information including passwords over the network must encrypt the data to protect it from being intercepted by network eavesdroppers.

The system shall use SSL (Secure Sockets Layer) with 128 bit encryption for Phase I.

3.7.3 Authentication/Authorization

1. For security reasons, Client/Server and Web based applications must provide server authorization to determine if an authenticated user is allowed to use services provided by the server.

2. Client/Server applications must not rely solely on client-based authorization, since this makes the application server and/or database vulnerable to an attacker who can easily bypass the client-enforced authorization checks. Such security attacks are possible via commercially available SQL tools and by modifying and replacing client software.

3. For three-tiered Client/Server applications, the middleware server must be responsible for performing user authorization checks. The backend database server must also be configured so that it will only accept requests from the middleware server or from privileged system administrators. Otherwise, clients would be able to bypass the authorization and data consistency checks performed by the middleware server.

3.7.4 Vandal Inspection

1. Use SSL/RSA encryption as necessary

2. Use messaging payload encryption as necessary

3. Use persistent storage (database) encryption as necessary

4. Establish login policies and procedures (password expiration, failed login attempts)

5. Enforce user/group permission structure for access to functionality

6. Maintain complete audit history of all data changes

7. Automatic monitoring of auditing changes

1.55.2. 3.7.5 Maintainability

Use standardized coding & naming conventions

Use source code change management software

Use regression test plans to verify incremental code changes

It will often be necessary for applications to gain full knowledge of a modules API in order to make specific calls. The full API of each module should be available to an application. By querying a module, an application should be able to get a location to the full API.

1.55.3. 3.7.6 Portability

Use OS/HW/JVM independent (e.g. J2EE) architecture

Avoid vendor specific coding (e.g. Weblogic)

Use generic data objects to access ODBC compatible database

Modules should be internationalized. They need to conform to the local language, locales, currencies etc, according to the settings specified in the configuration file or the environment in which they are running in.

1.56 3.8 Other Requirements

1.56.1. 3.8.1. Item Migration Requirements

1. Timeframe for initial load;

2. Timeframe for live production load of items;

3. Item quantities;

4. Requirements for metadata (metrics, curriculum framework, item enemies, etc.);

5. Process for additions, modifications, deletions;

6. Timeframe for initial load of constructed tests;

7. Timeframe for live production load of constructed tests;

8. Number of tests for operational, pilot, comparability;

9. Requirements for test-level metadata;

1.56.2.

1.56.3. 3.8.2. Item Content Requirements

1. Item types supported;

2. Item presentation requirements;

3. Number of item presentations and breakdown;

4. Item construction and identification;

5. Cluster construction and identification;

6. Item xml schema

7. Deployed item database er diagram

8. Test XML schema

9. Deployed test database er diagram

The foregoing description of the embodiments of the invention has been presented for the purposes of illustration and description. It is not intended to be exhaustive or to limit the invention to the precise form disclosed. Many modifications and variations are possible in light of this disclosure. It is intended that the scope of the invention be limited not by this detailed description, but rather by the claims appended hereto.

What is claimed is:

1. A computer-based testing system comprising:
a data administration system including centrally hosted data administration servers; a network; and an operational testing system;
said data administration system including a browser-capable workstation connectible via the network to the centrally hosted data administration servers;
the operational testing system including three subsystems connected to the network: a test delivery server running on a test delivery workstation and managing all aspects of a test session by acting as a data repository and hub for communication between the other subsystems, a proctor software running on a proctor test workstation providing a user interface for managing a test session by communicating with the test delivery server, and a student test software running on a student test workstation providing a user interface for displaying test items and recording responses.

2. The system according to claim 1 further comprising as scalable test display system, such that the appearance of a test item is common to all said student test workstations within the system.

3. The system according to claim 1 wherein users are categorized according to classes.

4. The system according to claim 3 wherein access to the system by a user is limited according to which said class said user belongs.

5. The system according to claim 1 further comprising an egress control system whereby access to non-test material by a student using a student test workstation is monitored and controlled during the administration of the test.

6. The system according to claim 5 wherein said egress -control system permits limited use of a world wide computer network.

7. The system according to claim 1 wherein said proctor software facilitates the monitoring of at least one student using said student test workstation.

8. The system according to claim 1 wherein said proctor software facilitates the assignment and reassignment of a student to said student test workstations.

9. The system according to claim 1 wherein said proctor software facilitates requests for assistance by a student to a proctor monitoring said proctor test workstation.

10. A statewide computer-based assessment administration system comprising:
a data administration system including centrally hosted data administration servers; a network; and an operational testing system;
said data administration system including a browser-capable workstation connectible via the network to the centrally-hosted data administration servers;
the operational testing system including three subsystems connected to the network: a test delivery server running on a test delivery workstation and managing all aspects of a test session by acting as a data repository and hub for communication between the other subsystems, a proctor software running on a proctor test workstation providing a user interface for managing a test session by communicating with the test delivery server, and a student test software running on a student test workstation providing a user interface for displaying test items and recording responses.

11. A system for the administration of jurisdiction wide standardized examinations, said system comprising:
an item bank management subsystem whereby items comprising said examinations may be accessed and edited by authorized test editors;
an assessment bank management subsystem whereby assessment materials may be accessed and edited by said authorized test editors;
a user management subsystem whereby a testee accesses said system and said examination is administered to said testee, said user management subsystem, comprising testee, teacher, and administrator import and export interfaces for batch updates and modifications;
a test publication subsystem comprising an online assessment system that takes an item set and applies pre-established styles to compile said examination for a distribution method, said method being chosen from the group consisting of online distribution and paper distribution;
a scoring subsystem whereby a user may manually score open response items, thereby obtaining testee results;
an analysis subsystem comprising algorithms for the analysis of testee results;
an reporting subsystem comprising algorithms for the analysis of testee results;
a security subsystem whereby a technical administrator can control access to said system; and
said system being rule based and configured to prompt users with specific steps and enforce the completion of said specific steps before proceeding to a next said specific step.

12. A method for administering a test over a distributed computer network, said method comprising:
transmitting test content to at least one data station from a central database;
transmitting test content to at least one testing station coupled to said data station;
administering the test; an
transferring test results from the test station to the data station;
storing the test results on the data station; and
uploading test results to the central database for analysis.
